(19) United States
(12) Patent Application Publication
(10) Pub. No.: US 2026/0296674 A1
(43) Pub. Date: Oct. 1, 2026

(54) MANAGING EFFICIENT VEHICLE BOARDING, DEBOARDING, AND CARGO HANDLING USING MODULAR CARTRIDGES

(71) Applicant: Ari Baruch Teman, Miami Beach, FL (US)

(72) Inventor: Ari Baruch Teman, Miami Beach, FL (US)

(21) Appl. No.: 19/630,306

(22) Filed: Mar. 26, 2026

Related U.S. Application Data
(60) Provisional application No. 63/777,882, filed on Mar. 26, 2025.

(51) Int. Cl. B64F 1/30; B64F 1/35; B64F 1/36

(52) U.S. Cl. CPC B64F 1/30; B64F 1/35; B64F 1/362

(57) ABSTRACT

Systems, methods, and computer-readable media for enhancing air travel, airport, and aircraft efficiency using modular, detachable cartridges are provided.

### CROSS-REFERENCE TO RELATED APPLICATION(S)

This application claims the benefit of prior filed U.S. Provisional Patent Application No. 63/777,882, filed Mar. 26, 2025, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to managing efficient vehicle use (e.g., boarding, deboarding, cargo handling, etc.) and, more particularly, to enhancing air travel, airport, and aircraft efficiency using modular, detachable cartridges.

### BACKGROUND OF THE DISCLOSURE

Air travel inefficiencies often stem from slow boarding, deplaning, and cargo handling, which may be exacerbated by long distances between cities and airports, between airplane gates, narrow aisles, and manual processes.

### SUMMARY OF THE DISCLOSURE

This document describes systems, methods, and computer-readable media for managing efficient vehicle boarding, deboarding, and cargo handling using modular cartridges.

For example, there may be provided a modular aircraft cartridge for side-loading passenger ingress and egress, wherein the cartridge may include a structural frame defining a passenger cabin interior, at least one lateral access assembly moveably coupled to the structural frame, the lateral access assembly configured to transition between a sealed flight configuration and an open loading configuration, and a deployable safety barrier positioned between a passenger seating area of the passenger cabin interior and the lateral access assembly, wherein the deployable safety barrier is configured to move between a retracted position and a protective position, the protective position defining a clearance gap that prevents passenger limb interference with a movement path of the lateral access assembly.

As another example, there may be provided a modular utility distribution system for aircraft, including a vehicle docking interface coupled to a primary utility system of an aircraft, a first modular cartridge including a first mated interface and a second mated interface, and a second modular cartridge including a third mated interface, wherein the first modular cartridge is configured to receive utilities from the primary utility system of the aircraft via the first mated interface and bridge said utilities to the second modular cartridge via a connection between the second and third mated interfaces.

As yet another example, there may be provided a method for reducing aircraft maintenance downtime, the method including identifying a failure in a fixed-function system of an aircraft, de-docking a modular cartridge containing the failed system from a vehicle docking interface of the aircraft, and instantly replacing the failed modular cartridge with a functional modular cartridge of the same type, such that the aircraft is cleared for flight without requiring in-situ repair of the failed system.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system for providing an agentic AI management processing service, according to one or more embodiments of the disclosure;

FIG. 1A is a more detailed schematic view of a subsystem of the system of FIG. 1, according to one or more embodiments of the disclosure;

FIG. 1B is in exemplary perspective birds eye view of an exemplary system for providing an agentic AI management processing service, according to one or more embodiments of the disclosure;

FIGS. 2A-2I are various perspective views of one or more cartridges during different stages of use at a terminal, according to one or more embodiments of the disclosure;

FIGS. 3-3H are various perspective views of a terminal, according to one or more embodiments of the disclosure;

FIG. 4 is a perspective birds eye view of a portion of a terminal and multiple vehicles, according to one or more embodiments of the disclosure;

FIG. 4A-4D are various perspective views of an exemplary mover providing a cartridge to a vehicle, according to one or more embodiments of the disclosure;

FIG. 4A′-4D′ are various perspective views of another exemplary mover providing a cartridge to a vehicle, according to one or more embodiments of the disclosure;

FIG. 5A-5D are various perspective views of an exemplary cleaning terminal, according to one or more embodiments of the disclosure;

FIGS. 6A-6C are perspective birds eye views of various departure terminals, according to one or more embodiments of the disclosure;

FIG. 7 is a perspective view of complementary resource feature connectors of a cartridge and a vehicle, according to one or more embodiments of the disclosure;

FIGS. 8-9d2 are perspective views of various cartridge-vehicle insertion solutions, according to one or more embodiments of the disclosure;

FIGS. 10-12C are perspective views of cartridges, according to one or more embodiments of the disclosure;

FIG. 13 is a perspective view of a cargo transport solution, according to one or more embodiments of the disclosure;

FIG. 14 is a perspective partially cutaway view of a mobile autonomous manufacturing environment used in an aircraft fuselage, in accordance with some embodiments of the disclosure;

FIG. 14A is a detailed view of a structural repair in an aircraft fuselage, in accordance with some embodiments of the disclosure;

FIG. 14B is a detailed view of a fuselage and front of an airplane pivoted away from one another, in accordance with some embodiments of the disclosure; and

FIGS. 14C and 14D are detailed views of a portion of the airplane of FIG. 14B once the fuselage and front of the airplane have been pivoted back towards one another and then locked together, in accordance with some embodiments of the disclosure.

### DETAILED DESCRIPTION OF THE DISCLOSURE

Systems, methods, and computer-readable media for managing efficient vehicle boarding, deboarding (e.g., deplaning, disembarking, etc.), and cargo handling using modular cartridges are provided. Such efficient use may be managed for any suitable vehicle (e.g., any suitable motor vehicle (e.g., car, truck, bus, motorcycle, etc.), any suitable railed vehicle (e.g., train, tram, etc.), any suitable watercraft (e.g., ship, boat, jet ski, etc.), any suitable aircraft (e.g., airplane, helicopter, drone, etc.), any suitable hover vehicle, any suitable spacecraft, any suitable uncrewed or autonomous vehicle (“AV”) (e.g., a multirotor drone), and/or the like).

As an example, certain aircraft may have wings with wingspans that may require significant spacing between aircraft, thereby limiting terminal capacity and/or involving long hallways that are not easily walked, while some possible modular systems may lack side-loading, remote terminal integration, advanced security, and/or automated cleaning features. Systems of this disclosure may introduce a scalable solution with flexible cartridge sizes and comprehensive logistics. Some solutions may allow for immediate side-loading of each passenger row, eliminating the common bottleneck of hundreds of passengers waiting behind one individual loading a bag into an overhead compartment, or a child into a seat, for example. Systems of this disclosure may allow every passenger to enter their row via the sides or center of the row, thus reducing the maximum number of people ahead of them to the other (e.g., 1 or 2) people in their row. This unique side-loading of all passengers and/or cargo may reduce boarding/loading time tremendously, saving airlines and passengers millions of dollars in wasted time, fuel, labor, and related expenses. Systems of this disclosure may include modular cartridges, which may be offered in various sizes, with side-loading capabilities, transported by autonomous movers, trucks, pods, or the like, with or without tracks, to aircraft fuselages or other suitable vehicles designed for rapid swapping. Passengers may enter cartridges via side openings, which may be secured by folding seat arms and then shades, while non-passenger cargo may load into specialized cartridges or cartridge sections. Tracks with bearings, wheels, and/or magnetic levitation (“maglev”) may move and secure cartridges to/from movers, which may be monitored by cameras with motion detection. Automated cleaning terminals with robotic cleaning and lost-and-found systems may ensure efficiency and passenger convenience. Unlike some potential solutions that may be reliant on aisle (vertical) loading and terminal proximity, systems of this disclosure may integrate direct side-entrance into every row and/or cargo shelf, automated or remotely-controlled pods that may move the cartridges, advanced security via motion-detecting/object-detecting cameras, robotic cleaning/prep/lost-and-found-item-returning terminals, and/or passenger safety features (e.g., folding seat arms and deployable shades that may form outer barriers during cartridge movement, minimizing ground time and enhancing operational flexibility). Additionally or alternatively, a multiple cartridge-to-plane ratio may allow simultaneous boarding, cleaning, and deboarding, while also allowing departure and arrival terminals to be physically distanced for security and efficiency purposes. Additionally or alternatively, because of the ability to load cartridges remotely, both passenger and cargo, systems of this disclosure may enable companies to fully-load multiple cartridges (e.g., with cargo, passengers, or a combination thereof) and drive them, manually or via autonomous mover, to the airport to be immediately loaded upon the plane's arrival. Systems of this disclosure may enable a plane to land, have existing cartridges removed, and fully-loaded replacement cartridges onboarded immediately such that the plane may then be ready for immediate takeoff without any taxiing to a terminal or waiting for individual people and cargo to load. This may save airlines millions of dollars in fuel, labor, and/or wear-and-tear (e.g., tires, etc.) eaten by taxying and loading/unloading. Additionally or alternatively, the planes can be powered by fuel and other fluid cartridges, similar in nature to a printer ink cartridge, such that no time is taken to fuel a plane with a flow of riel and replace necessary fluids (e.g., de-icer, water, etc.). These cartridges could even be replaced mid-air by drones or other airplanes, or dropped (e.g., with or without parachute) in a situation where the plane needs to drop weight, such as in an emergency situation. It is also possible that planes could have rescue cartridges, where, in the event of engine failure, passengers may pack into an area which may then be dropped and glide down via parachute and/or drone fans.

The systems and methods of this disclosure for efficient boarding, deplaning, and cargo handling using modular cartridges may streamline air travel operations through a series of integrated components and processes. The following description outlines the operational flow for a passenger from arrival at a departure terminal through to deplaning at an arrival terminal, followed by cartridge processing, and extends to the use of remote terminals. This disclosure also provides systems, methods, and computer-readable media for an integrated aviation ecosystem including modular cartridges, autonomous transport movers, and in-situ autonomous manufacturing for aircraft conversion and maintenance. The disclosure introduces a paradigm shift in aircraft architecture, utilizing distributed side-loading access points to eliminate boarding bottlenecks and employing topologically interlocked, additive-manufactured junctions to ensure structural integrity. By deploying mobile autonomous manufacturing environments (“MAMEs”) directly within a fuselage, systems of the disclosure may enable the on-wing retrofitting of legacy aircraft into modular cartridge-compatible vessels, effectively synthesizing high-strength, inseparable mechanical hinges and locking mechanisms that are physically incapable of disassembly under extreme pressure differentials. This disclosure covers not only the physical modularity of passenger and cargo units but also the robotic lifecycle management, including automated cleaning, biometric lost-and-found recovery, and autonomous additive repair, which may enable rapid aircraft turnaround. Accordingly, it will be appreciated that the features described in this disclosure represent a comprehensive system for enhancing the safety, efficiency, and structural versatility of air travel. Features described in the context of one embodiment, such as 3D-printed captive-loop hinges, may be combined with other embodiments, such as remote terminal autonomous pods, to provide a unified transport solution.

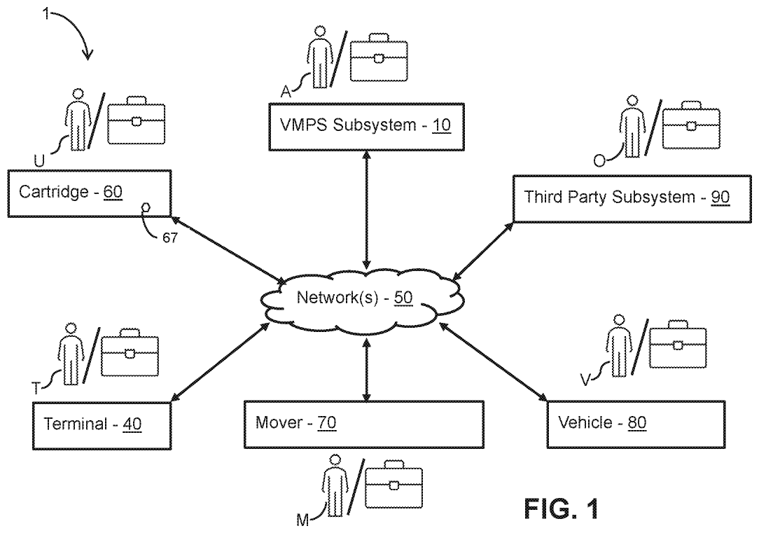

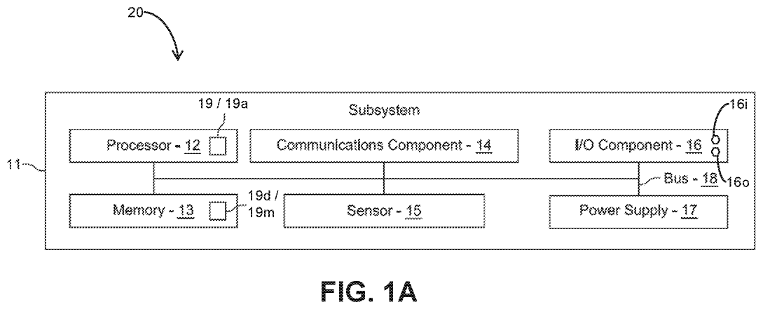

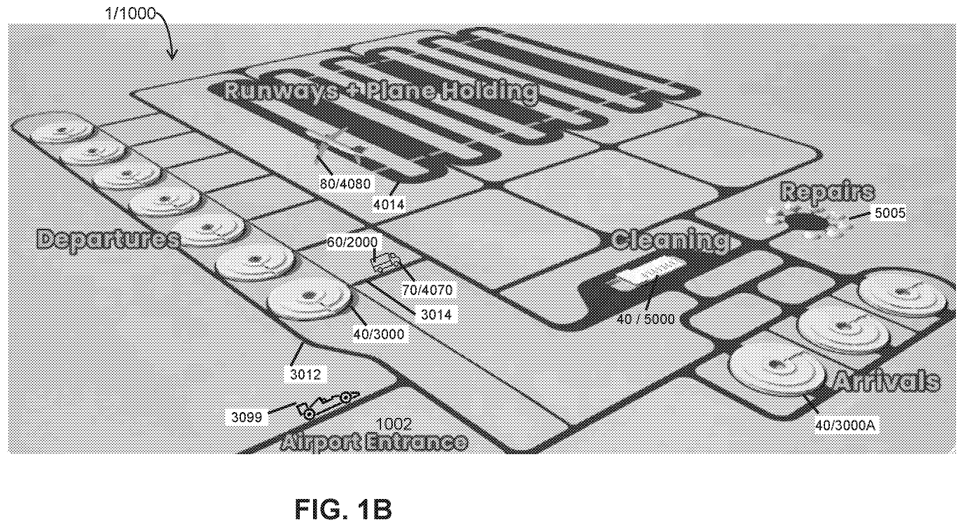

FIG. 1 is a schematic view of an illustrative system 1 in which at least partially automated vehicle management (e.g., efficient vehicle boarding, deboarding, and cargo handling) may be facilitated using modular cartridges. For example, as shown in FIG. 1, system 1 may be a vehicle management system and may include a vehicle management processing service (“VMPS”) subsystem 10, at least one cartridge 60, at least one terminal 40, at least one mover 70, at least one vehicle 80, at least one third party enabler subsystem 90, and at least one communications network 50 through which any two or more of VMPS subsystem 10, cartridge 60, terminal 40, mover 70, vehicle 80, and third party enabler subsystem 90 may communicate. Some or all portions of VMPS subsystem 10 may be operated, managed, or otherwise at least partially controlled by any suitable person(s), organization, or other suitable entity (e.g., an administrator A) that may be responsible for providing to one or more other suitable entities (e.g., any suitable user U that may operate, manage, or otherwise at least partially control or use cartridge 60, an operator O that may operate, manage, or otherwise at least partially control or use subsystem 90, a terminal manager T that may operate, manage, or otherwise at least partially control or use terminal 40, a mover manager M that may operate, manage, or otherwise at least partially control or use mover 70, a vehicle operation V that may operate, manage, or otherwise at least partially control or use vehicle 80, etc.) of system 1 a VMPS or a VMPS platform (“VMPSP”) (e.g., any suitable platform of a vehicle management system).

As shown in FIG. 1A, a subsystem or system device 20 (e.g., one, some, or each of the devices and/or subsystems described herein of FIG. 1 (e.g., VMPS subsystem 10, cartridge 60, terminal 40, mover 70, vehicle 80, third party enabler subsystem 90, and/or otherwise) may include any suitable components or modules, including, but not limited to, a processor component 12, a memory component 13, a communications component 14, a sensor 15, an input/output (“I/O”) component 16, a power supply component 17, a housing 11, and/or a bus 18 that may provide one or more wired or wireless communication links or paths for transferring data and/or power to, from, or between various other components of subsystem 20. In some embodiments, one or more components of subsystem 20 may be combined or omitted. Moreover, subsystem 20 may include other components not combined or included in FIG. 1A and/or several instances of the components shown in FIG. 1A. For the sake of simplicity, only one of each of the components of subsystem 20 is shown in FIG. 1A.

I/O component 16 may include at least one input component 16i (e.g., a button, mouse, keyboard, etc.) to receive information from a user or other device or power therefrom and/or at least one output component 160 (e.g., an audio output component or speaker, video output component or display, haptic output component (e.g., rumbler, vibrator, etc.), lighting output component, olfactory output component, movement actuator (e.g., motor), etc.) to provide information or power or any other suitable support to a user or other device, such as a touch screen I/O component that may receive input information through a user's touch of a display screen and that may also provide visual information to a user via that same display screen, and/or the like. In some embodiments, an I/O component 16 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like.

Memory 13 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing any suitable data (e.g., data 19d (e.g., unique user identifier information, parameters, models, neural networks, algorithms, application data, etc.) and/or any suitable service system management model 19m (e.g., any suitable transformer model that may be trained and/or queried by the VMPSP (e.g., that may be used by any suitable application 19a)))). Memory 13 may include suitable logic, circuitry, and/or code that may enable storage of various types of information, such as received data, generated data, code, and/or configuration information.

Communications component 14 may be provided to allow subsystem 20 to communicate with one or more other subsystems 20 (e.g., any communication to, from, and/or between VMPS subsystem 10, cartridge 60, terminal 40, mover 70, vehicle 80, third party enabler subsystem 90, and/or the like of system 1 (e.g., via any suitable network 50)) using any suitable communications protocol(s). Communications component 14 can be operative to create or connect to a communication network or link of a network. Communications component 14 can provide wireless communications using any suitable short-range or long-range communications protocol, such as Wi-Fi (e.g., an 802.11 protocol), ZigBee™ (e.g., an 802.15.4 protocol), WiDi™, Ethernet, Bluetooth™ Low Energy (“BLE”), ultra-wideband, radio frequency systems (e.g., 1200 MHz, 2.4 GHz, and 5.6 GHz communication systems), high frequency systems (e.g., 900 MHz, 2.4 GHz, and 5.6 GHz communication systems), near field communication (“NFC”), infrared, protocols used by wireless and cellular telephones and personal e-mail devices, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, any other communications protocol, or any combination thereof. Communications component 14 can also be operative to connect to a wired communications link or directly to another data source wirelessly or via one or more wired connections or other suitable connection type(s). Communications component 14 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access. Communications component 14 may also include or may be electrically coupled to any suitable transceiver circuitry that can enable subsystem 20 to be communicatively coupled to another subsystem and communicate data with that other device wirelessly or via a wired connection (e.g., using a connector port). Communications component 14 (and/or sensor assembly 15) may be configured to determine a geographical position of subsystem 20 and/or any suitable data that may be associated with that position. For example, communications component 14 may utilize a global positioning system (“GPS”) or a regional or site-wide positioning system that may use cell tower positioning technology or Wi-FiTM technology, or any suitable location-based service or real-time locating system, which may use a geo-fence for providing any suitable location-based data to subsystem 20 (e.g., to determine a current geo-location of subsystem 20 and/or any other suitable associated data). Communications component 14 may include or otherwise provide a network interface that may include mechanical, electrical, and/or signaling circuitry for communicating any suitable data over any suitable physical links that may be coupled to network 50.

Sensor 15 may be any suitable sensor that may be configured to sense any suitable data for subsystem 20 (e.g., location-based data via a global positioning system (“GPS”) sensor system or any other suitable location determination protocol, motion data, environmental data, biometric data, etc.). Sensor 15 may be a sensor assembly that may include any suitable sensor or any suitable combination of sensors operative to detect movements of subsystem 20 and/or of any user thereof and/or any other characteristics of subsystem 20 and/or of its environment (e.g., physical activity or other characteristics of a user or any person or activity of interest of subsystem 20, light content of the device environment, gas pollution content of the device environment, noise pollution content of the device environment, altitude of the device, etc.).

Power supply 17 can include any suitable circuitry for receiving and/or generating power, and for providing such power to one or more of the other components of subsystem 20. For example, power supply assembly 17 can be coupled to a power grid (e.g., when subsystem 20 is not acting as a portable device or when a battery of the device is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when subsystem 20 is acting as a portable device). Subsystem 20 may also be provided with a housing 11 that may at least partially enclose one or more of the components of subsystem 20 for protection from debris and other degrading forces external to subsystem 20. Each component of subsystem 20 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, subsystem 20 may include other components not combined or included in those shown or several instances of the components shown.

Processor 12 may be used to run one or more applications, such as an application 19 (e.g., application 19a) that may be accessible from memory 13 (e.g., as a portion of data 19d) and/or any other suitable source (e.g., from any other device in its system). Application 19 may include, but is not limited to, one or more operating system applications, firmware applications, communication applications (e.g., for enabling communication of data between devices), third party service applications, internet browsing applications (e.g., for interacting with a website provided by a third party subsystem 90 and/or by VMPS subsystem 10 for enabling cartridge 60 and/or terminal 40 and/or mover 70 and/or vehicle 80 and/or third party enabler subsystem 90 to interact with an online service), application programming interfaces (“APIs”), software development kits (“SDKs”), VMPS applications (e.g., a web application or a native application that may be at least partially produced by VMPS subsystem 10 for enabling cartridge 60 and/or terminal 40 and/or mover 70 and/or vehicle 80 and/or third party enabler subsystem 90 to interact with an online service (e.g., a model training service and/or a model querying service) and/or a third party subsystem 90), any other suitable applications, and/or the like. For example, processor 12 may load an application 19 as an interface program to determine how instructions or data received via an input component 16i of I/O component 16 or other component of subsystem 20 (e.g., sensor 15 and/or communications component 14) may manipulate the way in which information may be stored (e.g., in memory 13) and/or provided to via an output component 160 of I/O component 16 and/or to another system device via communications component 14. As one example, application 19 may be a third party application that may be running on subsystem 20 that may be loaded on subsystem 20 (e.g., using communications component 14) via an application market, such as the Apple App Store or Google Play, or that may be accessed via an internet application or web browser (e.g., by Apple Safari or Google Chrome) that may be running on subsystem 20 and that may be pointed to a uniform resource locator (“URL”) whose target or web resource may be managed by or otherwise affiliated with any suitable entity. Any device (e.g., any user device or subsystem or server) may include any suitable special purpose hardware (e.g., hardware support of high-speed packet processing, hardware support of machine learning algorithms, etc.). Processor 12 may include suitable logic, circuitry, and/or code that may enable processing data and/or controlling operations of subsystem 20. In this regard, processor 12 may be enabled to provide control signals to various other components of subsystem 20. Processor 12 may also control transfers of data between various portions of subsystem 20. Processor 12 may further implement an operating system or may otherwise execute code to manage operations of subsystem 20. As one example, application 19 may provide a user with the ability to interact with an VMPSP of system 1, where application 19 may be a third party application that may be running on cartridge 60 and/or terminal 40 and/or mover 70 and/or vehicle 80 and/or third party enabler subsystem 90 (e.g., an application associated with VMPS subsystem 10 and/or third party subsystem 90) that may be loaded on cartridge 60 and/or terminal 40 and/or mover 70 and/or vehicle 80 and/or third party enabler subsystem 90 (e.g., using communications component 14) via an application market, such as the Apple App Store or Google Play, or that may be accessed via an internet application or web browser (e.g., by Apple Safari or Google Chrome) that may be running on cartridge 60 and/or terminal 40 and/or mover 70 and/or vehicle 80 and/or third party enabler subsystem 90 and that may be pointed to a uniform resource locator (“URL”) whose target or web resource may be managed by or otherwise affiliated with the VMPSP.

Subsystem 20 may be any portable, mobile, wearable, implantable, or hand-held electronic device configured to operate with system 1. Alternatively, subsystem 20 may not be portable during use, but may instead be generally stationary. Subsystem 20 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), a tag, credit card-shaped device, transponder, transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device (e.g., watch, ring, glasses, etc.), boom box, internet of things (“IoT”) device, virtualized IoT device (e.g., cloud compute instance), modem, router, RFID card, printer, kiosk, beacon (e.g., a Bluetooth low energy beacon transmitter device), server, and any combinations thereof. Subsystem 20 may be configured to have any physical structure (e.g., by one or more housings 11) that may include, but is not limited to, any suitable portable, mobile, wearable, implantable, rideable, controllable, or hand-held mobile electronic device (e.g., a portable and/or handheld media player), a headset, a helmet, glasses, a wearable, a tablet computer, a laptop computer, a controller, a VR and/or AR and/or MR device, a vehicle, server, sensor system, actuator system, and/or any other machine or device or housing or structure. Alternatively, subsystem 20 may not be portable during use, but may instead be generally stationary. In one or more implementations, one or more of processor 12, memory 13, sensor(s) 15, communications interface or communications component 14, I/O component 16, and/or power supply 17, and/or one or more portions thereof, may be implemented in software (e.g., subroutines and code), may be implemented in hardware (e.g., an application specific integrated circuit (“ASIC”), a field programmable gate array (“FPGA”), a programmable logic device (“PLD”), a controller, a state machine, gated logic, discrete hardware components, or any other suitable devices), and/or a combination of both. Variations in the arrangement and type of the components may be made without departing from the spirit or scope of the claims as set forth herein. Additional components, different components, or fewer components may be provided.

Any two of VMPS subsystem 10, cartridge 60, terminal 40, mover 70, vehicle 80, and/or third party enabler subsystem 90 may communicate via one or more communications networks 50. Network 50 may be the internet or any other network for communicatively coupling any two entities or devices or subsystems of system 1 that may be remote from one another, such that when interconnected, cartridge 60 and/or terminal 40 and/or mover 70 and/or vehicle 80 and/or third party enabler subsystem 90 may access information (e.g., an API, SDK, protocol, application, etc. (e.g., from data structure 19d of VMPS subsystem 10, as may be provided as a validation processing service via processor 12 of VMPS subsystem 10)) as if such information were stored locally at that cartridge 60 and/or terminal 40 and/or mover 70 and/or vehicle 80 and/or third party enabler subsystem 90 (e.g., in memory component 13 of that device).

Any suitable model 19m may be developed and/or generated for use in processing any suitable query. For example, a model may be a learning engine, where the learning engine may be operative to use any suitable machine learning (“ML”) (e.g., the system's ability to learn automatically from past events to affect future behavior) to use a certain query to generate a final query response. For example, the learning engine may include any suitable neural network (e.g., an artificial neural network) that may be initially configured, trained on one or more input documents, and then used to respond to any suitable query.

A neural network or neuronal network or artificial neural network may be hardware-based, software-based, or any combination thereof, such as any suitable model (e.g., an analytical model, a computational model, etc.), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs. The weights may be connection strengths between neurons of the network, which may be activated during training and/or query response prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. The neural network may be used to estimate or approximate functions that can depend on a large number of inputs and that may be generally unknown. The neural network may generally be a system of interconnected “neurons” that may exchange messages between each other, where the connections may have numeric weights (e.g., initially configured with initial weight values) that can be tuned based on experience, making the neural network adaptive to inputs and capable of learning (e.g., learning pattern recognition). A suitable optimization or training process may be operative to modify a set of initially configured weights assigned to the output of one, some, or all neurons from the input(s) and/or hidden layer(s). A non-linear transfer function may be used to couple any two portions of any two layers of neurons, including an input layer, one or more hidden layers, and an output (e.g., an input to a hidden layer, a hidden layer to an output, etc.).

The initial configuring of the learning engine or management model for a particular system (e.g., the initial weighting and arranging of neurons of a neural network of the learning engine) may be done using any suitable data accessible to a custodian of the model (e.g., an administrator or user), such as data associated with the configuration of other learning engines of the system (e.g., learning engines or management models for other systems), data associated with the particular system (e.g., initial background data accessible by the model custodian about the particular system composition, location, past uses, and/or the like), data assumed or inferred by the model custodian using any suitable guidance, and/or the like. For example, a model custodian may be operative to capture any suitable initial background data about a particular system in any suitable manner, which may be enabled by any suitable user interface provided to an appropriate subsystem or device accessible to one, some, or each operator or entity with knowledge of the particular system (e.g., a model app or website). The model custodian may provide a data collection portal for enabling any suitable entity to provide initial background data for the particular system. The data may be uploaded in bulk or manually entered in any suitable manner.

A learning engine or model for a VMPS system may be trained on any suitable input document(s) or the like. Any suitable training methods or algorithms (e.g., learning algorithms) may be used to train the neural network of the learning engine, including, but not limited to, Back Propagation, Resilient Propagation, Genetic Algorithms, Simulated Annealing, Levenberg, Nelder-Meade, and/or the like. Such training methods may be used individually and/or in different combinations to get the best performance from a neural network.

A trained model may then receive input data (e.g., any suitable query) from any suitable source (e.g., user device, VMPS subsystem, third party subsystem, etc.) using any suitable methods for use by the model. The trained model may then use this new input data to generate output data using the learning engine or model.

The processing power and speed of any suitable VMPS system and its one or more models may be configured to train a model effectively and efficiently and/or to determine a response to a received query effectively and efficiently or otherwise adjust a managed element based on the determined query response automatically and instantaneously or substantially instantaneously based on any new received query, such that management of the system may run quickly and smoothly. This may enable the system to operate as effectively and as efficiently as possible.

Therefore, any suitable model custodian may be operative to generate and/or manage any suitable model or learning engine that may utilize any suitable machine learning, such as one or more artificial neural networks, to analyze certain input document data for training a model and/or to analyze certain query data for using a trained model to generate a query response that may be utilized in any way to adjust a functionality of a user device or otherwise, which may enable intelligent suggestions to be provided to an operator/user and/or intelligent system functionality adjustments to be made for improving the operator's/user's experiences and the system's productivity.

The use of one or more suitable models or engines or neural networks or the like may enable query response. Such models (e.g., neural networks) running on any suitable processing units (e.g., graphical processing units (“GPUs”) that may be available to the system) provide significant speed improvements in efficiency and accuracy with respect to query response over other types of algorithms and human-conducted analysis of data, as such models can provide estimates in a few milliseconds or less, thereby improving the functionality of any computing device on which they may be run. Due to such efficiency and accuracy, such models enable a technical solution for enabling the generation of any suitable control data (e.g., for controlling any suitable functionality of any suitable managed element) using any suitable real-time data (e.g., data made available to the models) that may not be possible without the use of such models, as such models may increase performance of their computing device(s) by requiring less memory, providing faster response times, and/or increased accuracy and/or reliability. Due to the condensed timeframe and/or the time within which a decision (e.g., query response) with respect to system data (e.g., received query) ought to be made to provide a desirable user experience, such models offer the unique ability to provide accurate responses with the speed necessary to enable effective and efficient use management.

Any of VMPS subsystem 10, cartridge 60, terminal 40, mover 70, vehicle 80, and/or third party enabler subsystem 90 may further include any suitable structural components beyond an outer housing (e.g., as a portion or type of housing 11), as may be described herein. For example, a passenger cartridge may include any suitable seats, armrests, curtains, tracks, rollers, and/or the like.

As shown in FIG. 1B, an exemplary airport system 1000 may be provided that may include at least one terminal 40 (e.g., one or more departure terminals 3000, one or more arrival terminals 3000a, one or more cleaning terminals 5000, etc.), at least one cartridge 60 (e.g., one or more passenger cartridges 2000), one or more movers 70 (e.g., one or more passenger cartridge movers 4070), one or more vehicles 80 (e.g., one or more airplanes 4080), and one or more paths along which various modes of transportation may travel (e.g., basic transport mechanism lane(s) 3012 that may be used by basic transport mechanism(s) 3099 to transport passengers or other suitable cargo to/from the airport via any suitable airport entrance 1002, mover lane(s) 3014 that may be used by mover(s) 70 to transport cartridges 60 between terminals 40 and vehicles 80, vehicle lane(s) 4014 that may be used by vehicle(s) 80 to transport cartridges between airports 1000, and/or the like).

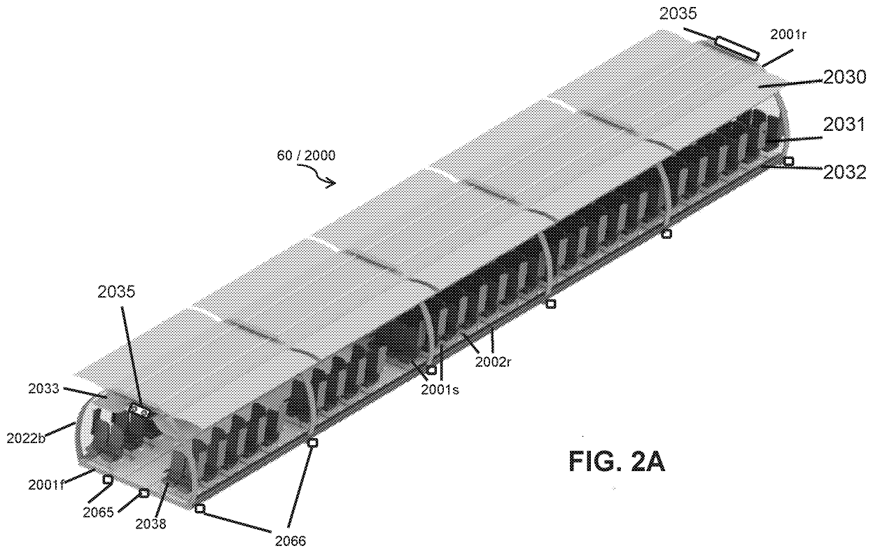

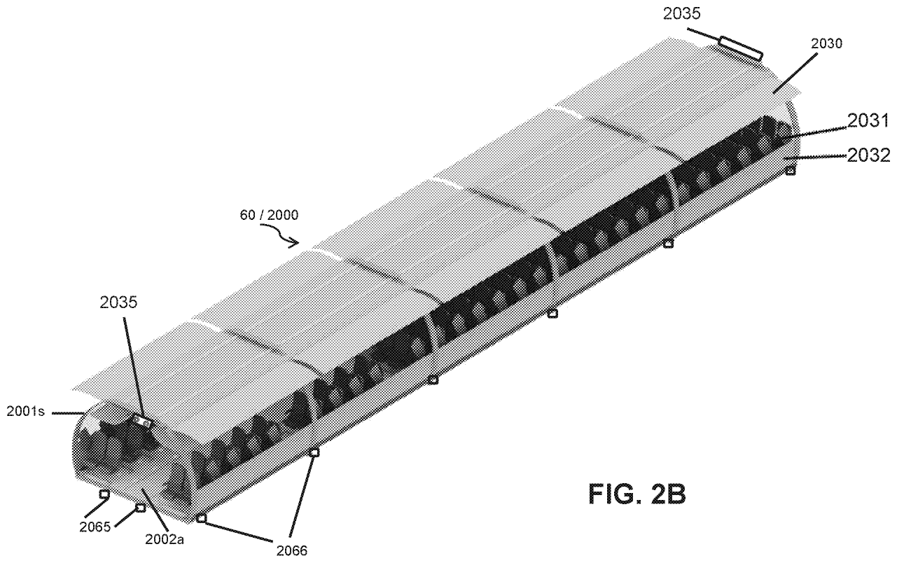

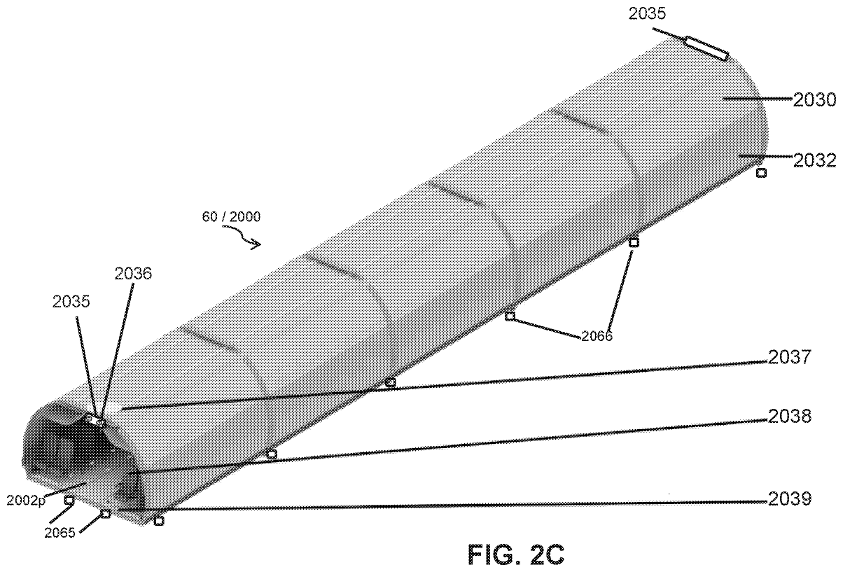

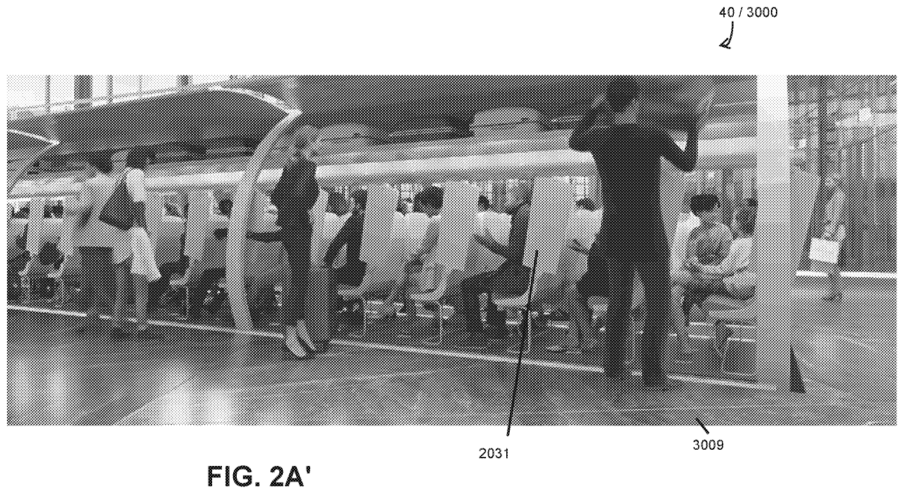

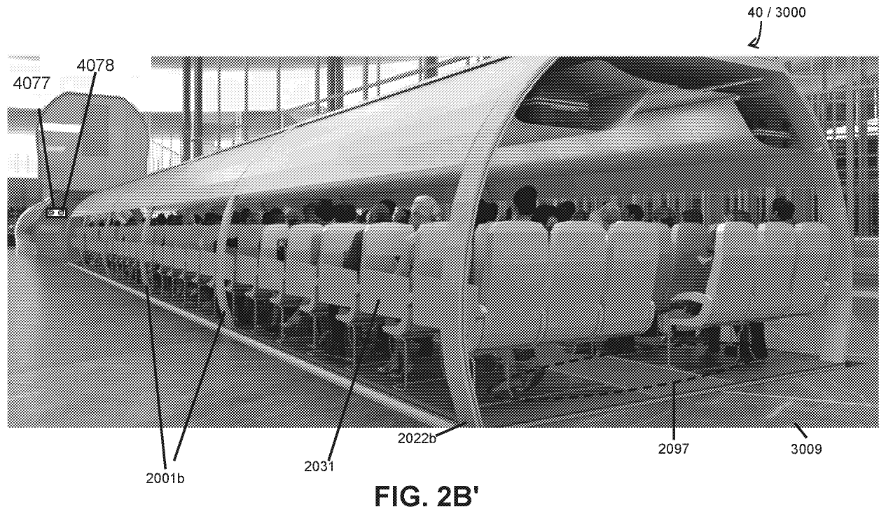

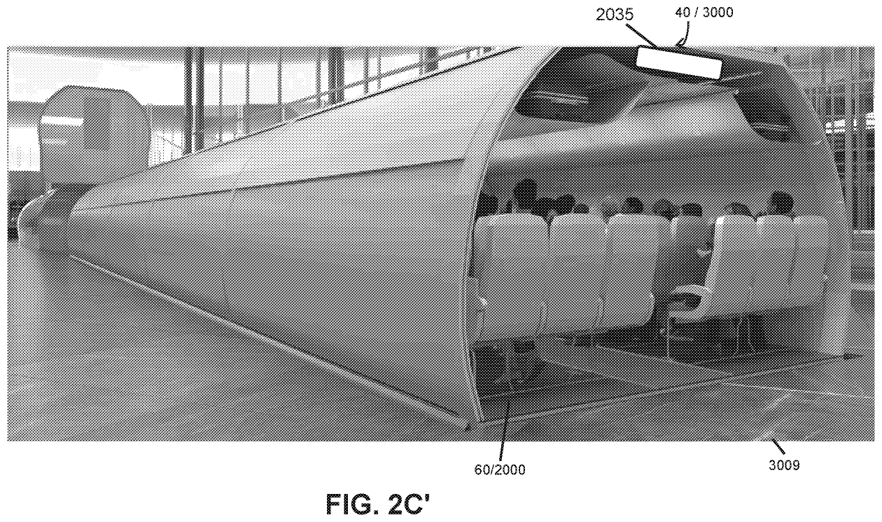

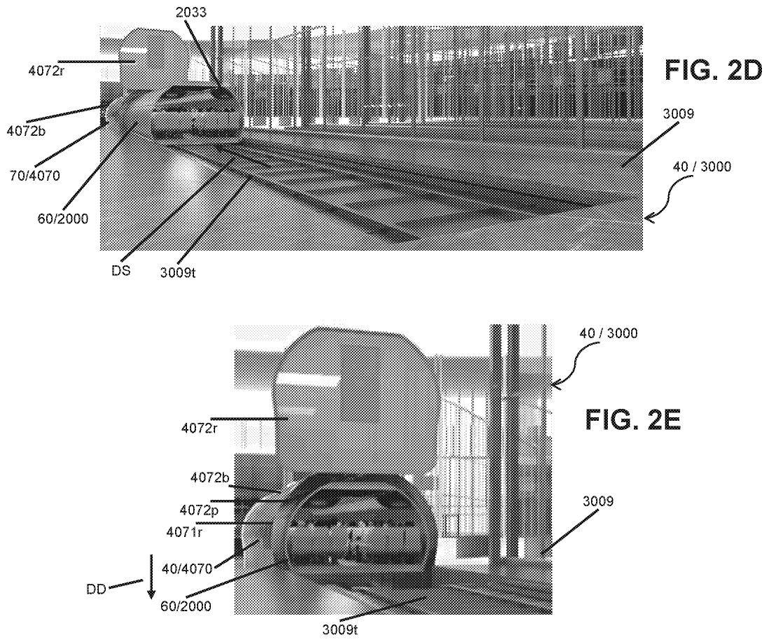

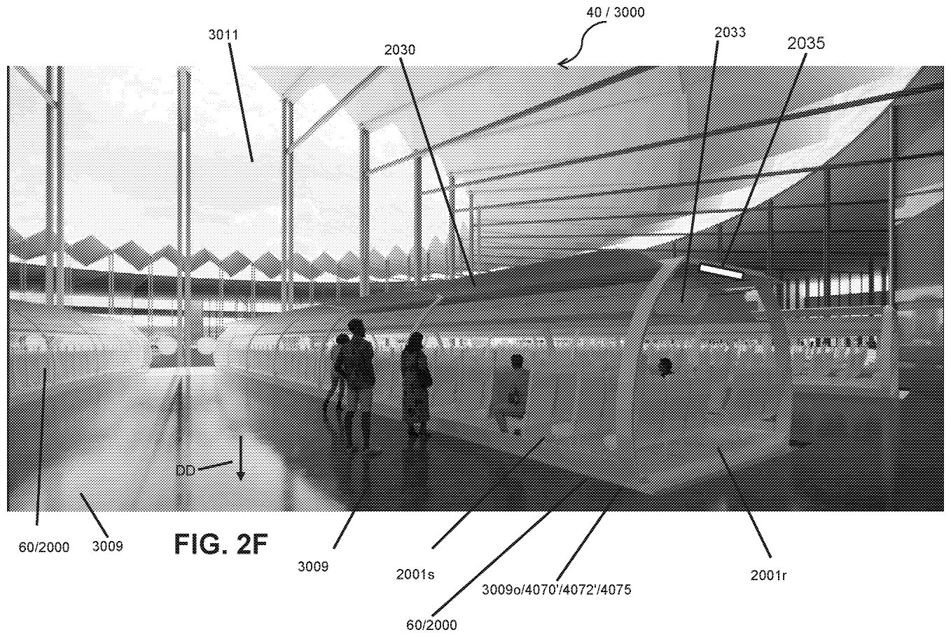

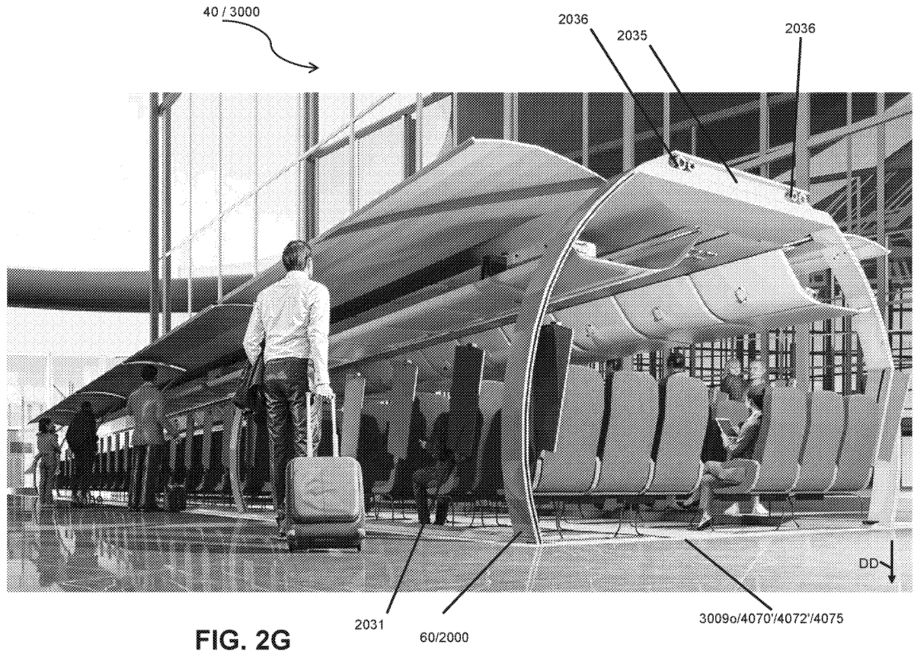

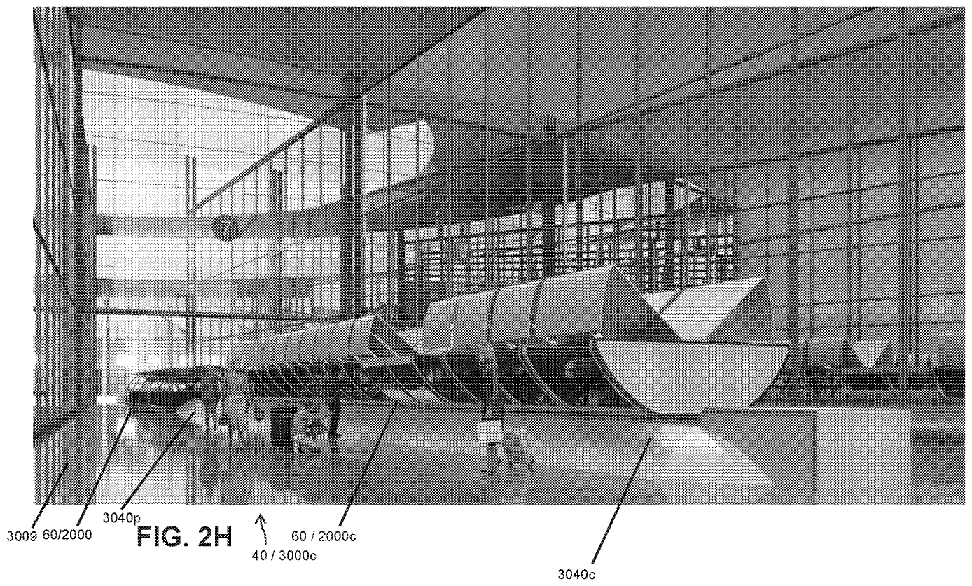

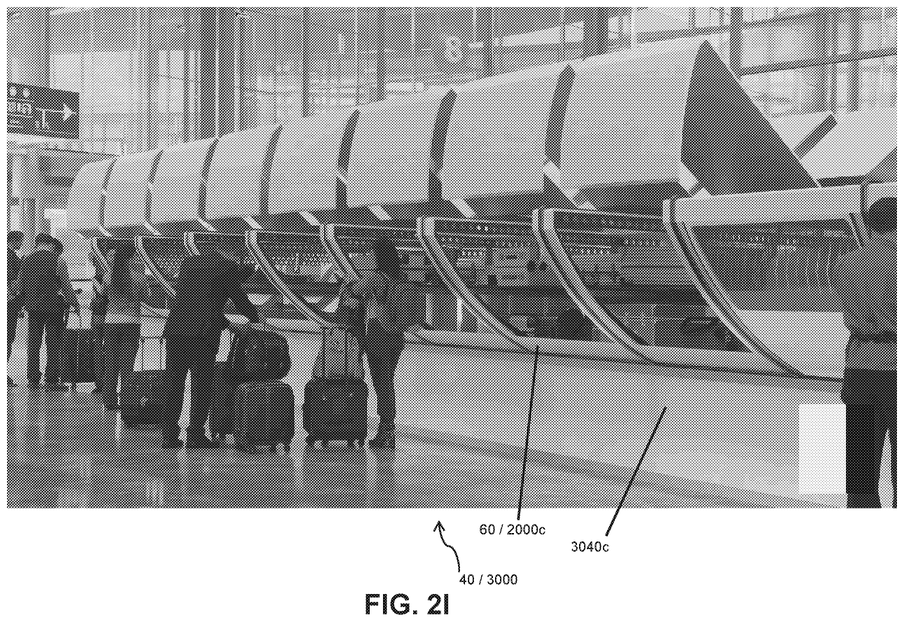

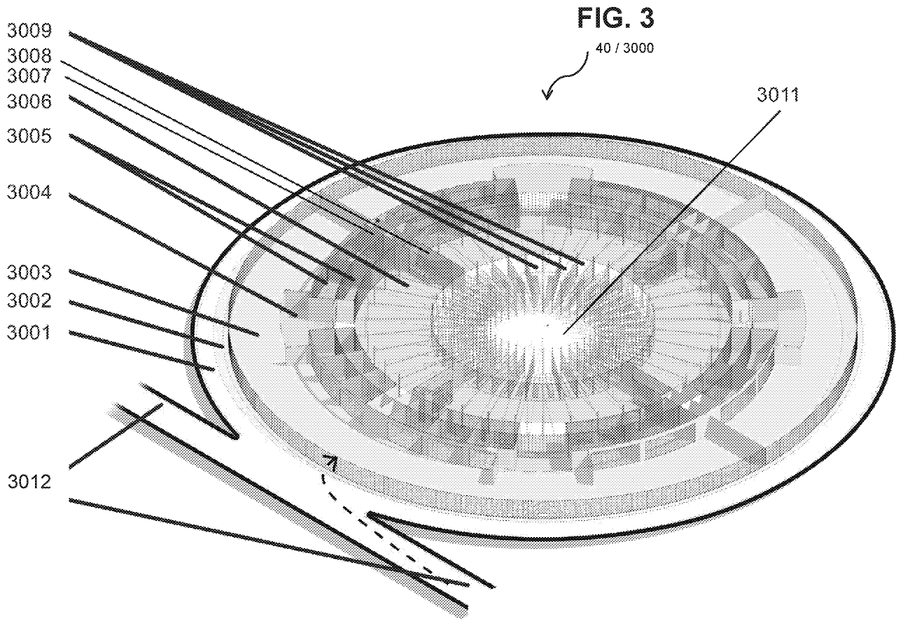

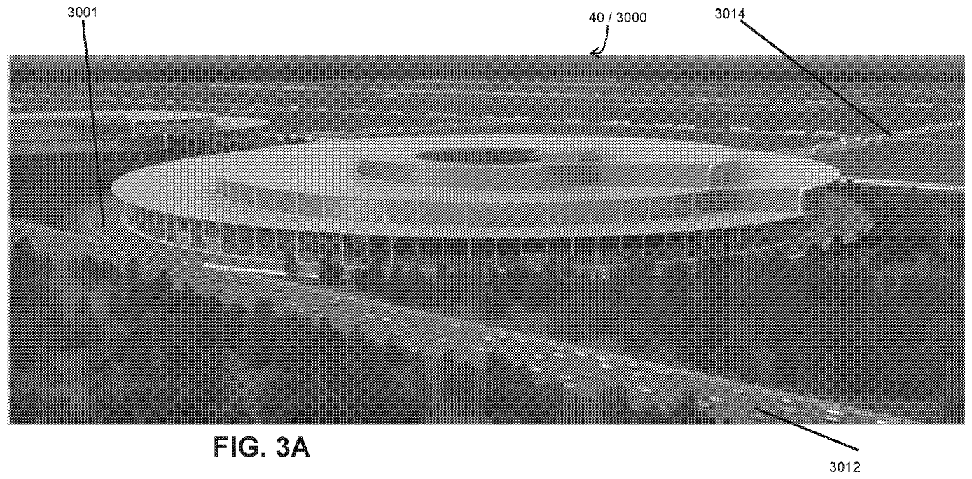

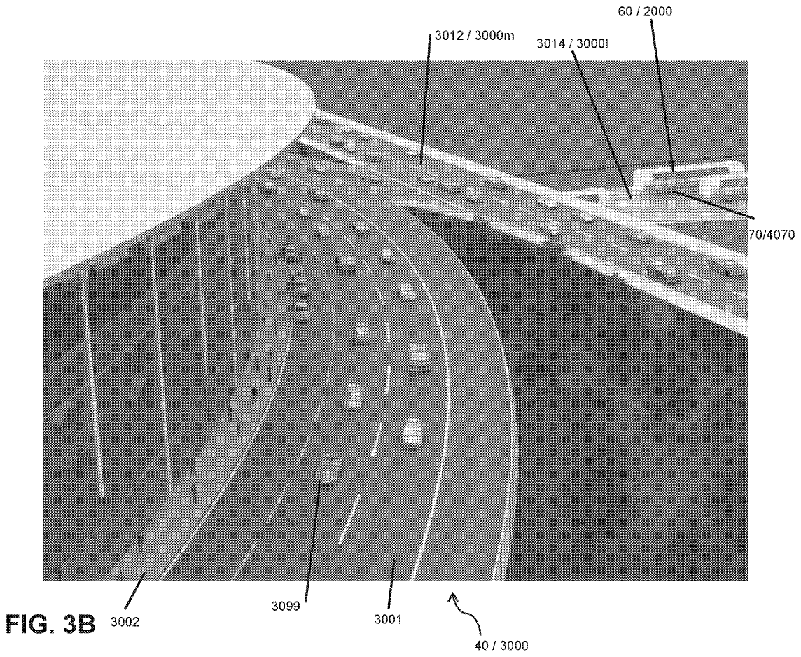

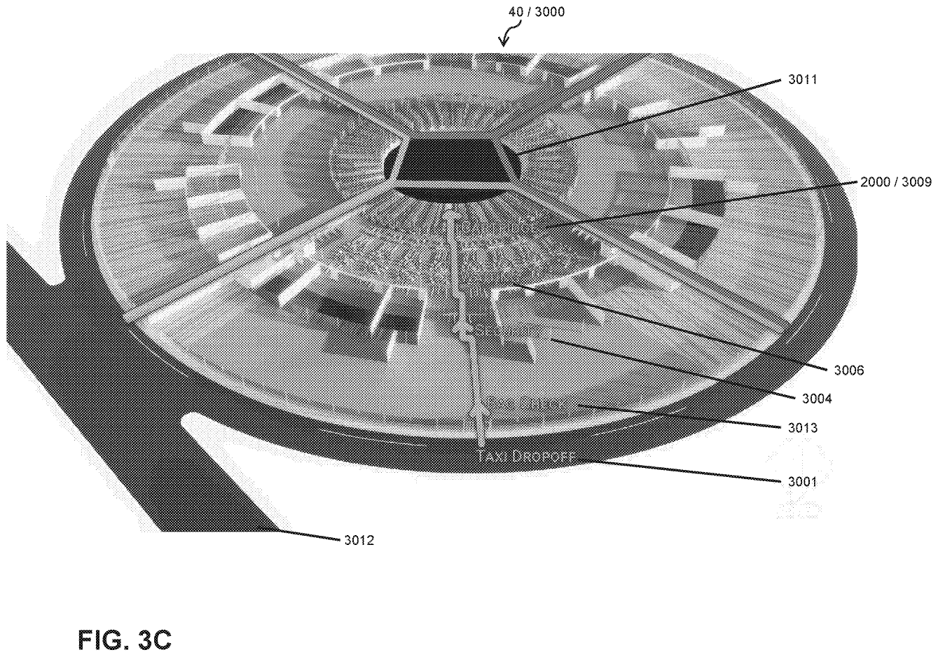

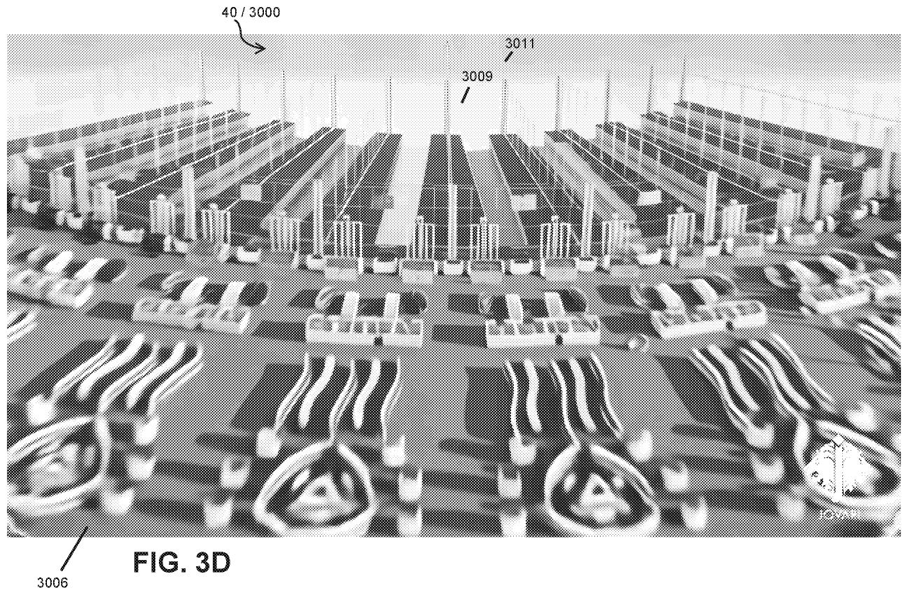

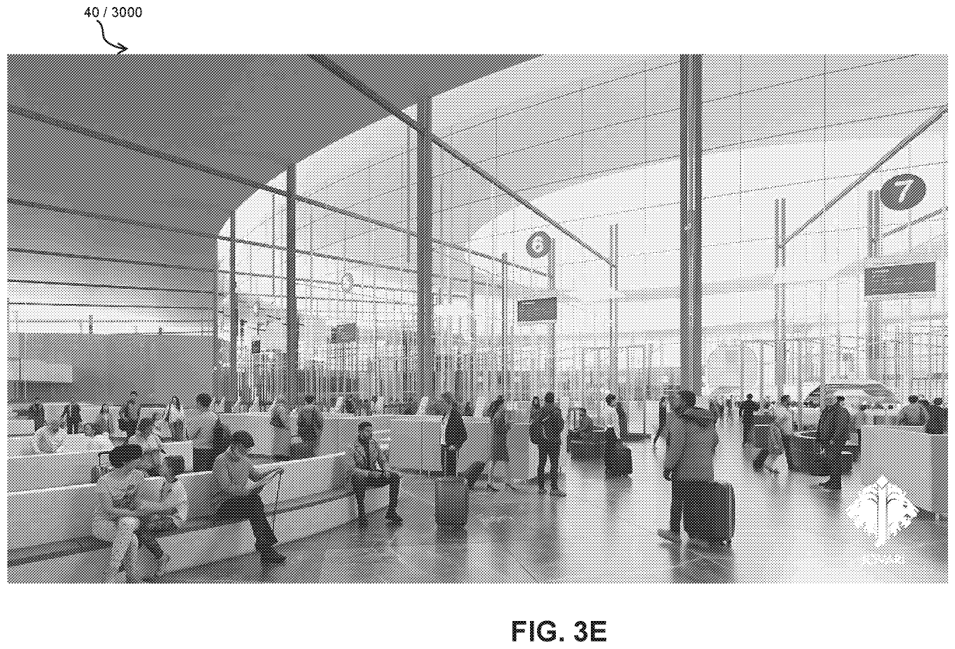

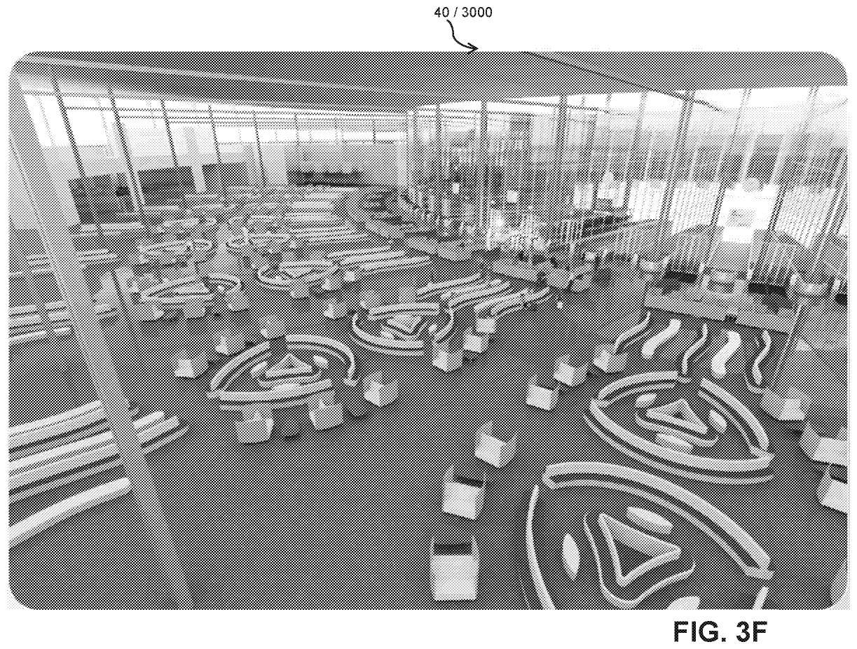

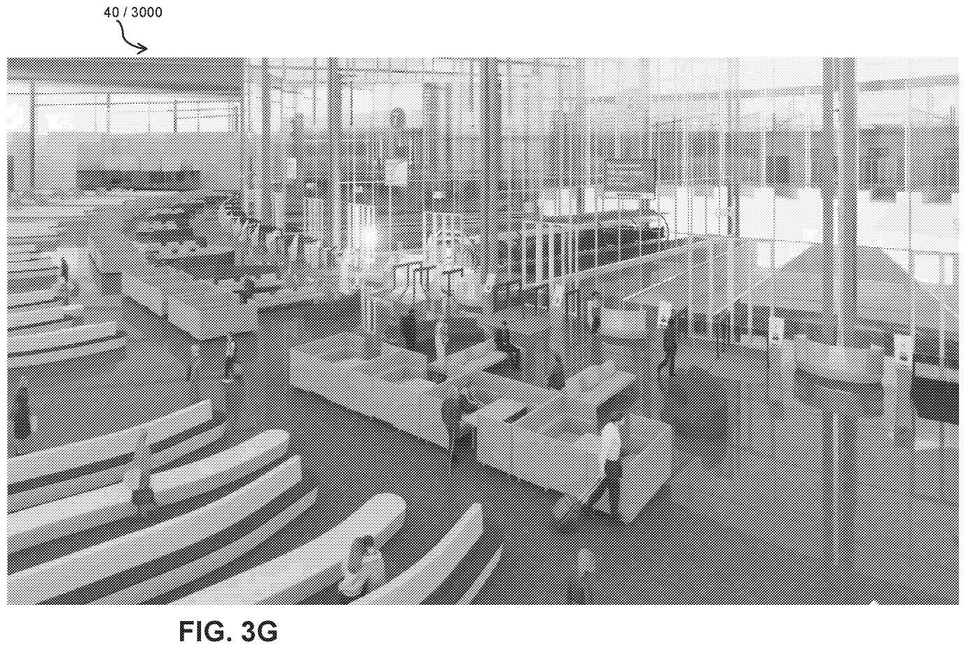

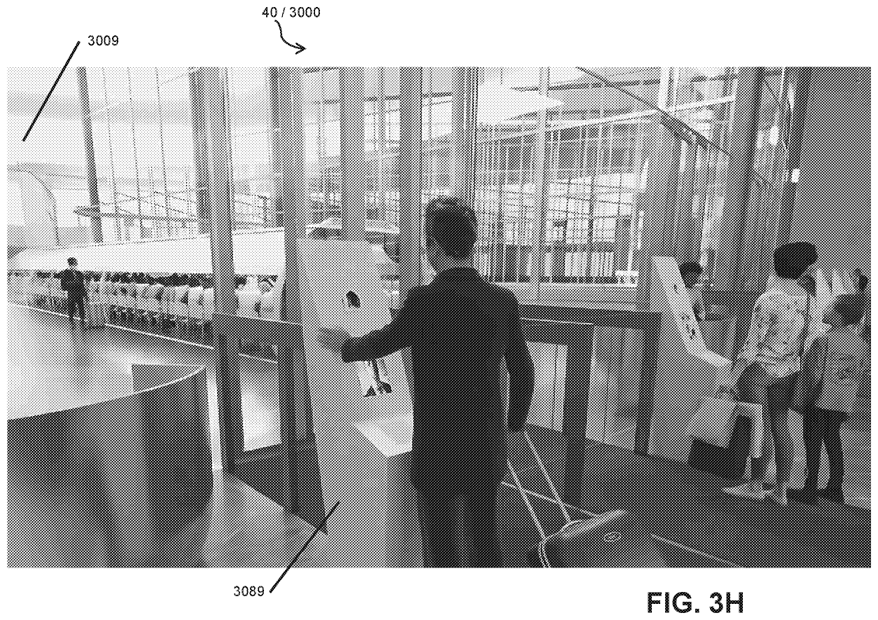

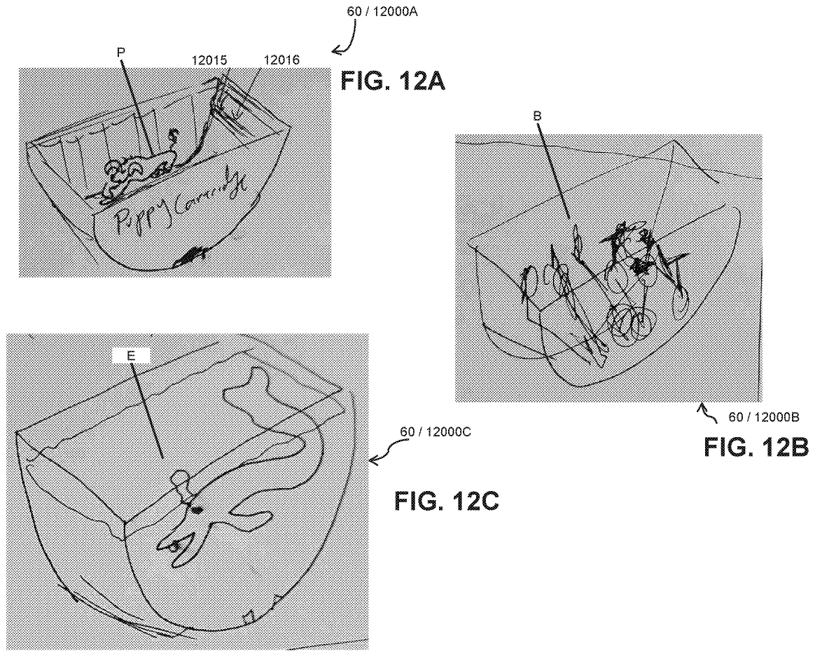

A passenger may begin their journey by being dropped off at a departure terminal 3000, which may be any suitable design, such as a circular design as shown in FIGS. 3 and 3A-3H. A passenger may arrive via a basic transport mechanism 3099 (e.g., a bus, personal automobile, taxi, etc.) via any suitable designated lane(s) 3012 (e.g., streets, highways, etc.) at an outer ring of lanes 3001, exit onto a sidewalk 3002, and enter a public area 3003 of terminal 3000. Optionally, at arrival, the passenger may drop off any suitable luggage at a bag drop or bag check 3013 (see, e.g., FIG. 3C), where bags and other general cargo may later be loaded into general cargo cartridges, such as general cargo cartridges 2000c of FIG. 2H, or specialized items may be loaded into special cargo cartridges, such as land animals (e.g., dogs, horses, etc.) that may be loaded in a land animal special cargo cartridge 12000A of FIG. 12A, inanimate special objects (e.g., bicycles B, scooters, etc.) that may be loaded in an inanimate object special cargo cartridge 12000B of FIG. 12B (e.g., for supporting niche travel needs, such as a cyclist traveling between cities and biking directly to and from different terminals with a flight in between), aquatic animals (e.g., fish, dolphins, eel E, etc.) that may be loaded in an aquatic animal special cargo cartridge 12000C of FIG. 12C filled with water or other suitable liquid or environmental conditions for sustaining aquatic life (e.g., for aquariums, sushi restaurants, etc.), and/or the like, each of which may be outfitted with any appropriate features (e.g., security camera(s) 12015, heating, ventilation, and air conditioning (“HVAC”) feature(s) 12016, and/or the like of cartridge 12000B for properly protecting the land animal special cargo (e.g., puppy P)). Therefore, specialized cargo cartridges may extend the system's utility.

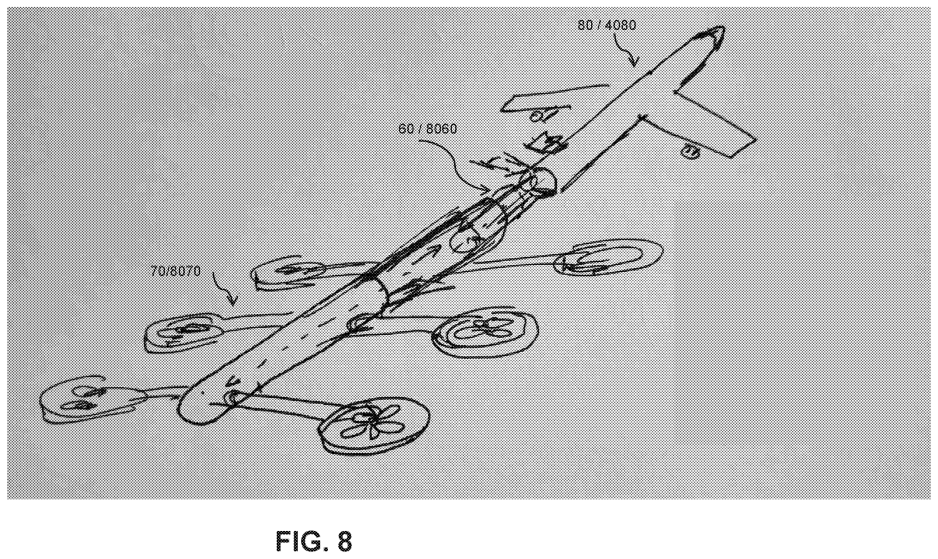

FIG. 8 shows a mover 70 that may be configured as a drone 8070 (e.g., a rescue drone). Drone 8070 may be configured to fly to any suitable vehicle 80 (e.g., an aerial vehicle (e.g., plane 4080)) whether on land (e.g., a runway 4014) or in the air and provide any suitable cartridge 60 (e.g., cartridge 8060) to an accessible cartridge space of the vehicle. For example, cartridge 8060 may be a specially designed fuel cartridge for enabling refueling of plane 4080. The illustrated layout of the propellers of drone 8070 is not meant to be limiting and is for exemplary purposes only, and a rescue drone might be powered by jets, turbines, and/or the like, such as when the drone may need to match a plane's speed in the air. This is just one of many possible layouts and designs for a rescue drone that can place or replace or remove a cartridge (e.g., for emergency mid-flight extraction), thereby enhancing operational efficiency and safety across diverse scenarios.

Continuing with a passenger's experience with terminal 3000, the passenger may proceed through any suitable security processing area 3004. Post-security, the passenger may enter a secure area 3006, where they may access any suitable shop(s) 3005, any suitable facilities 3007 (e.g., bathrooms), any suitable enhanced experiences 3008 (e.g., VIP or airline lounges, etc.), and/or the like. When boarding time arrives, the passenger's identity may be verified (e.g., via biometric scan or boarding pass (e.g., using any suitable passenger verification kiosk 3089 (e.g., a self-service kiosk or otherwise) that may be guarding an entrance to a particular cartridge room 3009) before entering a cartridge room 3009, such as one of any suitable number (e.g., 40) of such rooms in a compact layout of terminal 3000. One or more modular cartridges, such as a passenger cartridge 2000, may be temporarily positioned in a cartridge room 3009 (e.g., for loading or unloading passengers or any suitable cargo). Cartridges may enter and exit the terminal via center 3011, by being lifted up from underneath a cartridge room (e.g., by any suitable mover, truck, track, etc.). While this disclosure may show a departure terminal 3000 with a circular design, systems of this disclosure may allow for terminals with various types of shapes (e.g., as a footprint), including, but not limited to, rectangular, triangular, S-shaped, and the like.

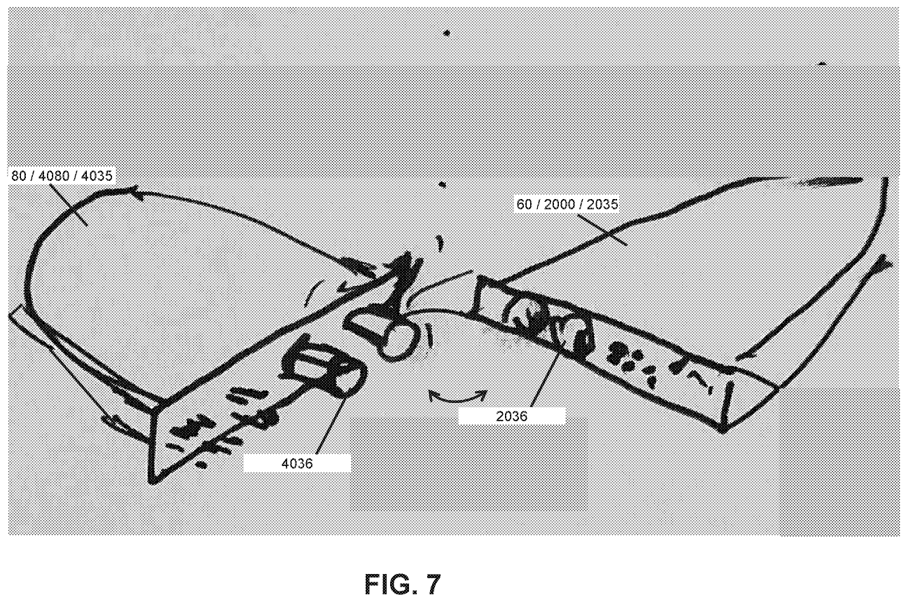

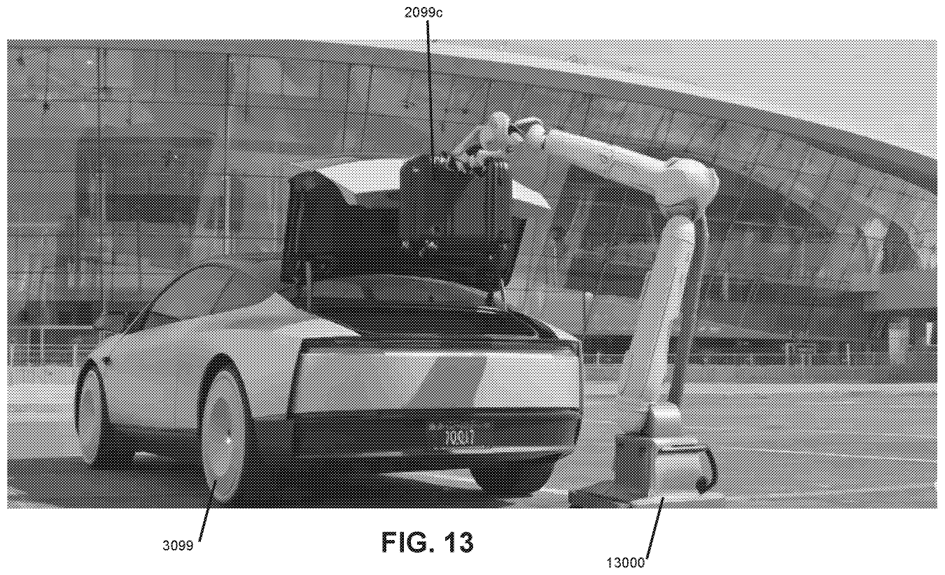

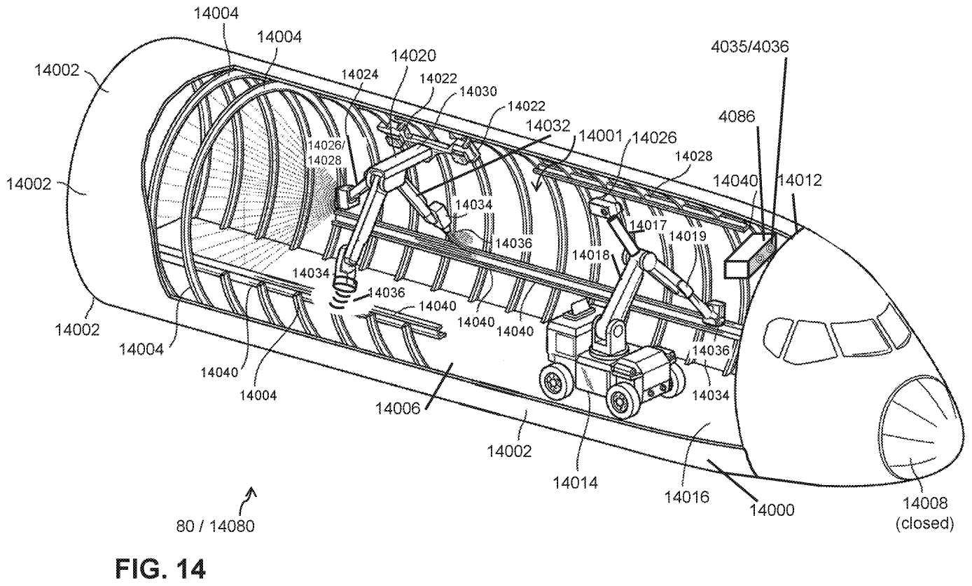

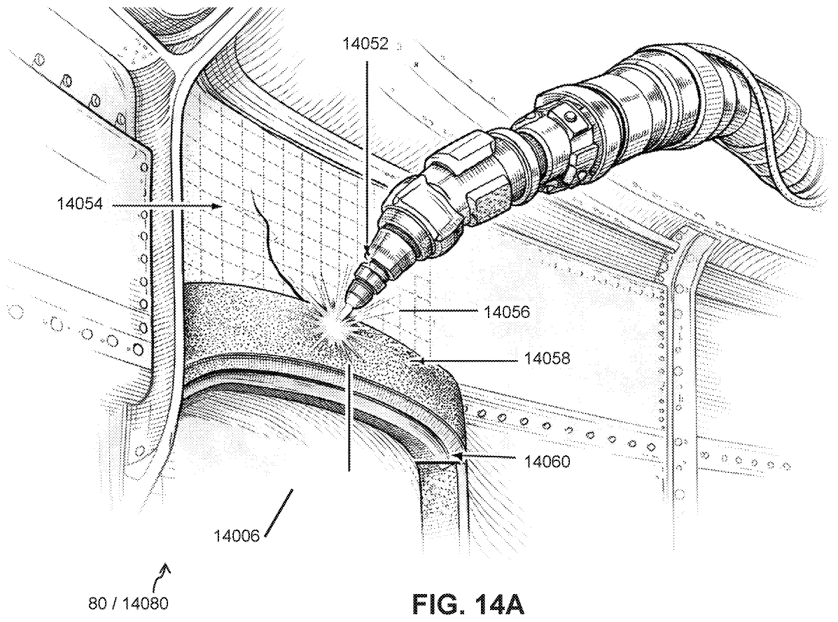

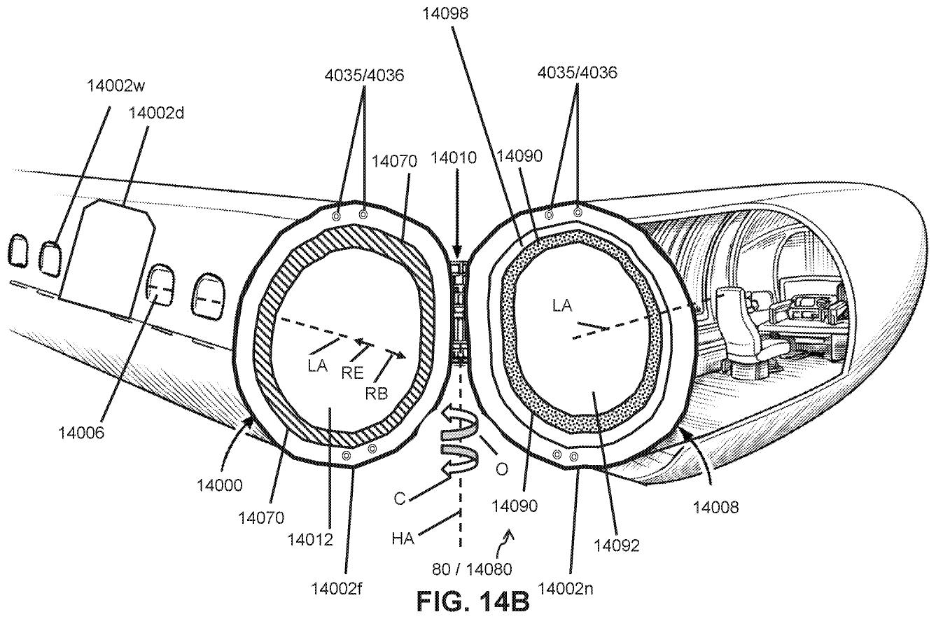

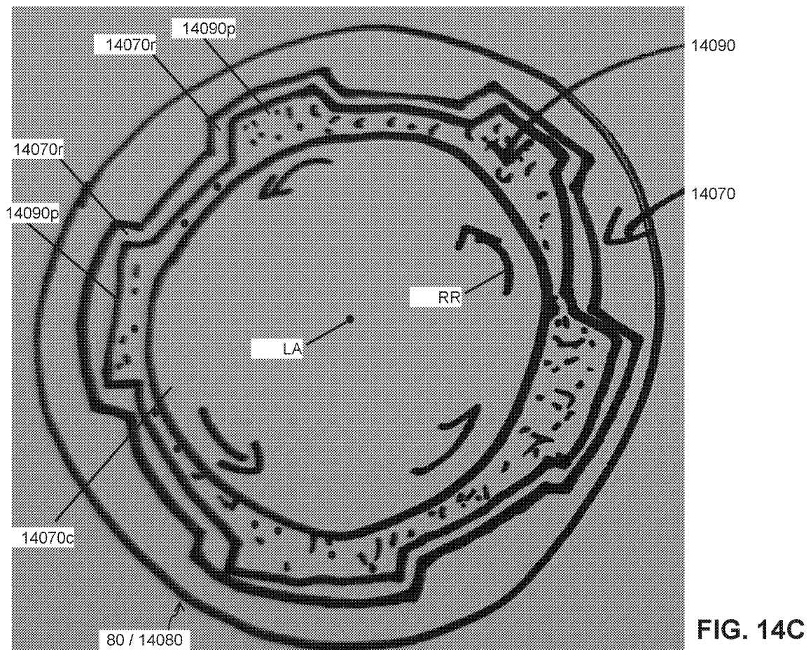

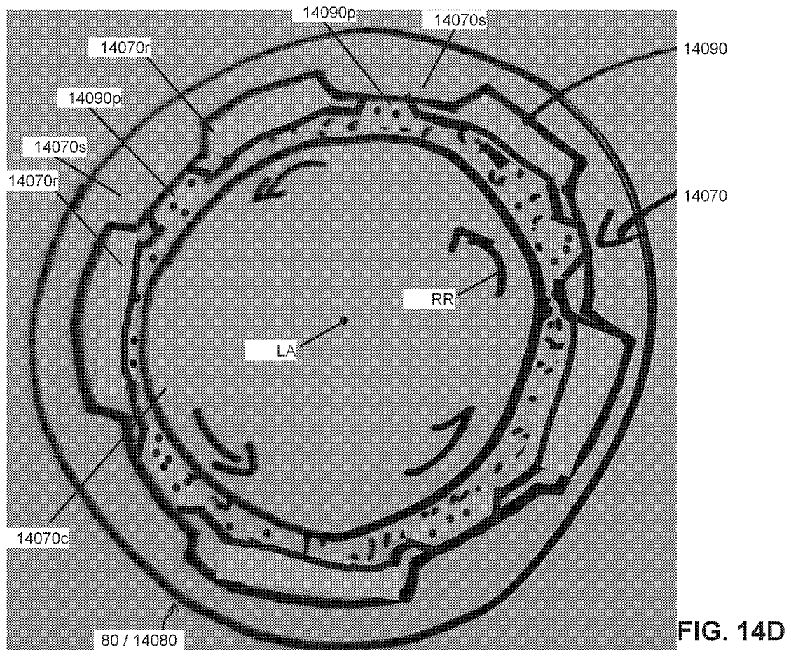

Inside a cartridge room 3009, the passenger may board a passenger cartridge space 2002p of modular passenger cartridge 2000 through any suitable rear-loading opening 2001r, any suitable front-loading opening 2001f, and/or any suitable side-loading opening 2001s. A side-loading opening 2001s may align with a particular row 2002r of seats 2038. This configuration may allow for simultaneous ingress or egress by different passengers in different rows or at different ends of a single row at the same time (e.g., at the same time, some passengers may enter space 2002p via front opening 2001f and travel along an aisle 2002a to their seat 2038 (e.g., a front aisle seat), while some other passengers may enter space 2002p via rear opening 2001r and travel along an aisle 2002a to their seat 2038 (e.g., a rear aisle seat), while yet some other passengers may enter space 2002p via side openings 2001s and travel along rows 2002r to their seats 2038 (e.g., a middle or window/side seats), etc.). This may drastically speed up a loading or unloading process compared to when all passengers must travel in the same direction along an aisle. A cartridge 2000 may be reconfigured between an open state (see, e.g., FIG. 2A and FIG. 2A′) and a closed state (see, e.g., FIG. 2C and FIG. 2C′) via one or more intermediate states (see, e.g., FIG. 2B and FIG. 2B′). For example, once all passengers are settled into their seats (e.g., once all seatbelts have been latched and/or all carry-on lockers have been closed), outer armrests 2031 may fold down (e.g., automatically or manually) and partially block opening(s) 2001s, and may be shaped to prevent passenger limbs from extending outward through opening(s) 2001s, while a protection component 2032 (e.g., curtain, shade, or the like of any suitable material (e.g., metal, cloth, etc.)) may be activated to roll up and partially or completely close side-loading opening(s) 2001s. Overhead compartment doors 2030 may be swung open or rolled up for enabling access to overhead compartments 2033 in the open configuration and lowered or rolled down to protect compartments 2033 in the closed configuration. Any suitable resource features (e.g., HVAC, fluid, electronic ports (e.g., entertainment, wireless communications, lighting, emergency requests, etc.), etc.) may run along the top (e.g., as upper resource features 2037) and/or bottom (e.g., as lower resource features 2039) of cartridge 2000 and may be configured to be coupled to reciprocal terminal systems of the vehicle receiving the cartridge during vehicle boarding and/or reciprocal terminal systems of the mover receiving the cartridge during mover loading. For example, as shown in FIG. 7, a cartridge 60 may include a cartridge resource feature connector 2035 and a vehicle 80 may include a vehicle resource feature connector 4035, where connector 2035 of cartridge 60/2000 may have any suitable coupler(s) 2036 (e.g., pin(s), port(s), etc.) for reciprocally coupling with any suitable coupler(s) 4036 (e.g., pin(s), port(s), etc.) of vehicle resource feature connector 4035 of vehicle 80/4080 when a cartridge 60 is properly loaded into a vehicle 80. Such coupling of a cartridge resource feature connector with a vehicle resource feature connector may enable climate control and power (or any other suitable resource control) for the cartridge during use in the vehicle by using the climate and power systems (or any other suitable resource control system(s)) of the vehicle (see, e.g., resource feature system(s) 4086 of vehicle 80 of FIG. 14 that may provide or be coupled to vehicle resource feature connector 4035 and coupler(s) 4036) rather than building such resource control system systems into the cartridge (e.g., a cartridge may be provided with power ports at each user's seat, but the cartridge itself may not have a power source but instead may couple the cartridge's power ports to a power source of the vehicle via connectors 2035 and 4035, a cartridge may be provided with vents at each user's seat (e.g., features 2037 independently controlled by a passenger from their seat 2038), but the cartridge itself may not have a source for generating heated or cooled air and instead may couple the cartridge's vents to an HVAC source of the vehicle via connectors 2035 and 4035, etc.). The same may occur for a connection between a cartridge 60 and a mover 70 (e.g., mover 70/4070 may include any suitable resource feature system 4076 (e.g., an HVAC system) that may include a connector 4077 with any suitable coupler(s) 4078 (e.g., pin(s), port(s), etc.) for reciprocally coupling with any suitable coupler(s) 2036 (e.g., pin(s), port(s), etc.) of cartridge resource feature connector 2035 of vehicle 60/2000 when a cartridge 60 is properly loaded into a mover 70, such that cartridge 60 may be functionally coupled to resource feature system 4076 of mover 70 when transporting cartridge 60 (e.g., personal HVAC interfaces may be provided above each seat 2038)). As shown in FIG. 2C, a cartridge may have a resource feature connector 2035 at each end of its cartridge body 2022b, such that either or each end may be coupled to any suitable resource feature connector, such as a resource feature connector 2035 of an adjacent cartridge (e.g., when two or more cartridges are loaded serially into a mover or vehicle), an adjacent mover resource feature connector 4077 (e.g., when the cartridge is loaded into a mover), an adjacent vehicle resource feature connector 4035 (e.g., when the cartridge is loaded into a vehicle), and/or the like. Resource feature(s) 2037/2039 may be configured to functionally couple different connectors 2035 of a cartridge (e.g., as any suitable HVAC ducts, electrical conductors, wires, busses, etc.) and provide functional interfaces at suitable locations along the cartridge for functional use (e.g., vents, power ports, video screens, audio speakers, etc.). FIG. 7 is just one example of how resource ports (e.g., HVAC, electronics, and fluid ports) for the cartridges and vehicles might line up. The specific layout and components will vary based on cartridge type, so this is just an example. However, it should be obvious that any suitable connector layout (e.g., customized or standardized layout) may enable cartridge resource feature connectors to easily dock and undock with resource feature connectors of any vehicle and/or mover and/or other cartridge that may share the connector layout, just as a USB connector can plug into any USB port of the same standard. Once all passengers are seated, the cartridge may be enclosed (e.g., at least on its sides if not also one or both ends) and ready for transport to a vehicle 80 by a mover 70.

Any suitable transport pod or cartridge mover 70 may be provided and manually controlled or at least partially or completely autonomously controlled for moving cartridges 60 between terminals 40 and vehicles 80, including loading cartridges into vehicles from movers and unloading cartridges from vehicles onto movers, loading cartridges onto movers from terminals and unloading cartridges from movers onto terminals, and/or the like. A mover may be configured to have any suitable cameras and/or other sensors around them to detect intrusion and prevent objects from being inserted into the mover and/or the cartridge(s) the mover may be moving after leaving a secure terminal area on their way to a vehicle. Autonomous movers may at certain times be controlled remotely by any suitable entities (e.g., administrator A of subsystem 10, etc.) so that they can be directed by humans in the event of a decision failure or other issue. The movers, which may be meant to leave the airport, such as to go pick up cartridges at remote terminals or cargo at warehouses and/or distribution centers, might have thicker outsides, additional security measures, and/or might even have a human drive seat, such that they can be driven into areas that may not yet allow autonomous vehicles.

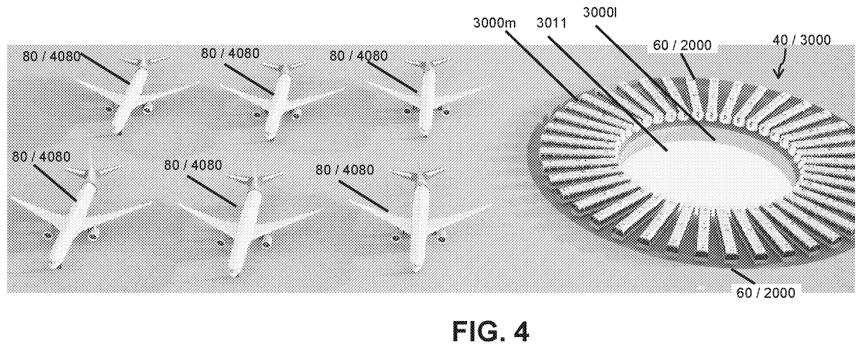

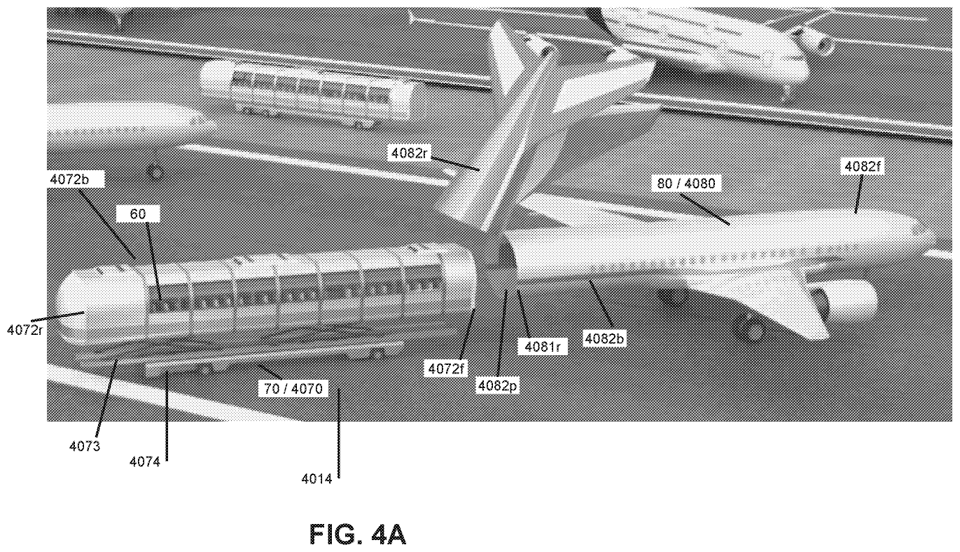

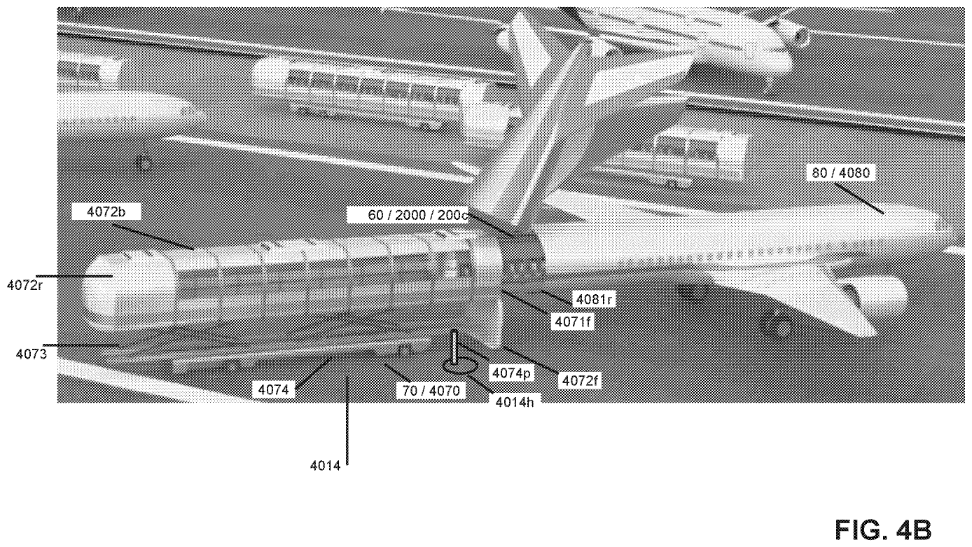

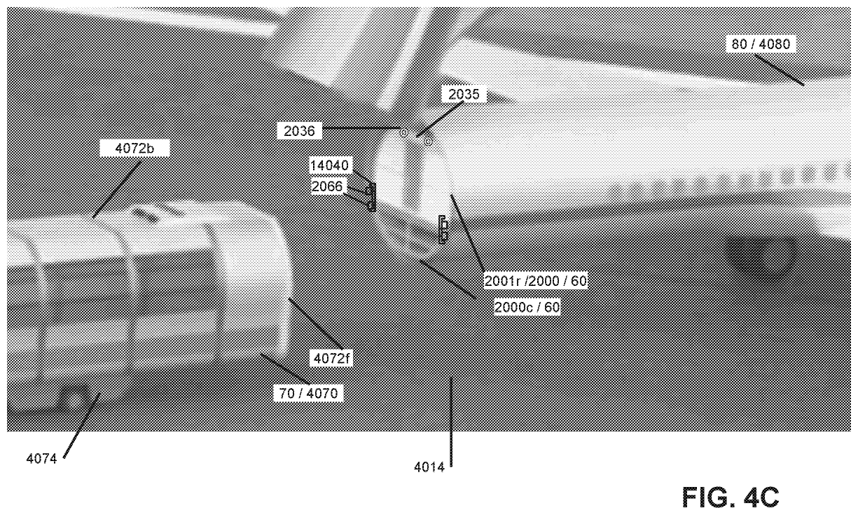

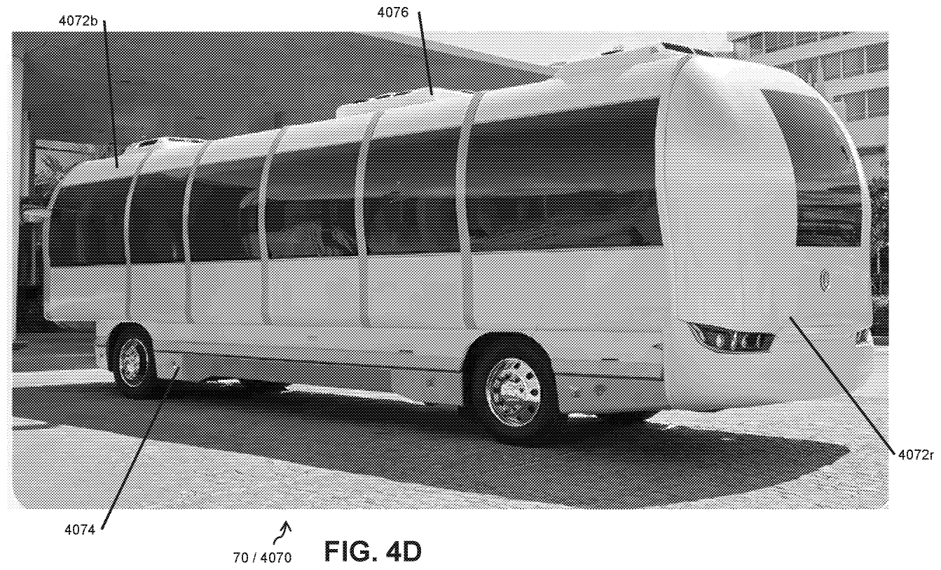

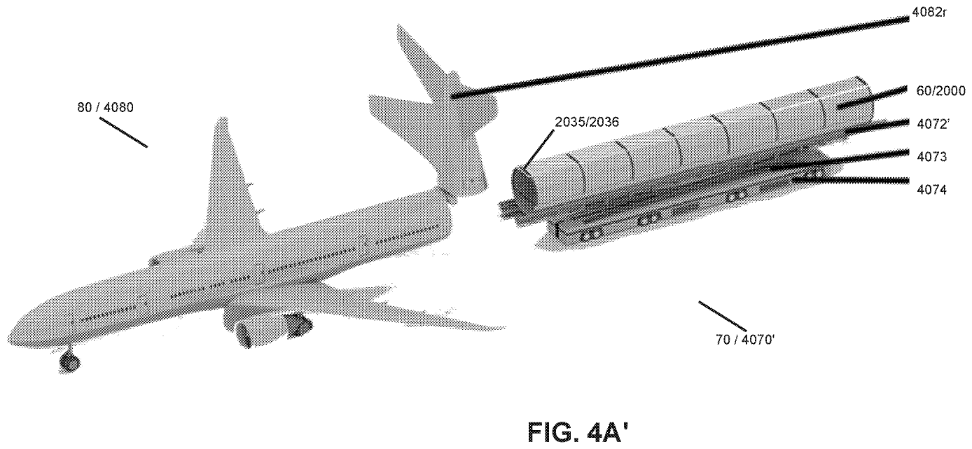

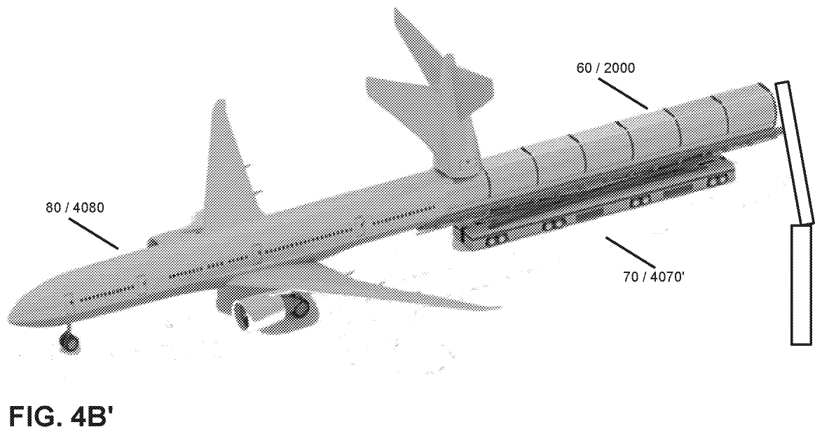

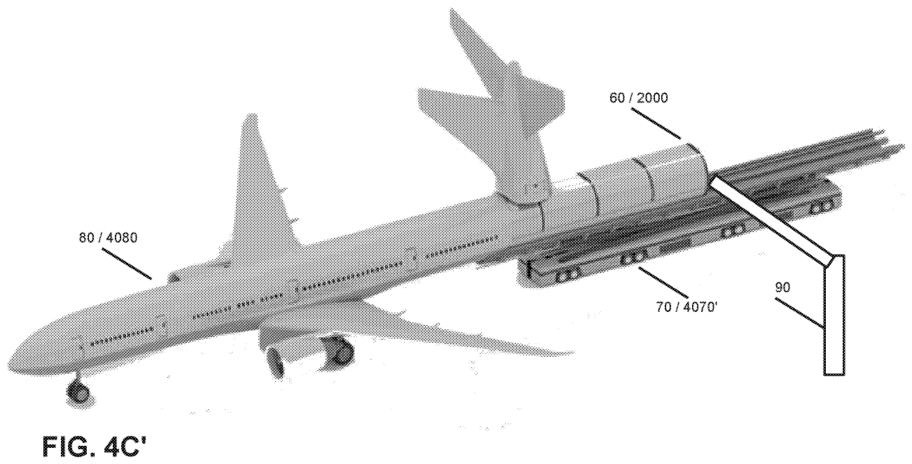

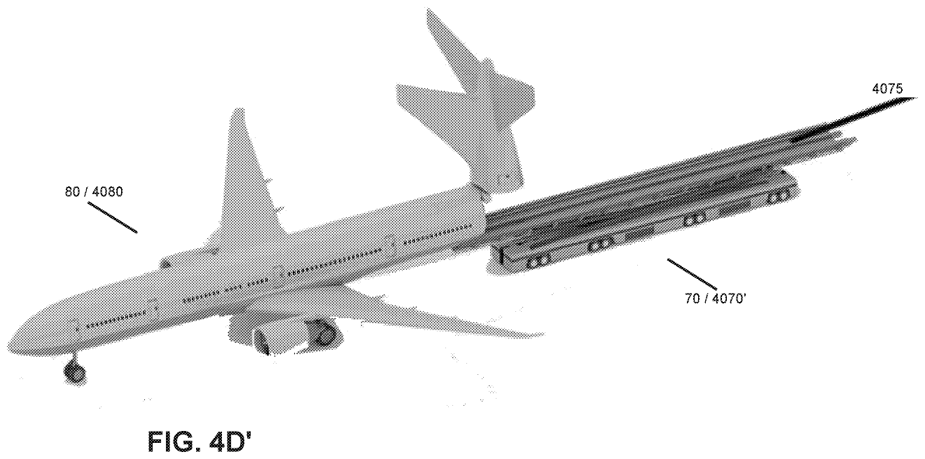

As shown in FIG. 4, terminal 3000 may be configured to service up to 40 passenger cartridges 3000 simultaneously in a main level 3000m above a lower level 30001 about central area 3011, although the terminal may be designed in other suitable ways to handle any other suitable number. As shown, an area of the array of cartridges 3000 about central area 3011 may be substantially the same as 6 airplanes 4080, illustrating the substantial footprint savings that may be achieved by such a terminal over alternative solutions. Therefore, the system's efficiency may be further highlighted by its spatial design, where, for example, 40 passenger cartridges can fit within the footprint of just 6 traditional planes 4080. This compact arrangement may reduce walking distances for passengers, staff, and crew, thereby saving significant time, labor, energy, and airport space.

Any suitable mover 70 (e.g., mover 4070 of FIGS. 2D and 2E) may be configured to transport a cartridge into and/or from room 3009, and the mover 70/4070 may be configured to travel into and from terminal 3000 via any suitable lane(s) 3014, such as from or two any suitable vehicle 80 located remotely from terminal 3000 (e.g., as shown in FIG. 3B, movers 70 may travel along lane(s) 3014 of a lower level 30001 underneath the main level 3000m of terminal 3000 (e.g., the level providing lane(s) 3012, lanes 3001, sidewalk 3002, public area 3003, bag check 3013, security 3004, secure area 3006, rooms 3009, etc.) and into a central area or opening 3011 that may span both the lower level and the main level, such that the movers may be configured to raise and lower a cartridge from the lower level to the main level for use in a cartridge room 3009 of the main level). Although central area 3011 may be shown as open-air or without a roof in some embodiments, it is to be understood that the central area may be covered in other embodiments (e.g., when the terminal is in cold weather climates).

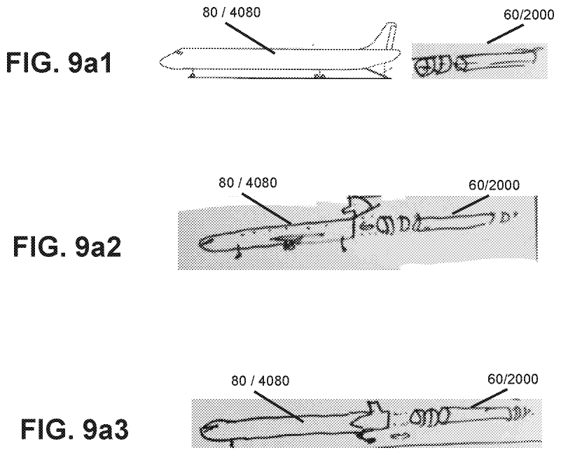

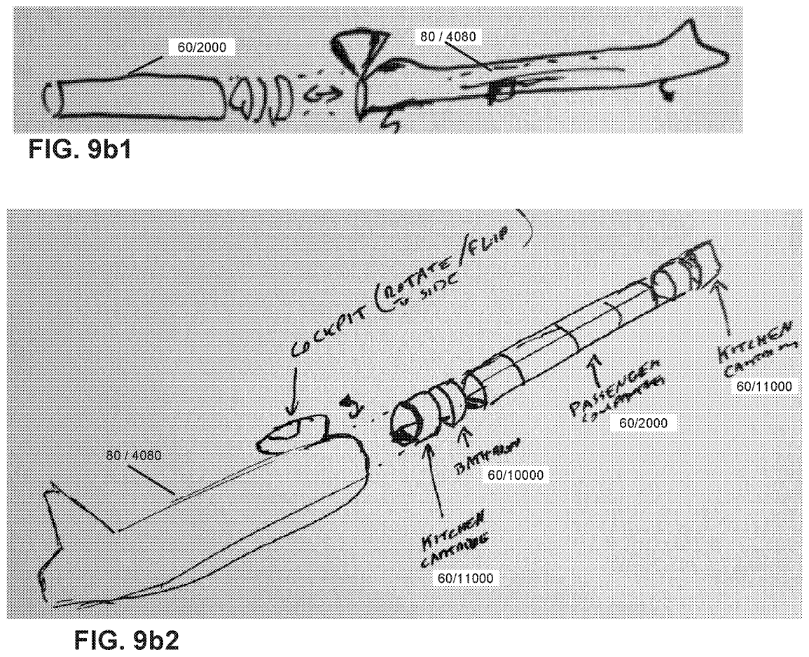

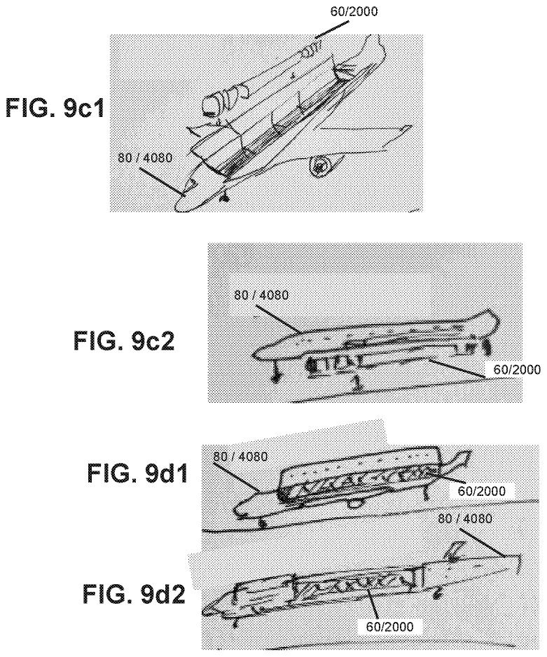

In some embodiments, as shown in FIGS. 2D, 2E, 4A, 4B, 4C, and 4D, a mover 4070 may include a drivable (e.g., wheeled) base 4074 that may be controlled manually and/or autonomously to move mover 4070 along lane(s) 3014 and/or otherwise for traveling between a vehicle 80 (e.g., airplane 4080) and a terminal 40 (e.g., terminal 3000). Mover 4070 may also include a platform 4072 (e.g., body 4072b of FIGS. 2D, 2E, 4A, 4B, and 4C, or a flatbed platform component 4072′ (e.g., with tracks 4075) of FIGS. 2F, 2G, 4A′, 4B′, 4C′, and 4D′) for supporting or holding a cartridge 60, and a lifter 4073 (e.g., a scissor lift and/or any other suitable mechanism (e.g., hydraulics, magnets, actuators, pistons, wheels, etc.)) that may be configured to raise or lower platform 4072 with respect base 4074 (e.g., for meeting various height requirements of terminals, vehicles, etc. at different stages of use). An airplane or any other suitable vehicle 4080 may include a main body 4082b (e.g., a fuselage) between a front portion 4082f (e.g., a cockpit) and a rear portion 4082r (e.g., a tail), where the main body 4082b may be provided with one or more cartridge receiving spaces 4082p. Cartridge receiving space 4082p may be made accessible to a cartridge via a main body opening (e.g., a main body rear opening 4081r) in any suitable manner (e.g., by rotating rear portion 4082r upwardly relative to main body 4082b as shown in FIGS. 4A-4D′ for exposing main body rear opening 4081r). However, in other embodiments, it may open in other ways, such as, but not limited to, from the front, bottom, side, rear, and/or top, with different opening methods (see, e.g., FIG. 9a1-9d2).

As shown in FIGS. 2D and 2E, mover 4070 (e.g., by controlling base 4074 and lifter 4073) may be positioned within central area 3011 with base 4074 supported on the lower level and a rear end opening 4071r of a mover body cartridge space 4072p of a mover body 4072b of mover 4070 raised up to (e.g., using lifter 4073) and positioned (e.g., using base 4074) at a front end of room 3009 (e.g., at a front end of a track 3009t of room 3009). Then, cartridge 2000 may be configured to move out from room 3009 (e.g., by any suitable control mechanism(s) along track 3009t in the direction of arrow DS) and through rear end opening 4071r into mover body cartridge space 4072p of mover 4070. Then, once cartridge 2000 is fully positioned within mover body cartridge space 4072p of mover 4070, a rear door 4072r may be closed to cover rear end opening 4071r to fully seal cartridge 2000 safely within mover body cartridge space 4072p of mover 4070, and then mover body 4072b of mover 4070 may be lowered down (e.g., in the direction of arrow DD by lifter 4073), such that mover 4070 and its mover body 4072b (e.g., as loaded with one or more cartridges) may be able to travel out from central area 3011 via a passageway underneath a portion of terminal 3000 (e.g., along the lower level under the main level (e.g., underneath one or more rooms 3009)), such that mover 4070 with cartridge 2000 may reach lane(s) 3014 for traveling to a remotely located vehicle 80 (e.g., plane 4080) that may then be loaded with cartridge 2000 by mover 4070. For example, as shown in FIG. 4A, once loaded mover 4070 arrives at opened plane 4080, lifter 4073 may be used to lift mover body 4072b up to align with the height of a cartridge receiving space 4082p (e.g., by aligning a front opening 4071f of space 4072p of body 4072b with a rear opening 4081r of space 4082p of vehicle body 4082b). Then, as shown in FIG. 4B, a front door 4072f of mover body 4072b may be moved (e.g., lowered) to open front opening 4071f of space 4072p such that cartridge 2000 may be passed out using any suitable mechanism(s) (e.g., rollers, pushers, tracks, etc.) from mover space 4072p through opening 4071f and into vehicle space 4082p through opening 4081r. In some embodiments, a track or any other suitable loading mechanism 4075 of a mover 70 may be configured to interact with any suitable loading mechanism(s) of a cartridge (e.g., track 4075 of a mover 4070 may interact with any suitable track interaction mechanism(s) 2065 (e.g., wheels, blades, etc.) of the cartridge (e.g., along a top and/or bottom of cartridge body 2022b)) to push a cartridge 60 from the mover into a vehicle 80 or into a terminal 40 and/or pull a cartridge 60 onto the mover from a vehicle 80 or from a terminal 40. Such a loading mechanism 4075 may be powered by any suitable power supply of mover 70 for pushing and/or pulling cartridge 60 without requiring cartridge 60 to have its own power system (e.g., mechanism 4075 may be powered to actuate in any suitable manner for moving cartridge interaction mechanism(s) 2065 relative to the mover for loading the cartridge onto the mover or unloaded the cartridge from the mover). Similarly, in some embodiments, a vehicle may be provided with any suitable loading mechanism(s) that may be configured to interact with any suitable loading mechanism(s) of a cartridge (e.g., one or more continuous (e.g., C-channel) cartridge tracks 14040 along interior side(s) of a vehicle 80/14080 may interact with (e.g., receive if not also advance) any suitable vehicle interaction mechanism(s) 2066 (e.g., wheels, grooves, nubs, etc.) of the cartridge (e.g., along each side of cartridge body 2022b)) to pull a cartridge 60 from the mover into a vehicle 80 and/or push a cartridge 60 onto the mover from a vehicle 80. Additionally or alternatively, an independent robot (e.g., any suitable independent subsystem 90) may be configured to push a cartridge off of a mover (e.g., into a terminal or vehicle) or onto a mover (e.g., from a terminal or vehicle) (e.g., as shown in FIG. 4B′ and 4C′, where such a robot may be movable along a runway but not loadable onto a vehicle, or may be loadable onto a vehicle for use at any suitable destination of the vehicle). Therefore, in some embodiments, a cartridge may be provided with any suitable mechanical features for enabling cartridge-mover loading/unloading, but may not include its own electronic actuators for doing so but instead may relay on the force of any suitable actuator(s) of a mover and/or a vehicle and/or a robot such that the cartridge may be light-weight and/or be as uncomplex as possible. Such mechanism(s) for transitioning a cartridge between a mover and a terminal or vehicle may be used for any suitable cartridges including passenger cartridges and cargo cartridges, including cartridges that might be stacked on top of one another (see, e.g., FIGS. 4A-4C, where a cartridge 60 may include an upper passenger cartridge 2000 and a lower cargo cartridge 2000c, which may be loaded/unloaded simultaneously by a single mover or serially by the same or different movers (e.g., each one of cartridge 2000 and 2000c may include mechanism(s) 2066 for interacting with tracks 14040 of the vehicle)). As shown in FIGS. 2H and 2I, when a vehicle is unloaded into an arrival terminal, lower cargo cartridge 2000c may be unloaded from a mover onto a cargo terminal track or podium 3040c of a cartridge room 3009 and upper passenger cartridge 2000 may be unloaded from the same or different mover onto a passenger terminal track or podium 3040p of the same cartridge room 3009, such that a passenger may exit the passenger cartridge and immediately access their cargo from the cargo cartridge in the same cartridge room (or in a room in a level directly below the passenger cartridge room (e.g., if the cargo cartridge and passenger cartridge of FIGS. 4A-4C stay on the mover when positioned in the terminal (see, e.g., FIGS. 2F and 2G where cargo cartridge 2000c may be positioned directly below cartridge 2000 on a mover)). The reverse may occur at a departure terminal. As shown in FIG. 4C, front door 4072f may be moved (e.g., raised) to close front opening 4071f and lifter 4073 may re-lower mover body 4072b of platform 4072, such that mover 4070 can be re-used to pick up another cartridge from terminal 3000. When using mover body 4072b, that body 4072b may have front and/or rear covers (e.g., doors 4072r, 4072f, etc.) that may be opened or closed, so as to seal the mover's contents (e.g., cartridge(s)) from weather and protect passengers and cargo from exiting the mover at the wrong time.

In some other embodiments, as shown in FIG. 2F and/or FIG. 2G and FIG. 4A′, 4B′, 4C′, and 4D′, a mover 4070′ may not include a mover body for enclosing a cartridge, but may instead include a flatbed platform component 4072′ (e.g., with tracks 4075) for supporting a cartridge thereon. As shown in FIGS. 2F and 2G, mover 4070′ (e.g., by controlling base 4074 and lifter 4073) may be positioned underneath room 3009 with platform component 4072′ positioned under and exposed by an opening 30090 in a floor of room 3009, whereby cartridge 2000 may be supported on and held by platform component 4072′ for positioning cartridge 2000 within room 3009 for loading/unloading. Once loaded or unloaded, cartridge 2000 and platform component 4072′ may be lowered down (e.g., in the direction of arrow DD by lifter 4073), such that mover 4070′ and its platform component 4072′ (e.g., as loaded with one or more cartridges) may be able to travel out from under room 3009 via a passageway underneath a portion of terminal 3000 (e.g., along the lower level under the main level (e.g., underneath one or more rooms 3009)), such that mover 4070′ with cartridge 2000 may reach lane(s) 3014 for traveling to a remotely located vehicle 80 (e.g., plane 4080) that may then be loaded with cartridge 2000 by mover 4070′. For example, as shown in FIG. 4A′, once loaded mover 4070′ arrives at opened plane 4080, lifter 4073 may be used to lift platform component 4072′ up to align with the height of a cartridge receiving space of plane 4080. Then, as shown in FIG. 4B′, cartridge 2000 may be moved using any suitable mechanism(s) (e.g., rollers, pushers, tracks (e.g., tracks 4075), etc.) of from mover platform component 4072′ and into a vehicle space of plane 4080 (e.g., as guided by tracks 4075, mover 4070′ may move a cartridge 2000 to an awaiting aircraft, sliding it into the fuselage through an open rear entrance (e.g., into space 4082p through opening 4081r)). Then, as shown in FIG. 4D′, lifter 4073 may re-lower mover platform component 4072′, such that mover 4070′ can be re-used to load another cartridge at terminal 3000. When not using mover body 4072b, curtain(s) 2032 and/or doors 2030 and/or other structural component(s) of cartridge 2000 may be opened or closed, so as to seal the cartridge's contents (e.g., passenger(s), cargo, etc.) from weather and protect them from exiting the cartridge at the wrong time.

Although cartridge receiving space 4082p of vehicle 4080 may be made accessible by an open rear entrance (see, e.g., FIGS. 4A-4D′ and 9a2 (e.g., by flipping up a tail portion) or FIG. 9a1 (e.g., by rotating down an entrance ramp below a tail portion or using the tail portion) or FIG. 9a3 (e.g., by flipping a tail portion sideways) or the like) for rear loading cartridge(s), alternative aircraft entry methods may include, but are not limited to, an open front entrance (see, e.g., FIG. 9b1 (e.g., by flipping up a front portion) or FIG. 9b2 (e.g., by flipping a front portion sideways) or the like) for front loading cartridge(s), an open top entrance (see, e.g., FIG. 9c1 (e.g., by flipping open top portion(s) of the main body) or the like) for top loading cartridge(s), an open bottom entrance (see, e.g., FIG. 9c2 (e.g., by flipping open bottom portion(s) of the main body) or the like) for bottom loading cartridge(s) (e.g., a bottom-loading approach where a cartridge may slide up), an open side entrance (see, e.g., FIG. 9d1 (e.g., by flipping open side portion(s) of the main body upwardly) or FIG. 9d2 (e.g., by flipping open side portion(s) of the main body laterally) and/or the like) for side loading cartridge(s), and/or the like. The aircraft's versatility in loading configurations enhances operational flexibility. These variations accommodate different aircraft designs and operational needs.

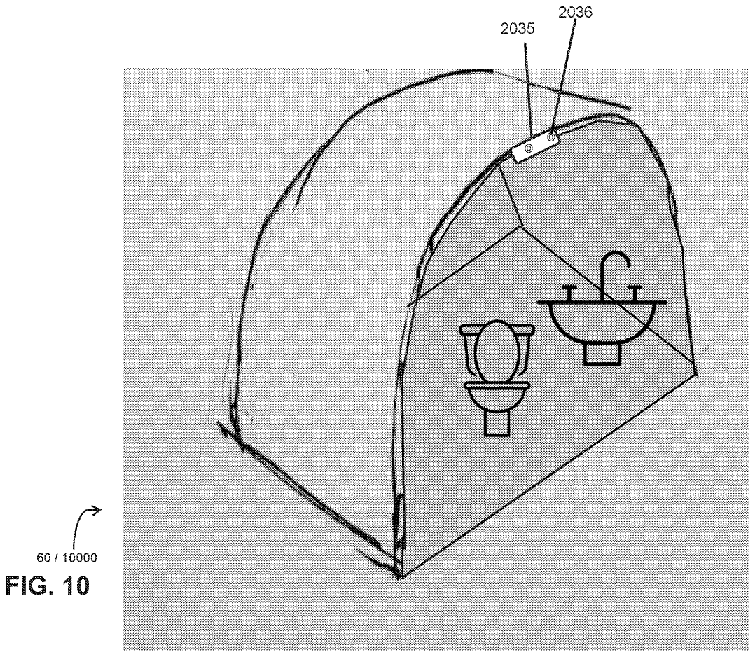

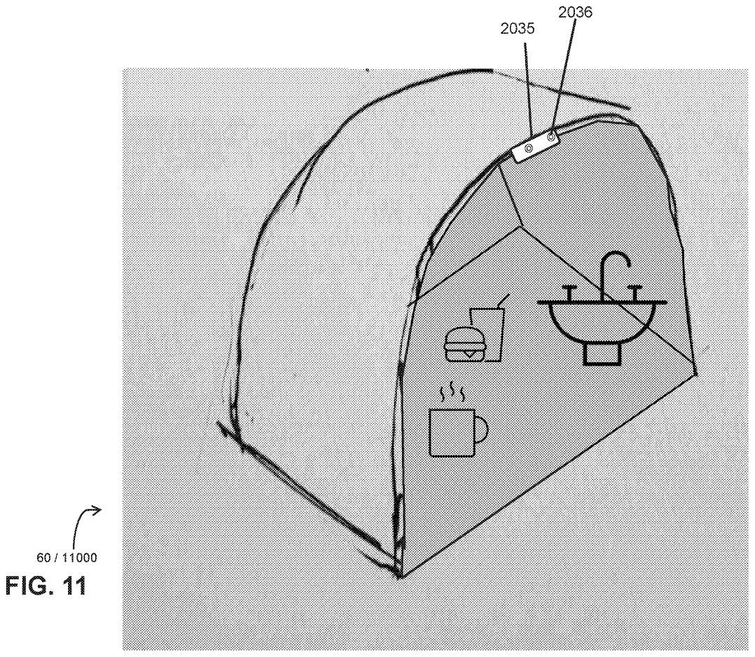

In some embodiments, a cartridge may align with emergency exits and may lock into place, coupling HVAC and electronic ports to the aircraft systems (see, e.g., FIG. 7). Additional cartridges, such as a bathroom cartridge 10000 of FIG. 10 and/or a kitchen cartridge 11000 of FIG. 11, may slide in before or after a passenger cartridge, depending on the plane's design. Such a bathroom cartridge 10000 and/or such a kitchen cartridge 11000 can slide into a rear, front, or any other suitable portion of a vehicle, depending on how the plane opens (e.g., before or after passenger cartridges). By enabling bathrooms and/or kitchens and/or the like to be swapped in and out of a vehicle may eliminate delays for cleaning and repair and restocking of such service areas. With loading complete, the aircraft may be closed (e.g., by rotating back the tail portion in FIGS. 4A-4C) and locked, and may then safely take off.

When an aircraft lands, the process may reverse. Passageway 4082p of plane 4080 may be made accessible (e.g., by opening a rear entrance (e.g., by flipping up tail portion 4082r), etc.), and any suitable mover 70 (e.g., mover 4070, mover 4070′, etc.) may move into position (e.g., the position of FIG. 4B or FIG. 4C′) such that one or more cartridges (e.g., cartridge 2000) may be removed from passageway 4082p and onto the mover (e.g., via tracks 4075 or otherwise). Then, mover may transport the cartridge(s) to any suitable destination (e.g., an arrivals terminal, which may be distinct from or the same as a departures terminal (e.g., 3000)). Passengers may exit cartridge 2000 at the destination via reopened side openings 2001s with armrests 2031 raised and curtains 2032 reopened and/or via opening 2001f and/or opening 2001r. When a passenger cartridge is being transitioned between a mover and a terminal or vehicle or otherwise, armrest(s) 2031 may be lowered and curtain(s) 2032 raised for preventing a passenger from dangerously accessing side opening(s) 2001s (e.g., preventing a passenger from falling out of the cartridge and/or having their appendages injured by an end of a terminal or mover or vehicle during movement of the cartridge). However, once a passenger cartridge has been securely loaded onto a mover, a terminal, or a vehicle, curtains 2032 may be lowered and armrest(s) 2031 may be raised for enabling a passenger to safely access side opening(s) 2001s for any suitable purpose (e.g., for enabling a passenger to clearly access a door or window of a mover or vehicle (see, e.g., vehicle door 14002d and/or window 14002w of FIG. 14B) via a side opening 2001s and/or to clearly enter or exit the cartridge at a terminal. In some embodiments, where a passenger may be trusted and/or certain dangers are otherwise obviated, a cartridge may be provided without armrest(s) 2031 and/or curtain(s) 2032, and side opening(s) 2001s may be accessible and unencumbered throughout the use of a cartridge. In some embodiments, curtain(s) 2032 may be robust and structurally solid (e.g., metal) and/or less so (e.g., cloth (e.g., translucent mesh material)). In some embodiments, curtain(s) 2032 may be at least partially transparent such that they may remain covering opening(s) 2001s and a passenger may still see therethrough (e.g., to a window of a vehicle or mover). In some embodiment(s), curtain(s) 2032 may be useful to prevent debris from entering passenger cartridge space 2002p via opening(s) 2001s (e.g., when a cartridge is being stored between uses). After deplaning into a secure area of the destination (e.g., area 3006), passengers may proceed through customs if international, and may use facilities (e.g., facilities 3007 (e.g., a bathroom)) before or during awaiting processing. Cleared passengers may exit to a public area (e.g., area 3003), where they can use other bathrooms and stores, retrieve luggage from cargo cartridges, and leave (e.g., via sidewalks 3002 and lanes 3001). In some embodiments, cargo 2099c may be automatically retrieved from any suitable cartridge 60 (e.g., cargo cartridge 2000c) and automatically brought to a passenger or their transport mechanism 3099 by any suitable autonomous transport cargo mover 13000, as shown in FIG. 13 (e.g., an automated bag bot may be configured to transport passenger's belongings and load them into driverless taxis or other suitable transport mechanisms 3099.

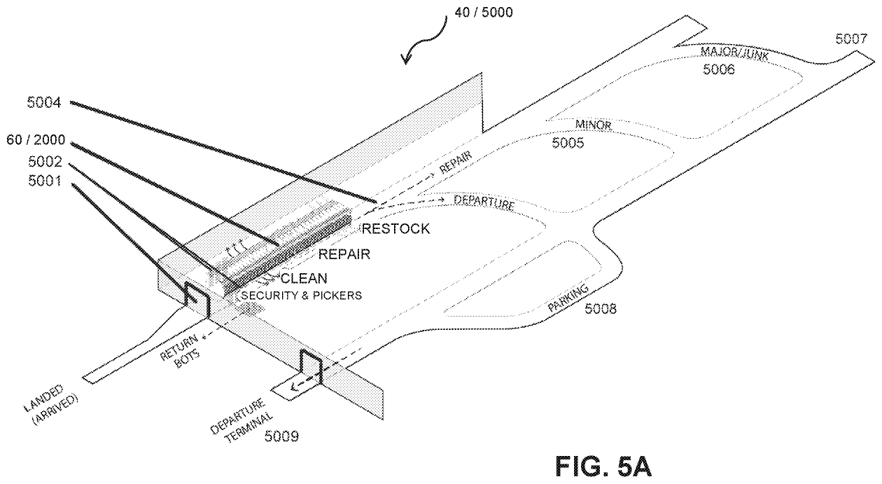

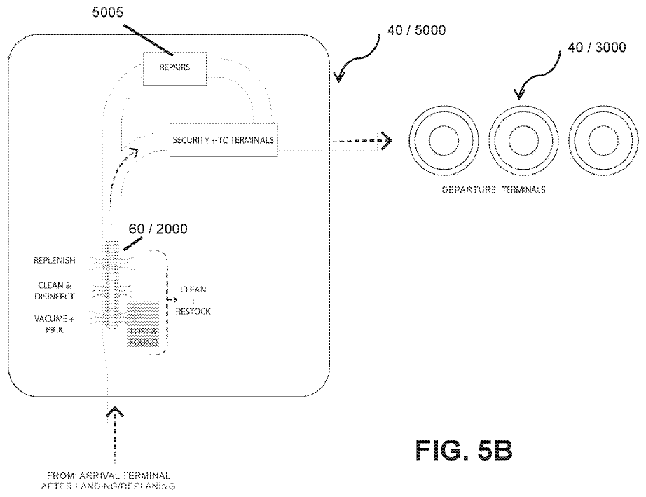

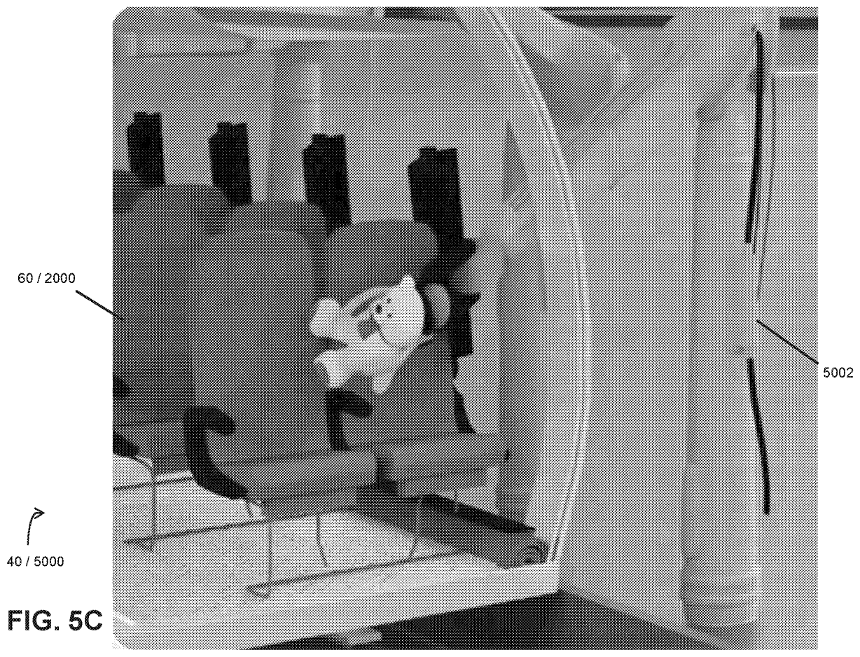

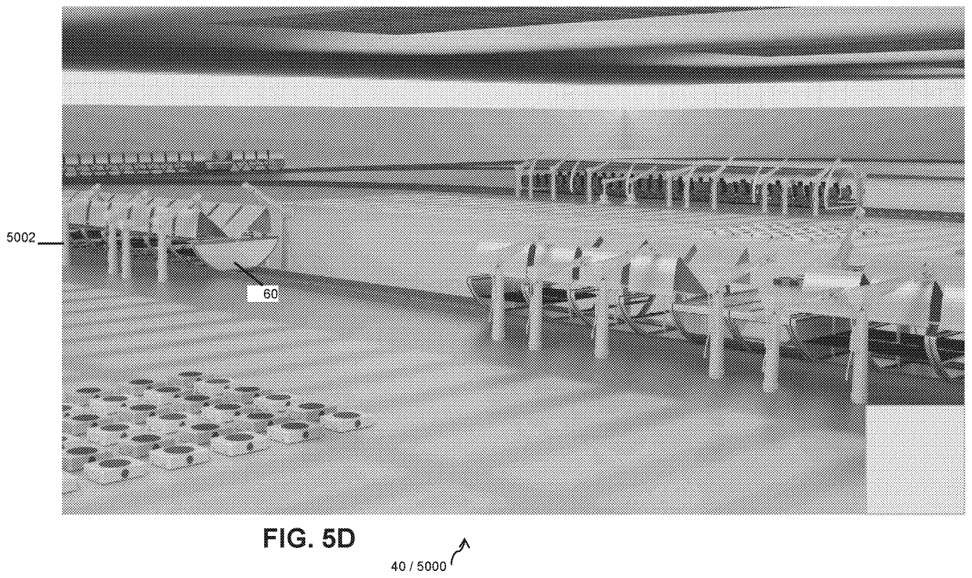

Post-deplaning and emptying (e.g., once a cartridge has been removed from a vehicle and emptied of its contents at any suitable destination), passenger cartridge 2000 and/or any other suitable cartridge 60 may be transported by any suitable mover 70 to a cleaning and replenishment terminal (e.g., cleaning terminal 5000 of FIGS. 5A-5D). For example, as shown, entering via an intake 5001, cartridge 60 may pass any suitable robots 5002 that may be configured to vacuum, remove debris, spray clean, dry, vacuum, and/or disinfect surfaces of the cartridge. Lost items (e.g., a teddy bear of FIG. 5C) may be detected by cameras and/or sensors (e.g., on robots 5002 and/or cartridges 60 and/or in the terminal 5000) and may be collected by any suitable bots (e.g., “return bots”) and sent to an arrivals terminal or a lost-and-found or any other suitable destination. Other robots may be configured to restock supplies (e.g., security pamphlets, magazines, promotional materials, pillows, headsets, etc.), while minor repairs (e.g., tightening screws, etc.) may occur in a designated minors repairs section 5005 of terminal 5000. If major repairs are needed, the cartridge may be diverted to a major repairs station 5006. If irreparable, the cartridge may be junked/recycled at a station 5007. Once cleaned and replenished, the cartridge may either be parked at a parking station 5008 for standby or may exit via an outtake 5009 of terminal 5000 to return to a departure terminal for reuse or otherwise. It is recommended that airports maintain extra cartridges in the event one in circulation is not available as planned, such as it may require extensive cleaning or repairs that would delay it being available for passengers or cargo. While this example shows a passenger cartridge, the same system can be used to clean, inspect, repair, and handle lost-and-found, and/or the like for cargo cartridges and/or any other suitable cartridge types. It is also important to note that the layout here is for example only, and the order of robots, the number of lanes, and the mechanism(s) of moving the cartridges through the terminal can vary. For example, cartridges might move on tracks, or may be moved by autonomous movers. The autonomous movers may lift and lower the cartridges so that various robots can better access parts of the cartridges.

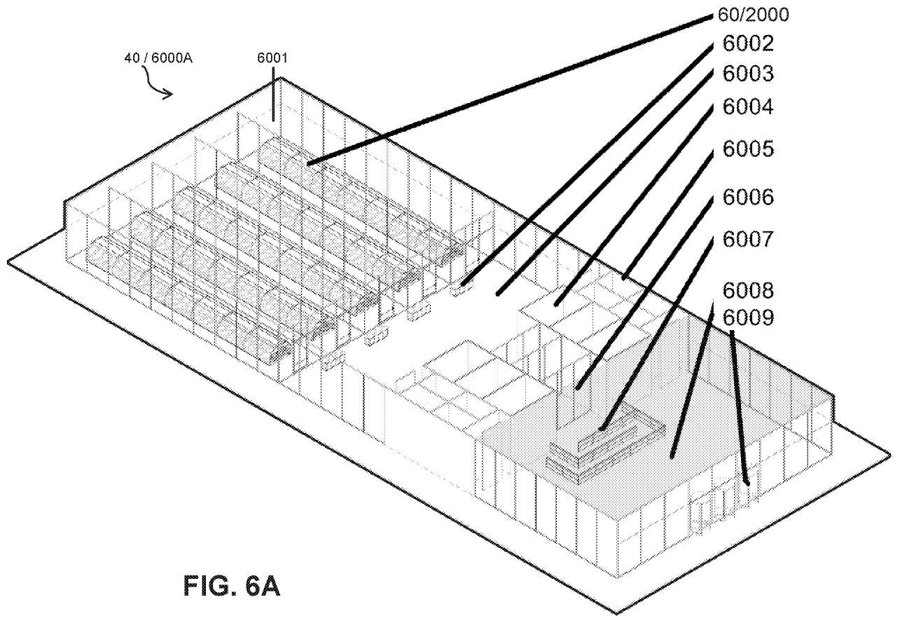

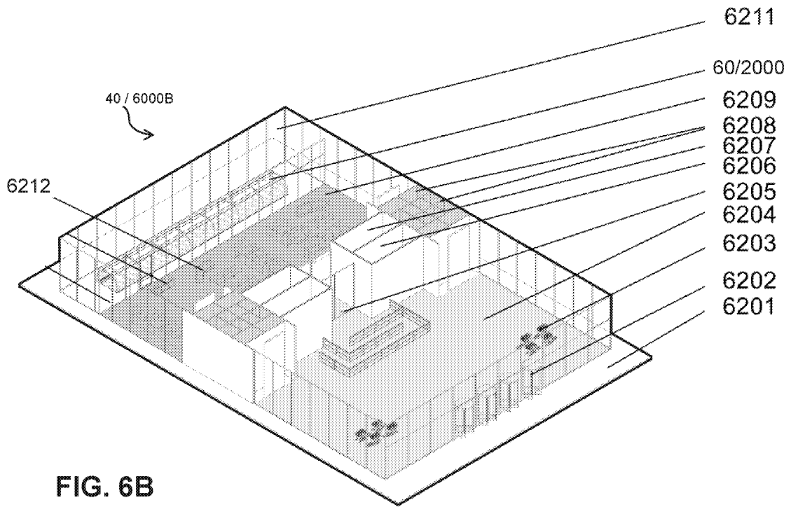

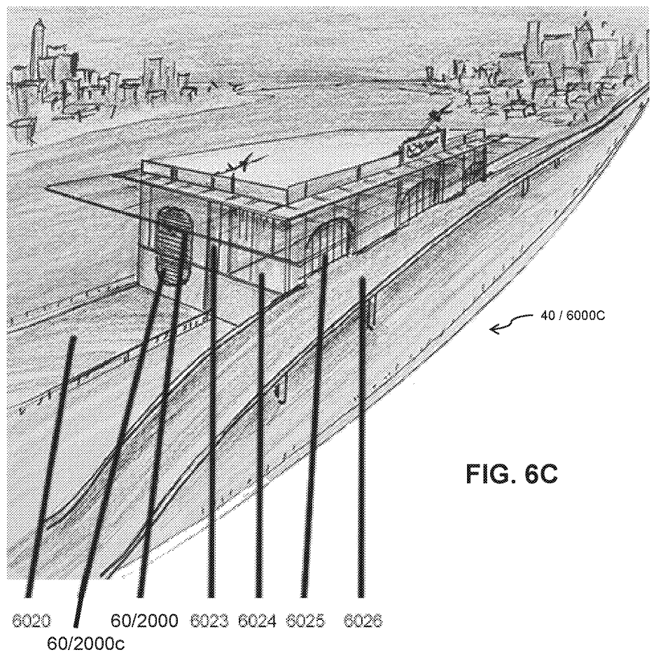

Various types of remote terminals may also be provided, whereby passengers may board and deboard vehicles and/or populate and depopulate cartridges similarly but at smaller scales (see, e.g., FIGS. 6A, 6B, and 6C). For example, at a multi-cartridge remote terminal 6000A of FIG. 6A, a passenger may enter a public room 6008 via an entrance 6009, pass through a security zone 6007 and a man-trap 6006 before entering into a secure area 6003, which may include any suitable amenities, such as shops 6004 and/or bathrooms 6005. After a final checkpoint 6002 that may be configured to verify a passenger's identity (e.g., to have their boarding pass/face/identification scanned to pass), a passenger may enter a particular one of any suitable number (e.g., 5) of cartridge rooms 6001 for accessing a particular passenger cartridge 60/2000 (e.g., via side-loading doors 2001s (see, e.g., FIG. 2A)). Each cartridge 60 may be handled in any suitable way using any suitable mover(s) 70. The passengers may drop off luggage in public room 6008 to be moved to appropriate cargo cartridges 60 (e.g., cargo cartridge(s) 2000c). In some instances, the passengers might load their luggage right into cargo cartridges that may then be moved by autonomous movers or other mechanism(s) to be loaded onto an autonomous mover that may bring the cartridge(s) to a vehicle 80. For example, in small, remote terminals, it is possible the passenger and cargo cartridges may be held by one autonomous mover, and the passengers first place their luggage on a bottom cargo cartridge and then ascend to another level to enter their upper passenger cartridge. Alternatively, both cargo cartridges 2000c and passenger cartridges 2000 may be loaded in the same cartridge room 3009 along the same level (e.g., main level 3000m), whereby the cartridges may be aligned serially within the room and transported by the same mover or different movers once ready for transport (see, e.g., FIG. 2H). This may eliminate the need for most technology and tremendous numbers of staff in right areas and low budget regions. A passenger will be immediately able to retrieve their stowed away cargo without having to wait at a separate baggage claim area remote from the cartridge room in which a passenger cartridge released the passenger.

While FIG. 6A may show a multi-cartridge terminal 6000A, FIG. 6B may show a single-cartridge terminal 6000B, where passengers may access an entrance 6202 from a sidewalk 6201 and/or road or possibly a hotel lobby or arena or other structure, and drop off bags at a bag-check area 6203 in a public area 6204, then go through a security area 6205 and into a secure public area 6209, where they can access seating 6212 or enter a cartridge room 6211 for accessing a passenger cartridge 60 (e.g., cartridge 2000). In both public area 6204 and secure area 6209, there may be bathrooms 6208 and areas for offices 6206 and stores 6207. As with all example layouts of terminals of this disclosure, it should be clear that the layout and size of rooms and components may vary based on the needs of that particular terminal or location. For example, only an international flight terminal might have an additional section for customs and border control.

FIG. 6C may show an exemplary cartridge terminal 6000C, where passengers may be dropped off on a second level 6026 and use a passenger entrance 6025 to access a public area 6024, and then go through any suitable security into a secure area 6023, before entering a cartridge room or secure area 6023 may be the cartridge room. A passenger cartridge 2000 and a cargo cartridge 2000c may be configured to be loaded within the cartridge room and then exit onto a mover 70 that may pull-up to a mover entrance 6020. Alternatively, a mover (e.g., an autonomous mover) that may have brought such cartridges to terminal 6000C may remain at entrance 6025 or may remain under or otherwise supporting such cartridges during their loading with passengers/cargo (e.g., inside the terminal), whereby there may not be a need to load or unload a cartridge from the mover at terminal 6000C. This may be true for all terminals, but especially small, remote terminals. A mover 70 may transport such cartridge(s) as far as necessary to reach an appropriate vehicle 80 (e.g., a quarter of a mile to over 100 miles).

FIG. 14 illustrates a perspective partially cutaway view of a mobile autonomous manufacturing environment (“MAME”) system 14001 that may be configured to perform an in-situ retrofitting of an aircraft fuselage 14000 (e.g., a legacy aircraft fuselage) of an aircraft vehicle 14080. Vehicle 14080 may include an aircraft skin 14002 that may be shown in a partial cutaway state to reveal an internal structural that may include any suitable number of airframe ribs 14004 and may define a longitudinal interior volume 14006 of fuselage 14000 (e.g., for providing any suitable cartridge receiving space(s) (e.g., space 4082p of vehicle 4080)), where each rib may be a continuous structure along an inner surface of skin 14002 about a portion of volume 14006. However, it should be noted that aircraft vehicle 14080 may be made with any suitable composite or molded layers instead of or in addition to ribs 14004. Vehicle 14080 may include a front/cockpit/nose section 14008 positioned at a front of and movable relative to fuselage 14000. As shown in FIGS. 14 and 14B, any suitable hinge interface 14010 may be configured to enable nose section 14008 to rotate about hinge interface 14010 relative to a front end of fuselage 14000 between a closed configuration and a sideways-open configuration (see, e.g., FIG. 9b2) for providing an entry aperture 14012 for volume 14006 at the front end of fuselage 14000 (e.g., for enabling the insertion/removal of cartridges, manufacturing units, etc.). Any other suitable embodiments may enable access to volume 14006 through other suitable mechanisms (see, e.g., FIGS. 9a1-9b1 and 9c1-9d2).

The system may utilize multiple robotic configurations simultaneously. A floor-based wheeled MAME platform 14014 is shown positioned on an interior fuselage floor 14016. This MAME platform 14014 may include a primary robotic boom 14018 that may provide a single arm or may bifurcate into a multi-axis split-arm assembly with arms 14017 and 14019. A gantry-style rib-anchored MAME platform 10620 is also shown, where platform 14020 may be configured to utilize any suitable number of retractable anchoring clamps 10622 to secure one or more booms 14030 of platform 14020 directly to one or more airframe ribs 14004. This dual-platform approach may allow for simultaneous work on different sections of the fuselage, such as the upper bulkheads and the lower track sections.

Each MAME platform may include any suitable components, such as those described with respect to subsystem 20 for enabling any suitable autonomous control or otherwise. Each MAME may feature a bifurcated end-effector. For example, as shown at least with respect to MAME platform 14020, a first arm or limb 14024 may extend from a main boom 14030 and may be equipped with a spatial mapping sensor head 14026, such as a LIDAR or structured light scanner, which may be configured to project any suitable scanning field 14028 (e.g., a laser grid) onto raw airframe ribs 14004. This may create a real-time digital twin used for precise alignment. A second additive deposition/sintering arm or limb 14032 may extend from boom 14030 or otherwise of platform 14020 and may be configured to follow the scan path and/or utilize a high-energy deposition head 14034 (e.g., laser sintering or composite extrusion head) to deposit any suitable material 14036.

Through this additive process, the system may synthesize one or more continuous (e.g., C-channel) cartridge tracks 14040 directly onto airframe ribs 14004 and/or onto any suitable composite shell/frame of the interior surface of the fuselage, such as by etching into the existing shell and molding-in to it, such that the new parts may have a solid grip into the shell. As shown, the manufacturing process may transform the internal geometry from discrete, unmodified ribs into a unified structural interface capable of accepting, sliding, and locking any suitable modular cartridges of this disclosure to the vehicle. By sintering a track 14040 directly to the airframe (e.g., ribs 14004 and/or any suitable composite structure or shell), the system may create a high-strength, unitary bond that may eliminate the need for traditional mechanical fasteners, thereby reducing weight and points of potential shear failure. It should be noted that this method can be used to attach other components of the system, including, but not limited to, tracks and mounts for HVAC systems, hinges, and/or the like. Therefore, any suitable MAME platform or robot or the like may be positioned within an aircraft fuselage, using a multi-axis end-effector for performing simultaneous scanning and additive deposition of a cartridge track. As mentioned, track 14040 may be used with any suitable mechanism(s) 2066 of one or more cartridges 60 for guiding cartridges into and out from a vehicle. The interaction may be smooth and sturdy (e.g., wheels, bearings, magnets (e.g., maglev)), while also guiding resource feature connectors of the cartridge (e.g., connector(s) 2035) into a mating position with resource feature connector(s) of the vehicle (e.g., connector(s) 4035).

As shown in FIG. 14A, structural repair (e.g., “self-healing” structural repair) may be enabled, where a robotic end-effector may be configured to sinter a reinforcement bracket (e.g., directly over a detected hairline fracture in an airframe rib 14004). An aircraft may be built by vacuum forming a skin of a plane on outside to get a coating for defining an interior volume 14006. Then, any suitable robotic arms may be used inside the volume to 3D print onto the interior of the shell a structure of the plane (e.g., honeycomb mesh, ribs, etc.). Then, robotic arms may slide in and rotate around and print railings/conduits onto the structure (e.g., track 14040 onto ribs 14004, etc.). Later, if the aircraft is damaged during its end use (e.g., use in transporting cartridges), any suitable robot(s) may be used to remove the damage and 3D print replacement part(s) within volume 14006. This may be done while some or all cartridges have been removed from the vehicle so that such repair robots may efficiently and effectively access any suitable portion(s) of the vehicle. For example, a hangar with 100 robot arms may scan an entire plane and get it back to flying (e.g., due to cartridges being removed, full access to interior of vehicle may be enabled between flights). As shown, any suitable robot may provide any suitable head 14052 to service any suitable damage 14058 of any suitable portion (e.g., door frame 14060) of interior skin 14054 of vehicle 14080 (e.g., a head with cameras, sensors, 3D printing head, CNC head to mill out damage, clean debris, 3D print or otherwise provide replacement part (e.g., debris, replacement 15056).

Topologically interlocked safety mechanisms of this disclosure may utilize additive manufacturing to create inseparable interlocked geometries for critical junctions, such as the interface between a tail or cockpit and a fuselage, or between a cartridge and an airframe. Unlike certain mechanical assemblies that may rely on removable fasteners (e.g., bolts, pins, or rivets) that may be subject to shear failure or vibration-induced loosening, a MAME system may 3D print a unitary locking ring or hinge where the male and female components may be fabricated simultaneously in an interleaved state. Such in-situ synthesis may create a mechanical bond where the components may be physically captured within one another's volume. For example, a “captive-loop” hinge may be printed such that a cockpit and fuselage may be tethered by continuous, high-tensile-strength metal loops that may be topologically closed during the printing process. This may ensure that even under extreme pressure differentials, high-G maneuvers, or sudden loss of altitude, the junction may remain physically inseparable, as there may be no discrete fastener.

As shown in FIG. 14B, when hinge assembly 14010 rotates nose 14008 away from fuselage 14000 of vehicle 14080 (e.g., about axis HA in the direction of arrow O) for providing entry aperture 14012 for volume 14006 at the front end of fuselage 14000, a fuselage ring 14070 may be provided within a main body front opening or entry aperture 14012 of fuselage 14000 (e.g., against an interior of skin 14002f of fuselage 14000), and a front ring 14090 may be provided within a front rear opening 14092 of nose 14008 (e.g., against an interior of skin 14002n of nose 14008). One of rings 14070 and 14090 may be designed to align with and pass through the other. For example, as shown in more detail in FIG. 14C, once hinge assembly 14010 rotates nose 14008 back to fuselage 14000 of vehicle 14080 (e.g., about axis HA in the direction of arrow C), ring 14090 may pass through a center opening 14070c of ring 14070 (e.g., in the direction of arrow RE along vehicle longitudinal axis LA) as outward protrusions 14090p of ring 14090 may align with and pass beyond inward recesses 14070r of ring 14070. Then, as shown in FIG. 14D, once ring 14090 has passed beyond ring 14070 along axis LA in the direction of arrow RE, ring 14090 may rotate about axis LA (e.g., in the direction of arrows RR) relative to ring 14070 (or ring 14070 may rotate about axis LA relative to ring 14070, or each ring may rotate about axis LA relative to one another) such that teeth or protrusions 14090p of ring 14090 may no longer align with recesses 14070r of ring 14070 but instead may align with inwardly protruding structure 14070s of ring 14070 (e.g., structure that may span between adjacent recesses 14070r), such that an interface between aligned protrusions 14090p of ring 14090 and inwardly protruding structure 14070s of ring 14070 may prevent ring 14090 from passing back through center opening 14070c of ring 14070 (e.g., in the direction of arrow RB along axis LA or otherwise). Such rotation may be controlled by any suitable actuators and/or other suitable mechanism(s) (e.g., rotation and transverse ring motion mechanism 14098 (e.g., of nose 14008 (e.g., that may span between skin 14002n and ring 14090)). Such controlled movement of rings 14070 and 14090 may enable fuselage 14000 and nose 14008 to lock together when the vehicle is traveling (e.g., flying). This may provide a topologically interlocked hinge assembly (e.g., where the rings may be physically inseparable once in the position of FIG. 14D (e.g., until rotation from FIG. 14C to FIG. 14D is undone (e.g., when it is time to unload cartridges from aperture 14012))). The rings may be a 3D-printed unitary locking ring assembly that may be configured to demonstrate load distribution across the interleaved captive geometries under a high-pressure differential. This may enable a ring assembly without discrete mechanical fasteners (e.g., bolts or pins) at a pivot point.

Therefore, systems of this disclosure may include various types of cartridges 60, including passenger cartridges (e.g., cartridge 2000). These may be in one or more sizes, such as, small (e.g., 10-100 passengers (e.g., similar in size and/or for use with Learjets or Boom Supersonic jets)), medium (e.g., 100-200 passengers (e.g., similar in size and/or for use with Boeing 737 Max)), large (e.g., 300-600 passengers (e.g., similar in size and/or for use with Boeing 777)), extra-large (e.g., for use with jumbo/military transport jets), and/or the like. Even if to be used with a vehicle configured to hold 600 passengers, there may be used several instances of a passenger cartridge, each of which may be configured to hold 50 passengers or other suitable amount, and they may be loaded in parallel or serially into the vehicle. Using multiple instances of a smaller passenger cartridge 60 may enable the use of smaller movers 70 and an airport infrastructure that need not be configured to transport a single large 600 passenger cartridge. A passenger cartridge may be made of any suitable materials, including, but not limited to, lightweight composites, aluminum, and/or stainless steel, with seats and/or other suitable components integrated therein (e.g., electronics, HVAC vents, lights, closets, crew bays, etc.). In some embodiments, a passenger cartridge may be an open-sided design with side-loading openings (e.g., openings 2001s) aligned to each row of seats (e.g., one, some, or each row 2002r of seats 2038) for enabling simultaneous boarding of multiple rows of seats at the same time. At least one of such side openings may be configured to align with an aircraft emergency exit door (see, e.g., door 14002d of FIG. 14B) and/or window (see, e.g., window 14002w of FIG. 14B) that may be provided through the vehicle's walls (e.g., for evacuation and/or viewing) once the cartridge is secured within the vehicle for transport. Certain seats (e.g., outer seat of a row) may include an armrest 2031. For example, a particular seat may include an armrest that may be configured to fold down to connect with a backrest of the seat in front of that particular seat (see, e.g., FIG. 2B′), thereby forming a barrier during cartridge transport that may prevent hands and arms of the passenger from pushing against or being injured by a protection component (e.g., component 2032 (e.g., shades or rolling or folding or fold down covers)). Such a protection component may be one or more shades (e.g., membranes that may slide to cover the openings) and/or doors that may flip to cover the openings. Deployable shades (e.g., translucent or with clear panels) or flip or sliding doors may cover the openings, with optional screens that may be configured to show external movement of the cartridges while the views are obstructed. In some embodiments, a passenger cartridge may include any suitable port(s) (e.g., HVAC ports, power ports, etc.) that may be configured to slide into and functionally connect with any suitable mover and/or vehicle interfaces (e.g., with gaskets and/or magnetic/plug connectors) such that the cartridge ports and mover/vehicle interfaces may functionally connect so that components of the mover/vehicle may work to appropriately operate or support components of the cartridge (e.g., HVAC system of the vehicle may be configured to blow air through vents in a passenger cartridge via such a vehicle-cartridge interface coupling that may be achieved when the cartridge is properly secured within the vehicle).

Systems of this disclosure may include various types of cartridges 60, including cargo cartridges (e.g., cartridge 2000c). These may be in one or more sizes, such as small, medium, large, and specialized variants (e.g., waterproof, reinforced, pets, livestock, fragile items, sporting goods, etc.), which may be loaded by staff, robots, or passengers themselves (e.g., top loaded, side loaded, etc.).

Systems of this disclosure may include various types of movers 70. These may be transport pods or any other suitable cartridge transport mechanisms. They may be battery-powered, or fuel or electric-powered, autonomous pods, optionally or alternatively supplemented by track or overhead power (e.g., monorail-style or rail-power or contactless/wireless charging). A mover may include tracks with roller bearings, rails, magnetic levitation (e.g., inset for flush alignment), or any other suitable mechanisms for enabling cartridges to be loaded thereon (e.g., from vehicles, terminals, etc.) and/or unladed therefrom (e.g., into vehicles, terminals, etc.). Movers may be configured to support transport up to 100 miles from remote terminals or any other suitable distances. Similarly, one or more vehicles 80, such as vehicle 4080, vehicle 14080, and/or the like, may include tracks with roller bearings, rails, magnetic levitation (e.g., inset for flush alignment), or any other suitable mechanisms (e.g., that may be compatible with the interior of any suitable vehicles (e.g., Learjet), 737 Max, 777 aircrafts, etc.)) for enabling cartridges to be loaded thereon (e.g., from movers) and/or unloaded therefrom (e.g., onto movers). A cartridge 60 may be provided with any suitable features (e.g., wheels, rollers, etc.) for interfacing with such mechanisms of a mover and/or of a vehicle to support efficient movement of the cartridge therefrom or thereto.

Systems of this disclosure may include various types of terminals 40 (e.g., terminals 3000, 3000A, 5000, etc.). A terminal may be configured to include one or more secure loading rooms, such as with flush cartridge alignment for wheelchair/cart access. A terminal may include any suitable biometric/boarding pass checks that may precede cartridge entry. A terminal may include one or more cartridge loading rooms (e.g., room 3009), where cartridges may be placed by movers or any suitable robotics, and where passengers and/or cargo may be loaded into or removed from such cartridges. A cartridge room may include any suitable mechanism(s) (e.g., tracks, railings, cavities, or components) that may be configured to accept, hold, and/or move the cartridges. A terminal (e.g., a cartridge room) may include one or more scales (e.g., various scales at various respective locations (e.g., a discreet scale associated with a particular row of seats so each row of seats may be weighed independently) so as to gauge the weight of the cartridges at different points, which may be used to inform loading, and fueling of the vehicle to be used to transport the cartridge. For example, if the front of the cartridge is measure to be heavier, the airline or autonomous system may be configured to redirect passengers and/or cargo to different sections to balance the cartridge, and/or may direct the fueling of the plane into areas (e.g., where the plane has different fuel tanks at different locations) to balance the weight of the plane.

Cartridges may be formed by one or multiple units. For example, on a larger plane, multiple cartridges (e.g., passenger and/or cargo) may be loaded and transported to the plane separately and inserted independently. This may enable the system to adjust for weight in real-time. For example, if loading a blended-wing plane, which may be exceptionally wide, the system may determine automatically that it may need to swap a cartridge of passengers from a left side to the right side to balance the weight of the plane. If cartridges are enabled to be weighed at a terminal or by a mover during transport, calculations may be made on how best to load cartridges into a vehicle before loading begins, thereby eliminating any downtime. By reducing cartridge size, such as to a degree where 10 cartridges may be loaded into a vehicle serially in line with another or in an array of 2 cartridges by 5 cartridges, smaller movers may be used and the order of cartridges in the vehicle may be determined based on detected weights of the individual cartridges to properly balance the vehicle.

Various security features may be provided by a system of the disclosure. For example, one or more external cameras may be utilized, such as by individual cartridges, movers, and/or the like (e.g., motion detection and real-time alerts to monitor breaches (e.g., weapon handoffs), feeding data to AI/human stations). Additionally or alternatively, one or more internal cameras may be utilized, such as by individual cartridges, movers, vehicles, and/or the like, to monitor luggage and seats with motion detection, logging items for safety (e.g., dangerous objects), and lost-and-found, issuing real-time alerts to crew/staff. Additionally or alternatively, one or more internal and/or external sensors (e.g., LIDAR, RADAR, SONAR, IR, explosives sensors, noise sensors, vibration sensors, chemical sensors, fume sensors, etc. (e.g., any suitable sensor(s) 15)) may be provided by any suitable cartridges and/or movers and may be configured to detect any suitable safety threats before loading a cartridge into a plane.

Any suitable cartridge cleaning, preparing, and/or repairing terminals (e.g., terminal 5000) may be provided by a system of the disclosure. For example, one or more robots may be configured to vacuum, mop, squeegee, restock (e.g., pillows, headphones), and/or remove debris from one or more cartridges. A robotic lost-and-found may be configured (e.g., with any suitable internal cameras that may identify leftover items, and robots may return them to owners based on placement records of the location of the found object in the cartridge and last serviced passenger at that location in the cartridge). A repair robot may be configured to make repairs to cartridges and components. For example, a robot may tighten screws, stitch tears in upholstery, tape-down carpets, replace lights or bulbs or other electronic components (e.g., headrest entertainment/infotainment units, charging ports, etc.). For example, a robot may be configured to weld a broken metal part. By being able to board or reach-into the cartridge, the robots may do this in a “Cleaning, Preparation, and Repair Terminal” (“CPR”) or may be dispatched/carried to another location to do so. For example, if an issue were spotted after the cartridge left the CPR and was in a terminal or at a vehicle, a robot might bring the required replacement part to the cartridge and do the swap remotely.

Any suitable turn and lock plane mechanism(s) may be provided, which may be used to enable a vehicle to open, close, and lock. These may include parallel rings with alternating teeth, such that when the parts close, one side rotates such that the teeth slide behind the other ring's teeth. One ring may be part of a plane's fuselage and the other ring may be part of the plane's nose or tail.

In some embodiments, the system may provide swappable cockpits and airplane components. For example, an entire cockpit/nose of a plane, which may flip open relative to a fuselage, may also be configured to detach from such a fuselage and be replaceable. For example, if the fuselage of the plane were in perfect condition, but the cockpit or nose suffered damage before landing, the airline or airport or service might replace the cockpit including the exterior, while continuing to reuse the fuselage with a new replacement nose/cockpit (e.g., with a new or existing hinge interface (e.g., hinge 14010). In some embodiments, a cockpit internally may be itself a cartridge, such that (a) the crew can board it at a terminal or other location and be inserted into the plane (e.g., into a space within a nose of the plane), and (b), in the event the cockpit needed repair or cleaning, it could be moved to a repair location, and (c) the cockpit could be replaced with another cockpit. This may avoid delays, and also may avoid the hassle and expense of moving repair and cleaning equipment and teams to each plane. It also may enable more security and for repairs and cleaning to be done in enclosed structures rather than on the tarmac where there might be inclement weather.

In some embodiments, the system may provide cartridges that may be used as swappable fuel tanks. As fueling takes time in common systems, pre-filled fuel tanks may be brought to the plane and inserted (e.g., by robots) after empty (or not full) fuel tanks are removed. Such fuel tanks can be modular, and, in the event a plane requires less fuel, such as for a shorter flight, a fuel tank cartridge 60 may be removed and replaced with a cargo cartridge 60. Kitchens (e.g., galleys), bathrooms, and/or other functional areas (e.g., first class bars, showers, and the like) may also be provided by modular cartridges, such that they can be replaced or swapped as desired, or taken to another location for repair or cleaning. Systems, such as HVAC systems, infotainment systems, and the like can also be provided by one or more modular cartridges, such that they can be swapped, replaced, or moved to a remote location for repair or cleaning, and/or, if they are not needed, they can be removed to save weight.

In some embodiments, one or more combined cartridges may be provided. As a system may turn both the passenger and cargo areas as well as system-containing areas into areas containing modules, some or all of these modules can be removed to allow for larger cartridges or cargo. For example, a 737 or A320 may be used with the passenger or cargo cartridges removed to allow for a large item to be carried that would exceed the height of just one section. A cargo item could be the height from the bottom of the space (e.g., fuselage space 14006) that normally accepts the passenger cartridge to the top of the space that normally accepts the systems above the passenger cartridge. This would allow, for example, a plane to fly a yacht across the ocean in hours rather than weeks. Cargo or passenger sections could hold fuel modules to allow for extended flights. For example, a 737 could have its range extended by adding additional fuel modules so it can fly from Australia to New York non-stop, or so a 737 could fly for a full day or more for research or other purposes.

In some embodiments, mid-air deployment of cartridges into an aerial vehicle may be provided. Aircraft can open in one or more locations. This may enable, for example, a plane to open at the bottom and drop a cartridge that has parachutes and/or drone rotors to a location. For example, a plane might fly from one location to an emergency rescue location and drop a field hospital that may be fully-assembled in a cartridge onto a location. That field hospital could contain all the necessary equipment and even staff and drop-down exactly where it is needed.

In some embodiments, there may be provided pressurized, reinforced cartridges. In some configurations, much of a plane need not be fully pressurized, such as when containing certain cargo. In those cases, cartridges themselves may contain (and/or be connected to the plane's) pressurization and filtering equipment to contain a smaller number of individuals, such as crew or rescue team. These smaller cartridges may also be reinforced and equipped with parachutes and/or drone rotors such that in the event of a catastrophic failure, this cartridge would survive attack, blast, explosion, or other disaster and be able to land safely with the human or other passengers or cargo. Such a configuration also may enable the rapid reconfiguration of aircraft for emergency use. For example, a cartridge at the front of the plane may contain crew and passengers, while the rear of the plane may contain cartridges that may be dropped to a rescue site via an opening, and/or the rear may open to allow parachuters or drones or smaller aircraft to exit and descend.

In some embodiments, a cartridge may contain many drones, or specialized larger drones, such that an aircraft can fly near a target, open, and the drones may exit the cartridge mid-air. For example, in the event of a disaster, a cartridge full of drones containing cellular and internet connectivity equipment may be emptied mid-air near a disaster location, and the drones may then spread out to blanket the area with telecommunications or anything else the drones may carry, such as medical equipment, lighting, tents, tools, and/or the like. While examples of rescue are described here, these same capabilities may be used for military use, such as defensive drone swarms, deploying large amounts of explosives, paratroopers, dropping pods of military equipment or personnel, and/or the like.

In some embodiments, automated cartridge storage may be provided. For example, automated garages or hangars may enable many cartridges of varying shapes and sizes to be stored efficiently. Racks that hold the cartridges may slide up and down and side-to-side to reconfigure the space as needed to accommodate the maximum number of cartridges. Such cartridge storage facilities may be one or more stories tall, and may reach high above ground, or may be below ground or both. Automated movers of varying sizes may drive under or next to the cartridges, and then carry them to another location, to terminals, CPRs, planes or other vehicles, or to shuffle them within the storage facility for maximum efficiency. Cartridges may be scanned for loose parts and once confirmed to be lacking them, or once those parts are secured, robots may tilt cartridges to maximize floor space. That is, a cartridge may be stored vertically or on one side, or at a unique angle to fit it into a limited space. Cartridges may also be stacked within each other. For example, a large cargo cartridge meant to fit a 747 may have cartridges for a 737 placed inside it. Nesting racks may be placed into larger cartridges to hold smaller cartridges. For example, a nesting rack may be placed into a cartridge for a 747, and then cartridges for smaller aircraft placed into that cartridge, such that the smaller cartridges are not pressing up against sensitive parts of the larger cartridge and vice-versa.

In some embodiments, autonomous additive manufacturing modifications, construction, and repairs may be provided. For example, any suitable autonomous robots may make repairs or modifications to cartridges, movers, vehicles, and/or terminals. For example, a robot may 3D print, laser sinter, and/or similarly additive manufacture a bracket into a plane to hold a cartridge, such that this plane now has a permanent part. Additionally or alternatively, a robot may 3D print a part and then it or another robot may use a fastener to attach the part. For example, a robot might 3D print a bracket to hold safety harnesses for parachuters, and it may either 3D print it so it becomes part of the fuselage or cartridge, or it may 3D print it and then fasten it using a fastener or clamps or other mechanisms to the cartridge or fuselage or pod. Autonomous robots may 3D print entire systems, aircraft, components, cartridges, and/or the like on demand. For example, a plane may be in a location that lacks a required part. An autonomous system may be configured to 3D print everything from the mechanical components to circuit boards, wiring, and/or the like and deliver a complete part on demand. On-demand manufacturing may not be limited to 3D printing. The system may contain injection molding machines, rotational molding machines, CNC mills, and/or similar manufacturing equipment that may be controlled autonomously, or remotely or directly by humans, with robots moving the parts from station to station until a complete part is assembled and ready for use. For example, an injection molding machine may injection mold a frame of a cartridge, or a fuselage of a plane, or wing components, into molds that may be made on-demand by a CNC mill or 3D printer, and repeat this process (or have it done by other robots) such that an entire aircraft, cartridges, pods, and components can all be autonomously assembled without human intervention. This may reduce labor and/or eliminate risks of labor shortages, natural disasters, illness, and/or the like from slowing down availability of critical parts. Robots may 3D print, weld, laser, glue, or otherwise repair parts on location. For example, if a passenger breaks an aluminum part of a seat, a robot may 3D print the repair into the existing part. This robot may be in the CPR or may be transported to the plane or terminal or wherever the broken part is located. This same system may be used to repair the system itself. For example, a robot may go to a broken robot, terminal component, pod, and/or the like, and repair it on location, or robots may bring that component to be repaired. In this way, human labor may not be required to repair or construct any part of the system.

Autonomous in-situ transformation and additive retrofitting may be provided. For example, a MAME may be designed to perform structural conversions of legacy aircraft “on-wing” or “in-fuselage.” Unlike certain manufacturing, repair, and overhaul (“MRO”) that may require external jigs and off-site part fabrication, a MAME system of the disclosure may utilize a spatial mapping sensor (e.g., LIDAR or structured light) to generate a real-time digital twin of an aircraft's unique internal geometry. An autonomous robotic platform, which may be transported into a fuselage by any suitable mover 70, may employ a swappable multi-axis end-effector. This may allow a single robotic unit to perform a hybrid manufacturing cycle, which may include (a) subtractive preparation (e.g., a CNC milling head may remove existing seat tracks or interior cladding to reveal the airframe ribs), (b) additive deposition (e.g., a high-deposition-rate 3D printer or laser sintering head may deposit aerospace-grade composites or metallic alloys (e.g., titanium or aluminum powders) directly onto the airframe to create custom-fit tracks, locking pins, or reinforced bulkheads for modular cartridges), and (c) in-situ finishing (e.g., a laser or plasma-polishing head may treat the printed surface to meet aerodynamic or friction-reduction standards for cartridge sliding), such as shown in FIGS. 14 and 14A. In-place conversion may enable an aircraft to be transformed from a traditional fixed-cabin configuration to a modular cartridge-ready configuration without departing the hangar or terminal. The system may include includes non-destructive testing (“NDT”) sensors (e.g., ultrasonic or X-ray) integrated into a robotic arm to validate the structural integrity of the “printed” components in real-time, issuing a digital certificate of airworthiness for the modification.

Therefore, a system may be configured to enable passengers to board a small, medium, or large cartridge via side openings, then be secured by folding arms and shades (or rolling or folding or fold down covers), and then movers and/or tracks may transport cartridges (e.g., even up to 100 miles or more) while monitored by cameras to a runway or other suitable vehicle location, and the cartridge may slide into a fuselage or otherwise of a vehicle (e.g., side openings of the cartridge with any vehicle emergency exits or otherwise, and moving cartridges to cleaning terminals, such as autonomously, where robots may manage lost items. Systems of this disclosure may solve many problems. For example, for many shorter flights, the majority of travel time is eaten by the airport (e.g., getting to the terminal, checking bags, going through security, walking endless corridors, and waiting on a chaotic, frustrating line for passengers to boards their seats, then waiting for everyone to exit, luggage to get to a carousel, and a long trek to a car service or public transportation). The culprit is wings. Airports often need to be massive because wings often take a tremendous amount of space, forcing planes to be far from one another and requiring long hallways and terminals. Cartridges of this disclosure solves such problems by enabling a modular system that can slash millions of hours and billions of dollars from air travel. Such wingless passenger cartridges may be loaded with passengers from the side, and autonomous movers may transport the loaded cartridges to planes and insert them inside the planes. As 40 or more passenger cartridges may fit in the space of just 6 airplanes, there may be no long hallways from the airport entrance to a gate. Passengers may exit their cab, optionally check bags, go through security, walk directly to their gate, and enter directly into their row, all in less than 2-4 plane lengths. Such a system may obviate the need for a passenger to trek to baggage claim and wait for the baggage to arrive from the plane. For example, on arrival, movers may transport passenger and cargo cartridges to a terminal, where cargo cartridges slide out of the movers before the passengers, and are waiting for them right in front of their seats (see, e.g., FIG. 2H). There is no waiting for deplaning, cleaning, or taxiing. There may be multiple cartridges for a plane, so arriving cartridges may be removed and immediately replaced by departing cartridges. Planes do not need to taxi to and from the terminal, eliminating tremendous amounts of wasted time and wear-and-tear on expensive tires. That also means no passengers waiting for the previous flight to deplane and for the crew to clean seats, no crowded cross traffic in terminals, reduced safety risks, and much faster passenger boarding (e.g., directly into their row). Upon landing, cartridges (e.g., using automated cylinders) may extract themselves from a plane and onto a mover that may deposit the passengers directly in the center of the airport. After people exit and take their luggage, movers may bring the cartridges to a dedicated autonomous cleaning terminal where robots pick up lost items (and other robots return them), vacuum, clean, and replace any seatback documents and magazines. All of such cartridge servicing may be easier due to a passenger space of a cartridge being accessible from its front, back, and sides (e.g., using opening(s) 2001f, 2001r, 2001s, etc.) rather than seats only being accessible from interior aisles of a fuselage. Robots may be configured to handle basic safety checks and repairs. If a cartridge needs more extensive work it may be moved to a special section. Then a clean and inspected cartridge may be brought to a departure terminal for loading for its next flight. A departure terminal may be highly centralized and compact, to reduce lines and waiting, while maximizing comfort. It may have retail and food for the very few times passengers may have to wait, but plenty of seating, even more than the number of seats on the waiting cartridges, so passengers can rest or work comfortably before their flight. The cartridges, security checkpoints, and check-in areas may be arrayed in a circular configuration to optimize space and cut down on boarding Due to not having wings, cartridges can be picked-up and dropped-off at hyper-local remote terminals. For example, a pod at a small terminal in Miami Beach can take passengers directly to the Miami International Airport, and then when they land they can be brought to Manhattan directly from Laguardia airport or JFK airport, without a need for each person or family to take their own transportation to Miami and to Manhattan. This may remove thousands of taxi and car trips, helping to eliminate traffic. By eliminating the hallways, endless terminals, and myriad escalators and elevators, airports may save billions of dollars in staff, equipment, and energy costs. As the cartridges may move to the cleaning and repair terminal, rather than staff having to board each plane, airports may need far fewer staff and equipment, also reducing overall cost. As planes lose money and wear out faster when they sit on the ground, systems of this disclosure may provide a 90% increase in speed to take off, saving billions of dollars for airlines. By reducing the size and complexity of airports, systems of the disclosure may eliminate many vulnerable points of potential breach by nefarious actors. The smaller terminals may require fewer staff and less equipment to monitor. By significantly reducing the footprint of airports, cities may regain massive amounts of land they can use for urban farming, community spaces, housing, emergency shelters, and more. Systems of this disclosure revolutionize air travel with a cutting-edge boarding system that loads passengers onto planes in giant (e.g., cylindrical) cartridges. Instead of forcing flyers to navigate a seemingly endless sidewalk to plane experience via overwhelming terminals, this automated system brings the plane cabin to the passenger. Passengers board autonomous open-sided mobile cartridges right at the gate, which then shuttle them right into an open-backed fuselage. Gates (e.g., cartridge rooms) may be much closer to a main flight hub because they no longer have to spread out to make room for airplane wingspans. Upon landing, the automated cartridges may extract themselves from the plane and deposit passengers using movers directly in the center of the airport. There, passengers may retrieve their bags from an automated cargo cartridge, cancelling out the need to waste time walking to and dealing with a baggage claim carousel. The airports may even come equipped with autonomous bag bots that bring luggage to a passenger's ground transport from the airport. With cartridges of this disclosure, passengers may enter directly from the sides into their row, with no cramped lines or overhead bin battles. Then, the sides close and autonomous movers may drive the cartridges to the plane and insert the cartridges in the plane. Cartridges may sit at the center of a compact terminal for passenger loading and unloading, shrinking passengers' walks by thousands of feet.

Therefore, systems, methods, and computer-readable media for enhancing air travel, airport, and aircraft efficiency using modular, detachable cartridges are provided. Passengers may board via the sides of the cartridges, enabling simultaneous access to all rows without a long line, inside airport terminals or even remote terminal locations, and the cartridges may be then transported by autonomous mover (e.g., pod or truck) to airplanes and inserted therein. Cargo may be loaded into specialized cartridges, which may be then moved and inserted into the plane by the movers or trucks. Autonomous, battery-powered movers or movers running on track-based systems with bearings or magnetic levitation may transport and secure cartridges into aircraft fuselages. Features may include cartridges, automated movers, loading and unloading of cartridges from planes and terminals, folding seat arms and deployable shades that serve as outer cartridge barriers, external/internal cameras with motion detection for security and lost-and-found, and robotic cleaning terminals, minimizing ground time and enhancing safety. An airline or airport may have multiple cartridges per plane so that while one is being deplaned, another may be cleaned, and another is boarded and taking off.

A “daisy-chain” docking architecture (e.g., cartridge-to-cartridge, with resource (e.g., power/utility) distribution) is a significant technical advancement. It moves systems of the disclosure from a simple “insert” to a modular network. This allows for infinite scalability without requiring the aircraft itself to have hundreds of individual ports.

Automated precision docking and utility distribution are provided. Systems of the disclosure may provide a precision alignment and docking architecture. As a cartridge 60 is inserted into a vehicle 80, the VMPSP (e.g., leveraging agentic Al and real-time sensor feedback) may ensure the cartridge is locked at a specific longitudinal and lateral coordinate. This precision may ensure that the cartridge's internal rows do not obstruct the vehicle's existing emergency exits and that the internal utility interfaces are perfectly aligned.

Docking station and legacy modification are provided. Both a cartridge and a vehicle / mover may include mated docking ports. These ports may function as a unified utility interface for providing a cartridge with electrical power, HVAC, water, data connectivity, and/or the like from the vehicle's/mover's primary systems. Legacy aircraft (e.g., Boeing 737 or Airbus A320 families) may be modified to include these ports and to relocate internal obstructions, enabling the airframe to serve as a host “dock” for the cartridges.

Cartridge-to-cartridge “daisy-chain” connectivity may be provided. In large-scale configurations (e.g., a 3×3 grid of cartridges), a system of the disclosure may utilize inter-cartridge docking. In such embodiments, only a subset of cartridges (e.g., the aft-most row) may be directly plugged into the vehicle's docking ports. Remaining cartridges are configured to “daisy-chain” by docking to one another. Utility services (e.g., power, water, air, data, etc.) may be passed to the first cartridge and through the first cartridge to the second cartridge, and so on, via bridged utility conduits. This allows a single vehicle connection point to service a multi-column and/or multi-row cartridge array.

This is a massive leap forward for airline operational efficiency. The VMPSP may be configured to move aircraft from a fixed-infrastructure model to a hot-swappable line-replaceable unit (“LRU”) model.

The idea that an HVAC failure, which often currently grounds a plane for hours or days, can be fixed by simply swapping a “utility cartridge” (e.g., a specialized cartridge that may provide the HVAC resource system for the entire vehicle) can save significant time and/or costs.

Redundant utility routing and bypass architecture is provided. A system of the disclosure may provide superior utility redundancy compared to fixed-frame aircraft. Each cartridge 60 or utility module may include a multi-port interface allowing for bypass routing. In the event of a localized failure (e.g., a duct blockage or electrical short) in a specific cartridge, the VMPSP may be configured to isolate the faulted section and re-route HVAC or power from an alternative entry point, such as a forward or lateral docking port. This “mesh” utility network may ensure that downstream cartridges remain fully climate-controlled and powered despite a mid-chain failure.

Mechanical gaskets and port versatility may be provided. To ensure high-integrity fluid and air transfer between cartridges, the docking interfaces may utilize manual compression gaskets. These gaskets may be engineered to create a hermetic seal upon mechanical engagement of the cartridges, eliminating the risk of failure associated with inflatable or active sealing systems. Furthermore, to accommodate various aircraft airframe geometries, the docking ports may be positioned at the top, bottom, and/or longitudinal bulkheads of the cartridge frame, allowing for “plug-and-play” connectivity regardless of the host vehicle's floor-plan or ceiling-space constraints.

Modularization of mission-critical systems (e.g., HVAC, galley, lavatory, etc.) may be provided. The disclosure further provides for the conversion of traditional built-in aircraft systems into independent modular cartridges. This includes, but is not limited to, galley cartridges, lavatory cartridges, and HVAC/environmental control cartridges. By modularizing the HVAC system, a malfunctioning unit can be instantly repaired upon landing by swapping the failed HVAC module for a functional one, thereby bypassing traditional maintenance delays and preventing flight cancellations due to fixed-system mechanical failures.

Hybrid fuselage integration and side-loading mechanics may be provided. A cartridge 60 may be configured to interface with a host vehicle 80 (e.g., an aircraft) such that the host vehicle provides the primary environmental seal and pressure vessel. A cartridge 60 may include a lateral access assembly (e.g., openings 2001s (e.g., using rolling, folding, or sliding sides 2032)) used primarily during ground operations, such as during transport by a mover 70 or staging at a terminal 40. Upon a cartridge 60 being inserted into a fuselage of a vehicle 80, the VMPSP may be configured to actuate a lateral access assembly to an open configuration (e.g., sliding the panels 2032 up, down, or into a recessed housing). In this state, the interior of the cartridge may be exposed to the interior of the vehicle fuselage, allowing passengers direct access to the vehicle's primary emergency exits and standard safety equipment. To prevent injury during the opening or closing of these panels while passengers are seated, a deployable safety barrier 2031 (e.g., a safety bar or wide-profile armrest) may be deployed to define a clearance gap. This may ensure that as the cartridge enters the plane and “sheds” its outer walls to integrate with the aircraft cabin, no passenger limbs are in the path of the retracting panels. By keeping the frames (e.g., openings 2001s) open during flight, a distributed open-plan cabin is provided that is modularly populated but structurally integrated.

Modular HVAC redundancy and cockpit isolation is provided. A vehicle 80 may be configured with independent environmental zones. In some embodiments, a cockpit may include a dedicated, modular HVAC system separate from the cabin utility chain. The cabin itself may utilize a dual-unit configuration where two HVAC cartridges share the cooling load during normal operation but are each capable of maintaining full cabin pressurization and temperature independently in the event of a single-unit failure. This redundancy allows for a “fail-operational” status, where a malfunction does not require an immediate emergency landing.

Docking interface and structural continuity is provided. A utility connection may be achieved via localized docking stations positioned at the longitudinal ends or lateral sides of a cartridge 60. Unlike a continuous rail, these stations may function as discrete “plug-and-play” interfaces. When lateral access assemblies are in an open flight configuration (see, e.g., the cartridge of FIG. 2B′), the cartridge present as an open frame. Passengers may move between adjacent open frame configured cartridges during flight or other safe vehicle use through the open sides, with only minimal structural horizontal support bars 2001b and top railings remaining visible. This may create a continuous, unobstructed cabin environment while maintaining the structural rigidity that may be required for flight.

Automated weight and balance management is provided. The VMPSP may include a center of gravity (“CG”) optimization engine. Before the insertion of any cartridges into a vehicle (or mover), the system may identify (e.g., using any suitable scale(s) 2097 of a terminal, of a cartridge, of a mover, etc.) the weight and contents of each cartridge (e.g., distinguishing between a heavy HVAC/water/fuel cartridge and a light economy-seating passenger cartridge). Any suitable controller (e.g., any suitable AI-driven controller) may then be configured to assign each cartridge a specific docking coordinate within the vehicle 80 to ensure the combined mass stays within the aircraft's certified CG envelope.

Autonomous mover and lifting architecture may be provided. A mover 70 (e.g., a ground pod) may be an autonomous or semi-autonomous transport mechanism that may be configured to transport cartridges 60 between a terminal 40 and a vehicle 80. The mover 70 may include a heavy-duty chassis equipped with a vertical lift assembly.

In some embodiments, the vertical lift assembly may utilize a scissor lift, hydraulic piston array, chain-drive lift system, or the like. This may allow the mover 70 to adjust the height of a cartridge 60 to precisely match the sill height of various aircraft types (e.g., matching the different deck heights of a Boeing 737 vs. a Boeing 747). The VMPSP may be configured to provide real-time telemetry to a mover 70 to ensure that the lifting speed and alignment are synchronized with the vehicle's docking ports.

Ground stability and tarmac integration may be provided. To ensure stability during high-lift operations and in adverse weather conditions (e.g., high crosswinds), a mover 70 may include a ground-locking assembly. This assembly may include one or more deployable structural poles or “pickets” that may be configured to be received within reinforced, concrete-encased steel apertures built into the airport tarmac. When engaged, the mover may be vertically and laterally anchored to the ground, transferring the overturning moments from wind or off-center loads directly into the subterranean infrastructure, thereby eliminating the need for wide-footprint stabilizer jacks.

Cartridge transference and actuation logic are provided. Systems of the disclosure may be designed to concentrate high-wear moving parts on a mover 70 to minimize maintenance requirements for a vehicle 80 and terminal 40 and cartridge 60. A mover 70 may include an active transference suite that may include motorized rollers, gears, and magnetic propulsion tracks (e.g., tracks 4075 or otherwise) to move a cartridge 60 longitudinally. Additionally or alternatively, a mover 70 may be equipped with a hook-and-winch system or robotic grapplers that may be configured to reach into a vehicle fuselage or terminal room, engage a cartridge frame, and/or pull or push a cartridge into a final docked position in a vehicle or terminal.

Sensor-dense architecture may be provided. While a mover handles the mechanical work, a vehicle 80 and terminal 40 may be configured with a sensor-dense architecture. This may include high-precision weight sensors (e.g., load cells) at the docking points and optical alignment sensors. These sensors may provide real-time feedback to the VMPSP, ensuring that even though a mover is doing the “heavy lifting,” a vehicle and terminal can verify the exact weight distribution and locking integrity of every cartridge.

An integrated logistics and orchestration ecosystem may be provided. An integrated logistics ecosystem may include a distributed network of terminals 40, movers 70, and vehicles 80, all of which may be synchronized via the VMPSP (e.g., using VMPS subsystem 10 or otherwise). The ecosystem may manage the lifecycle of a passenger or other cargo from arrival at an airport entrance 1002, through automated staging in a cartridge 60 at a departure terminal 40/3000, and finally to a precision-timed “just-in-time” delivery to a vehicle 80 via an autonomous mover 70.

The ecosystem may be characterized by a multi-stage handoff protocol. In a first stage, a terminal 40 may identify a passenger or cargo load and assign it to a specific cartridge 60. In a second stage, a mover 70 may autonomously retrieve the cartridge, utilizing the previously described vertical lift and tarmac-anchoring systems to maintain stability. In a third stage, the mover may perform a data handshake with a vehicle 80 to confirm the specific docking coordinates and utility requirements (e.g., HVAC and power) before executing the physical insertion. This integrated workflow may allow a terminal to function as a “pre-boarding” zone, where the aircraft itself remains in flight or in a separate maintenance area until the exact moment the cartridges are ready for insertion, drastically reducing gate occupancy time.

Fluid-based “printer ink” refueling may be provided. The concept of replacing fuel via modular cartridges (e.g., including mid-air replacement) may be highly useful. Fluidic “printer ink” cartridge architecture may include a modular cartridge 60 that may be configured as a fluid-storage unit for the transport and delivery of propulsion propellants (e.g., Jet-A, sustainable aviation fuel (“SAF”), liquid hydrogen, or battery-electric storage). This “printer ink” model may allow for the rapid replenishment of a vehicle's energy reserves by swapping depleted fluid cartridges for fully charged units, rather than traditional pumping at a fixed fuel farm.

High-pressure dry-break interfaces may be provided. To facilitate safe and rapid transfer, fluid cartridges 60 and vehicle 80 may include mated dry-break fluidic couplings. These couplings may be similar to resource interface connections and may be engineered to remain hermetically sealed until a full mechanical “handshake” is confirmed by the VMPSP. This may prevent environmental leakage during the high-speed insertion of a fuel cartridge into the vehicle airframe.

Mid-air replenishment and ejection of cartridges may be provided. Systems of the disclosure may enable in-flight energy replenishment. For example, a secondary “tanker” vehicle or autonomous drone or mover may dock with a primary vehicle 80 to exchange a depleted fuel cartridge for a full one. Conversely, for emergency weight reduction or mission-range extension, the vehicle 80 may be configured to autonomously eject an empty fuel cartridge (e.g., while vehicle 80 is airborn (e.g., using a safety parachute, etc.)), which may then be recovered by a mover 70 or a trailing drone, allowing the primary vehicle to continue flight with reduced mass and optimized aerodynamics.

Autonomous recovery and safe ejection of propellant modules may be provided. To ensure the safe recovery of such fuel cartridges or otherwise and to prevent hazards to ground personnel or infrastructure, each fluid cartridge 60 may be equipped with an integrated recovery suite 67. This suite may include deployable parachutes, telescopic glider wings, and/or autonomous drone propulsion systems (e.g., electric fans or compressed gas/air jets). Upon ejection from a vehicle 80, the cartridge's resident controller (e.g., processor 12) may be configured to navigate the cartridge to a designated recovery zone or to be intercepted mid-air by a mover 70 or recovery drone.

Dynamic center-of-gravity (“CG”) compensation may be provided. The VMPSP may be configured to execute a predictive ballast adjustment sequence during the ejection or swapping of a cartridge. Any suitable processing (e.g., AI) may be configured to calculate the instantaneous change in mass and the resulting shift in the vehicle's center of gravity. To maintain aerodynamic trim, the system may actuate on-board robotic systems or gears to shift the longitudinal or lateral position of remaining cartridges. Alternatively, or in combination, the system may initiate an internal fluid transfer, moving liquid propellant between auxiliary reservoirs or remaining cartridges to provide a counter-weight, ensuring the vehicle remains balanced throughout the transition. This may add a sophisticated layer of active ballast management and autonomous recovery to the propulsion system. It may transition a system from a simple tank swap system to a dynamic, self-balancing flight operation system.

By using on-board robots and/or fluid transfer to counter the ejection of mass, an aerodynamic challenge of modular flight may be solved by maintaining trim during weight shifts.

Automated maintenance and cleaning may be provided. Robotic cleaning and lost-and-found recovery system in specialized terminals is a key differentiator of systems of the disclosure. Robotic lost-and-found and object recognition may be provided by the VMPSP. A cleaning terminal may include any suitable vision-based recovery system. For example, using high-resolution cameras and AI-driven object recognition, the system may be configured to scan the nooks and crannies of a cartridge seating area, such as seatback pockets and under-seat gaps, which may be fully exposed when the cartridge walls are retracted (e.g., curtains 2032 may be retracted from opening(s) 2001s). The system may be configured to identify foreign objects (e.g., smartphones, wallets, passports, stuffed animals, etc.), catalog them with a timestamp and cartridge ID, and trigger an automated notification to an appropriate passenger (e.g., via network 50 (e.g., via a passenger portable media device (e.g., smart phone) that may be reached using any suitable passenger records of the VMPSP)).

Preventative maintenance and wear detection during a cleaning cycle may be provided, and robotic sensors may be configured to perform a structural health check on the cartridge interior. This may include detecting frayed seatbelt webbing, tears in upholstery, or malfunctions in the integrated charging ports of a cartridge. If a deficiency is found, the VMPSP may be configured to flag the cartridge for maintenance rather than assign it a “flight ready” status, thereby ensuring that every cartridge inserted into a vehicle is in peak condition.

Autonomous mobile maintenance swarms may be provided. Specialized cleaning and repair terminals may utilize a fleet of free-moving autonomous robots (e.g., robots 5002). These robots may be configured to navigate the interior and exterior of open-frame cartridges 60 to perform high-precision micro-maintenance tasks. These robots may include specialized end-effectors for any suitable functions, including, but not limited to, restocking (e.g., inserting in-flight magazines, customs forms, and safety cards into seatback pockets), textile repair (e.g., swapping seat cushion covers or utilizing integrated sewing heads to repair torn upholstery), component replacement (e.g., identifying and replacing failed LED bulbs or damaged seat hardware), surface restoration (e.g., buffing scratches on tray tables or interior panels and vacuuming floor surfaces), and/or the like.

Last-mile passenger item delivery may be provided. In conjunction with an asset recovery module, any suitable free-moving robots or otherwise of the VMPSP may be configured to perform last-mile delivery of identified passenger items. Upon the recognition and security clearance of a lost item (e.g., a smartphone or passport), a mobile robot may be dispatched to navigate the terminal environment to deliver the item directly to the passenger at a boarding gate or airport entrance/exit 1002 or passenger transport mechanism 3099 (see, e.g., FIG. 13 and robot 13000), such as by utilizing network 50 to track the passenger's real-time location.

A system is provided for efficient aircraft boarding and cargo handling, comprising:
a modular cartridge (60) in multiple sizes (e.g., tiny, small, medium, large, and huge) comprising side-loading openings (2001s);
an autonomous, battery-powered transport mechanism (70) comprising tracks (4075) or pods, moving cartridges even to 100 miles or more (such that boarding and arrival can take place many miles from the airport);
an aircraft fuselage (80) comprising tracks (14040) and/or pins and locking mechanisms to accept and secure the cartridges; and
a terminal (40) comprising cartridge-loading rooms (3009) (where people can safely and ergonomically board the cartridges, and where the cartridges are then closed before being slid onto transport mechanisms and then driven to a plane and inserted; and alternatively where this process is reversed for arrivals).

The system of paragraph [0125], wherein the cartridge comprises folding outer seat arms (2031) connectable to the backrest ahead (or getting very close), and deployable shades (2032), with side openings (2001s) aligned to standard aircraft emergency exits.

The system of paragraph [0125], wherein the transport mechanism uses inset tracks (4075) with bearings, rails, wheels, and/or magnetic levitation.

The system of paragraph [0125], further comprising external cameras with motion detection (15) around the transport mechanism, issuing real-time alerts to a remote station (10).

The system of paragraph [0125], further comprising internal cameras with motion detection (15) inside the cartridge, logging items and alerting crew/staff to safety issues or lost items.

The system of paragraph [0125], further comprising internal cameras with motion detection and/or sensors (15) inside the cartridge checking that passengers are seated, and/or seatbelted, and/or their arms and limbs are inside the area before closing curtains (2032) and arms (2031), and/or playing a sound and/or notifying the passenger(s) to move their arms or legs inside the cabin as the curtains and/or doors (2032) and/or arms (2031) close.

The system of paragraph [0125], further comprising a cleaning and restocking terminal (5000) with robots (5002) for restocking and a robotic system to return lost items identified by internal cameras.

The system of paragraph [0125], further comprising security scanning terminals (5000) where robots (5002) and/or humans and/or dogs and/or scanning machines and/or cameras scan incoming or returning cartridges for explosives, drugs, illegal migrants, forbidden produce, weapons, and other forbidden items. These may be a separate terminal before a cartridge arrives to an arrivals terminal such that international travelers, for example, and their items are scanned before entering domestic space, or it may be after the arrivals terminal, integrated into the cleaning/preparation terminal to ensure the cartridge is safe to be re-entered into the cycle and used for a new flight. Also, such a scanning terminal may be placed by an entrance to the airport to scan cartridges that have traveled from a remote terminal to ensure nothing has been added or inserted to the terminal.

The system of paragraph [0125], further comprising various types of cartridges of different configurations, such as, but not limited to, cargo, passenger, animal, fuel, liquid, such that an aircraft can land full of passengers, but the passenger cartridge is removed and replaced with a cargo cartridge and the aircraft serves as a cargo aircraft without needing any adjustments to the actual aircraft.

The system of paragraph [0125], wherein the cartridge comprises side-loading openings (2001s) aligned with each passenger row (2002r), enabling simultaneous ingress and egress, distinct from end-door sequential boarding.

The system of paragraph [0125], wherein the transport mechanism operates autonomously over distances even up to 100 miles or more, integrating external cameras with motion detection (15) for security and autonomous driving.

The system of paragraph [0125], further comprising a robotic cleaning terminal (5000) and internal cameras identifying and returning lost items, enhancing turnaround efficiency.

The system of paragraph [0125], further comprising the aircraft fuselage comprising tracks (14040) with bearings or magnetic levitation for horizontal cartridge insertion.

The system of paragraph [0125], further comprising the automated pods or trucks comprising tracks (4075) with bearings or magnetic levitation for horizontal cartridge insertion and movement.

The system of paragraph [0125], further comprising fuel cartridge(s) that are placed in the cargo area closest to the engines of the aircraft, to reduce the need for pipes/tubes, or placed where the weight balance is necessary.

The system of paragraph [0125], further comprising fuel cartridge(s) that can be ejected from the aircraft and fall with parachute, in the event the aircraft needs to rapidly drop weight.

The system of paragraph [0125], further comprising fuel cartridge(s) that can be inserted mid-flight by autonomous drone, other aircraft, rope/cable that pulls one up from a ship or other aircraft, or by other means.

The system of paragraph [0125], further comprising passenger cartridges and/or cargo cartridges and/or fuel cartridges that can be ejected from the aircraft and lowered to the ground by parachute (67), such as in the event of emergency.

The system of paragraph [0125], further comprising rescue drone(s) that can fly up to the aircraft and allow the cartridge(s) to slide into the drone, such as if the aircraft has damaged engines, or a vertical landing is required.

The system of paragraph [0125], further comprising emergency cartridges with integrated parachutes and/or drone(s) (67) that can be packed with passengers and deployed from the aircraft, such as if the aircraft has damaged engines.

The system of paragraph [0125], further comprising cartridges with integrated parachutes and/or drone(s) (67) that can be packed with passengers and/or cargo and deployed from the aircraft, such as if the aircraft has damaged engines or in a military situation where troops and/or equipment must be dropped to a specific area.

A method for secure aircraft operation, comprising:
loading passengers into a small, medium, or large cartridge (60) via side openings (2001s), securing with folding arms (2031) and shades (2032);
transporting the cartridge up to 100 miles, monitored by motion-detecting cameras (15); inserting the cartridge into an aircraft fuselage (60), aligning with emergency exits; and
cleaning and returning lost items via robotic systems (5002).

An automated maintenance and item recovery system for modular transport units, comprising:
a plurality of internal sensors (15) disposed within a modular cartridge (60), comprising at least one image sensor and at least one occupancy sensor corresponding to a specific seating coordinate;
a central processing unit (12) configured to:
   receive an “empty” status from the occupancy sensor;
   capture a post-deplaning image of the specific seating coordinate;
   compare the post-deplaning image against a baseline “clean” state to identify a foreign object; and
   generate a digital manifest linking the foreign object to a specific passenger identity based on seating records;
a cleaning terminal (5000) comprising at least one robotic effector (5002) configured to traverse the modular cartridge; and
a recovery robot (“Return Bot”) (13000) communicatively coupled to the central processing unit, configured to receive the digital manifest, navigate to the specific seating coordinate, retrieve the foreign object, and transport it to a designated retrieval location.

The system of paragraph [0148], wherein the robotic effector is further configured to:
perform a sanitation cycle (e.g., UV-C light, vacuuming, or disinfectant spray) based on a “dirty” state identified by the image sensor; and
perform a replenishment cycle by replacing a consumable item (e.g., headset, pillow, or safety pamphlet) at the specific seating coordinate.

The system of paragraph [0148], wherein the central processing unit is configured to transmit a real-time notification to a mobile device of the passenger identity associated with the foreign object while the modular cartridge is in transit to the cleaning terminal.

The system of paragraph [0148], further comprising a diagnostic robot (5002) configured to:
inspect mechanical components (e.g., seat fasteners, electronic ports, or armrest hinges) identified as faulty by the internal sensors; and
execute an on-site repair using an additive manufacturing (3D printing) tool or automated fastener tool.

A system for the in-situ autonomous conversion and repair of an aircraft fuselage, comprising:
a mobile manufacturing platform (14052) comprising a multi-axis robotic arm equipped with a swappable end-effector (e.g., a 3D-printing nozzle, a laser sintering head, or a CNC milling bit);
a spatial mapping sensor (e.g., LIDAR or structured light scanner) configured to generate a real-time 3D digital twin of the interior geometry of the aircraft fuselage;
a positioning controller configured to align the mobile manufacturing platform within the aircraft fuselage based on the 3D digital twin; and
an additive manufacturing processor configured to deposit material directly onto the interior surface of the aircraft fuselage to form a structural interface (e.g., a cartridge track, a locking bracket, or an environmental port) without requiring external jigs or manual fastening.

The system of paragraph [0152], wherein the mobile manufacturing platform is configured to operate within a non-pressurized environment and utilize the existing power bus of the aircraft to fuel the additive manufacturing process.

A method for converting a legacy aircraft for modular cartridge compatibility, comprising:
scanning an internal airframe (14006) of the aircraft to identify load-bearing rib locations;
calculating an optimized track path for a modular cartridge based on the scan;
printing a reinforced track system (14040) directly onto the airframe using high-strength composite or metal laser sintering; and
validating the structural integrity of the printed track via an integrated ultrasonic or X-ray inspection sensor (15) on the robotic arm.

A high-integrity mechanical junction for modular aircraft, comprising:
a first structural component (e.g., a cockpit bulkhead) (14090) and a second structural component (e.g., a fuselage ring) (14070); and
a topologically interlocked locking mechanism synthesized in-situ via additive manufacturing, wherein:
   the first and second structural components comprise interleaved geometries that are physically inseparable without material destruction; and
   the locking mechanism is configured to maintain structural continuity during a rapid decompression event or extreme pressure differential by distributing load across a continuous, 3D-printed grain structure rather than a discrete mechanical fastener.

A modular aircraft cartridge (60) for side-loading passenger ingress and egress, comprising:
a structural frame (2022b) defining a passenger cabin interior (2002p);
at least one lateral access assembly (2032) moveably coupled to the structural frame, the lateral access assembly configured to transition between a sealed flight configuration and an open loading configuration; and
a deployable safety barrier (2031) positioned between a passenger seating area and the lateral access assembly, wherein the deployable safety barrier is configured to move between a retracted position and a protective position, the protective position defining a clearance gap that prevents passenger limb interference with a movement path of the lateral access assembly.

The modular aircraft cartridge of paragraph [0155], wherein the lateral access assembly (2032) comprises a flexible rolling member configured to retract into a housing via a vertical or longitudinal rolling motion (e.g., similar to a window blind).

The modular aircraft cartridge of paragraph [0155], wherein the lateral access assembly (2032) comprises a plurality of articulated hinged panels configured to travel along a curved track, similar to a sectional garage door.

The modular aircraft cartridge of paragraph [0155], wherein the lateral access assembly (2032) comprises a solid panel configured to fold upward, downward, or slide longitudinally relative to the structural frame to reveal a loading aperture (2001s).

The modular aircraft cartridge of paragraph [0155], wherein the lateral access assembly (2032) comprises a removable panel secured to the structural frame via a plurality of magnetic arrays and mechanical interlocks, the removable panel configured for total detachment from the cartridge by an external robotic or human operator.

The modular aircraft cartridge of paragraph [0155], wherein the deployable safety barrier (2031) comprises an extended-width armrest or a safety bar configured to pivot or slide into the protective position prior to the movement of the lateral access assembly (2032).

The modular aircraft cartridge of paragraph [0155], further comprising a logic controller (12) in communication with the lateral access assembly (2032) and the deployable safety barrier (2031), the logic controller configured to:
detect a position of the deployable safety barrier; and
inhibit movement of the lateral access assembly unless the deployable safety barrier is confirmed in the protective position.

The modular aircraft cartridge of paragraph [0155], wherein the structural frame of the modular cartridge is configured to provide an open-plan cabin architecture when in the open flight configuration, characterized by a lack of solid lateral walls between adjacent cartridges to allow for unimpeded passenger movement and visibility across multiple docked cartridges.

A modular utility distribution system for aircraft, comprising:
a vehicle docking interface (4035) coupled to a primary utility system (4086) of an aircraft (4080/14080);
a first modular cartridge (60) comprising a first mated interface (2035) and a second mated interface (2035); and
a second modular cartridge (60) comprising a third mated interface (2035), wherein the first modular cartridge is configured to receive utilities from the primary utility system of the aircraft via the first mated interface and bridge said utilities to the second modular cartridge via a connection between the second and third mated interfaces.

The system of paragraph [0163], wherein the utilities distributed via the mated interfaces comprise at least two of: high-voltage electrical power, pressurized conditioned air (HVAC), potable water, and high-speed data.

The system of paragraph [0163], further comprising a vehicle management processing service configured to:
calculate a precise insertion coordinate for the first and second modular cartridges; and
verify a secure utility seal and data handshake between the aircraft and the cartridges prior to flight.

The system of paragraph [0163], further comprising a dedicated cockpit HVAC module configured to operate independently of a cabin modular utility network, providing a secondary layer of environmental redundancy for the flight crew.

A redundant utility distribution network for modular aircraft, comprising:
a plurality of modular cartridges (60) arranged in a multi-column or multi-row grid within a vehicle fuselage;
a plurality of utility docking ports (2035) disposed on at least two surfaces of each modular cartridge; and
a bypass controller (12) configured to detect a utility fault in a first cartridge and autonomously re-route at least one utility (e.g., HVAC airflow or electrical power) through a second, adjacent cartridge to a third, downstream cartridge, thereby maintaining service continuity.

The network of paragraph [0168], wherein the utility docking ports comprise static compression gaskets configured to form a fluid-tight seal upon mechanical mating of two cartridges without the use of active inflation.

A method for reducing aircraft maintenance downtime, comprising:
identifying a failure in a fixed-function system (e.g., HVAC, galley, or lavatory) of an aircraft (80);
de-docking a modular cartridge (60) containing the failed system from a vehicle docking interface (4035) of the aircraft; and
instantly replacing the failed modular cartridge with a functional modular cartridge of the same type, such that the aircraft is cleared for flight without requiring in-situ repair of the failed system.

A method for managing the structural and utility integration of modular aircraft, comprising:
identifying a plurality of modular cartridges (60) for a specific flight mission, the plurality of modular cartridges comprising at least one utility cartridge (e.g., HVAC, kitchen, bathroom) and one passenger cartridge;
calculating, via an AI-driven management system (1), an optimized loading sequence and longitudinal position for each cartridge based on the mass of each cartridge to maintain the vehicle's Center of Gravity (CG) within safe flight limits;
inserting the cartridges into a vehicle airframe (80); and
actuating a docking sequence wherein each cartridge connects to at least one of a vehicle utility port (4035) or an adjacent cartridge utility port (2035).

A ground-based transport system for modular aircraft cartridges, comprising:
an autonomous mover (70/4070) having a multi-wheeled chassis (4074) and a deck (4072b) configured to support a modular cartridge (60);
a vertical lift assembly (4073) coupled to the deck, the assembly comprising at least one of a scissor lift, a hydraulic actuator, or a chain-driven lift; and
a height-sensing controller (12) configured to:
   identify a target vehicle (60) type and a corresponding docking height; and
   actuate the vertical lift assembly to align a lateral access port of the modular cartridge with a fuselage opening of the target vehicle (60).

A stabilized ground-support system for modular aircraft loading, comprising:
a loading area (4014) having a plurality of reinforced apertures (4014h) disposed within a ground surface;
a mover (70) comprising a chassis (4074) and a vertical lift (4073); and
a plurality of deployable locking poles (4074p) coupled to the chassis, wherein the poles are configured to extend into the reinforced apertures to anchor the mover against lateral wind loads and tilting moments during a high-lift operation.

A modular transference system for aircraft cartridges, comprising:
a vehicle (80) having a passive internal track (14040) and a plurality of weight sensors (15); and
a mover (70) comprising an active propulsion assembly (4075), the assembly comprising at least one of motorized rollers, a winch-and-cable system, or a magnetic linear actuator, wherein the mover is configured to provide the primary motive force to translate a modular cartridge (60) from the mover onto the passive internal track of the vehicle, thereby minimizing the number of moving parts onboard the vehicle.

The system of paragraph [0173], wherein the mover further comprises a robotic grappler configured to engage a structural member of the modular cartridge to perform a precision-pull docking sequence into a vehicle utility port.

An integrated logistics system for modular aircraft boarding and deboarding, comprising:
a plurality of modular cartridges (60), each associated with a unique logistics identifier;
a remote terminal (40) configured to stage the plurality of modular cartridges independently of an aircraft's (80) presence at a gate;
an autonomous mover (70) comprising a vertical lift assembly and an active transference suite; and
a centralized management processor (10/12) in communication with the terminal, the mover, and an aircraft, the processor configured to execute a synchronized boarding sequence comprising:
   assigning a specific mover to retrieve a specific cartridge from the remote terminal based on the logistics identifier;
   routing the mover to an aircraft docking position; and
   commanding a mechanical and utility “handshake” between the mover and the aircraft to translate the cartridge into a fuselage of the aircraft at a calculated center-of-gravity (CG) coordinate.

The system of paragraph [0175], wherein the remote terminal further comprises an automated cleaning and recovery module (5000) configured to process a deboarded cartridge by performing robotic sanitation and lost-item identification before the cartridge is re-assigned by the processor for a subsequent flight mission.

A modular fluidic replenishment system for aircraft, comprising:
a propulsion fluid cartridge (60) defining an internal reservoir for a combustible or electric propellant;
a high-pressure dry-break interface coupled to the reservoir; and
a vehicle docking port (4035) configured to receive the fluid cartridge and establish a fluidic or electrical connection with a vehicle's (80) primary propulsion system (4086), wherein the propellant is delivered to the vehicle as a pre-packaged unit, allowing for “printer ink” style replacement of energy reserves without traditional refueling hoses.

The system of paragraph [0177], wherein the vehicle is configured to autonomously eject the propulsion fluid cartridge during flight upon reaching a threshold depletion level to reduce vehicle mass.

The system of paragraph [0177], wherein the fluid cartridge further comprises an integrated pump and filtration system controlled by a cartridge-resident logic controller (12), allowing the cartridge to self-regulate fluid pressure and purity during the “printer ink” delivery process.

The system of paragraph [0177], wherein the fluid cartridge comprises autonomous drone engines configured to maintain a formation flight with the vehicle during a docking or de-docking procedure, allowing for zero-airspeed-differential replenishment.

A method for mid-air energy replenishment, comprising:
docking a first vehicle (80) with a second vehicle (70) during flight;
exchanging a depleted propulsion fluid cartridge (60) from the first vehicle with a fully charged propulsion fluid cartridge (60) from the second vehicle via a modular transference assembly; and
establishing a utility handshake between the new cartridge and the first vehicle's propulsion system, such that the first vehicle's flight range is extended without landing.

An autonomous recovery system for modular aircraft cartridges, comprising:
a modular cartridge (60) comprising a structural frame (2022b) and an internal reservoir (2002p);
an integrated recovery suite (67) coupled to the frame, the suite comprising at least one of: a parachute, glider wings, a drone propulsion system, or compressed gas jets; and
a recovery controller (12) configured to actuate the recovery suite upon ejection of the cartridge from a vehicle (80), thereby navigating the cartridge to a controlled landing or intercept coordinate.

A method for maintaining vehicle (80) trim during modular component ejection, comprising:
calculating, via a centralized management processor (12), a center-of-gravity (CG) shift resulting from the ejection of a modular cartridge (60); and
initiating a ballast compensation sequence prior to or during the ejection, wherein the sequence comprises at least one of:
   physically translating a second modular cartridge (60) to a new coordinate within the vehicle (80) via a robotic or geared actuation system; or
   transferring fluid between at least two reservoirs within the vehicle to counteract the mass of the ejected cartridge.

An automated maintenance and sanitation system for modular aircraft cartridges, comprising:
a sanitation bay configured to receive a modular cartridge (60);
a robotic effector (5002) positioned within the bay and comprising at least one of a UV-C sterilization lamp, a vacuum nozzle, or a pressurized fluid sprayer; and
a terminal controller (12) configured to actuate the robotic effector to clean the interior of the modular cartridge while the cartridge is in an open-frame configuration.

The system of paragraph [0184], further comprising an asset recovery module, the module comprising:
an optical sensor (15) configured to scan the modular cartridge for passenger-left objects; and
an AI-driven recognition engine configured to:
   distinguish between debris and high-value personal items; and
   generate a recovery record linked to a specific passenger profile associated with the cartridge's previous flight mission.

A method for rapid aircraft turnaround using modular maintenance, comprising:
extracting a used modular cartridge (60) from a vehicle (80);
transporting the used modular cartridge to a specialized cleaning terminal (5000);
performing a simultaneous robotic sanitation cycle and an automated “lost-and-found” optical scan; and
returning the modular cartridge to a “flight-ready” queue while the vehicle is simultaneously loaded with a pre-sanitized modular cartridge, such that the vehicle's ground time is independent of the cleaning duration.

An autonomous micro-maintenance system for modular aircraft cartridges, comprising:
a fleet of free-moving robots (5002) configured to navigate an interior of a modular cartridge (60);
a plurality of specialized maintenance tools coupled to the robots, selected from a group consisting of: a sewing head, a polishing buffer, a vacuum, and a component-grasping manipulator; and
a swarm controller configured to assign specific maintenance tasks to each robot based on a diagnostic scan of the modular cartridge.

The system of paragraph [0187], wherein at least one robot is configured to restock consumable items into a seatback pocket of the modular cartridge, the consumable items comprising at least one of printed media, safety instructions, or passenger comfort kits.

The system of paragraph [0187], wherein the free-moving robots are configured to replace modular seat cushions by detecting wear or contamination levels via a multispectral sensor and autonomously swapping a degraded cushion with a localized inventory of fresh cushions within the repair terminal.

A method for autonomous asset recovery and delivery, comprising:
identifying a personal item left within a modular cartridge (60) via an optical recognition engine (12/15);
assigning the personal item to a free-moving delivery robot (5002);
performing a security scan of the personal item; and
navigating the delivery robot through a terminal environment (40) to a real-time coordinate of a passenger to return the personal item.

One, some, or all of the processes described with respect to FIGS. 1-14D and otherwise may each be partially or entirely implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of FIG. 1A). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from a central network controller device to a router device or from a data device to any network device. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure (e.g., any or each module of system 1) may be provided as a software construct, firmware construct, one or more hardware components, or a combination thereof. For example, any, each, or at least one module or component or subsystem of any suitable system may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

Implementations within the scope of the present disclosure can be partially or entirely realized using a tangible computer-readable storage medium, or multiple tangible computer-readable storage media of one or more types, encoding one or more instructions. The tangible computer-readable storage medium also can be non-transitory in nature.

At least a portion of one or more of the modules of any suitable system of the disclosure (e.g., system 1, system 199, system 499, etc.) may be stored in or otherwise accessible to a subsystem (e.g., subsystem 20) in any suitable manner (e.g., in memory 13 (e.g., as at least a portion of application 19a and/or model 19m)). Any or each module of any suitable system of the disclosure (e.g., system 1) may be implemented using any suitable technologies (e.g., as one or more integrated circuit devices), and different modules may or may not be identical in structure, capabilities, and operation. Any or all of the modules or other components of any suitable system of the disclosure (e.g., system 1) may be mounted on an expansion card, mounted directly on a system motherboard, or integrated into a system chipset component (e.g., into a “north bridge” chip). At least a portion of one or more of the modules of any suitable system of the disclosure (e.g., system 1) may be stored in or otherwise accessible to any suitable components in any suitable manner. Any or each module of any suitable system of the disclosure (e.g., system 1) may be implemented using any suitable technologies (e.g., as one or more integrated circuit devices), and different modules may or may not be identical in structure, capabilities, and operation. Any or all of the modules or other components of any suitable system of the disclosure (e.g., system 1) may be mounted on an expansion card, mounted directly on a system motherboard, or integrated into a system chipset component (e.g., into a “north bridge” chip).

Any or each module of any suitable system of the disclosure (e.g., system 1) may be a dedicated system implemented using one or more expansion cards adapted for various bus standards. For example, all of the modules may be mounted on different interconnected expansion cards or all of the modules may be mounted on one expansion card. With respect to system 1, by way of example only, modules of system 1 may interface with a motherboard or processor assembly 12 (e.g., of subsystem 20) through an expansion slot (e.g., a peripheral component interconnect (“PCI”) slot or a PCI express slot). Alternatively, modules of system 1 need not be removable but may include one or more dedicated modules that may include memory (e.g., RAM) dedicated to the utilization of the module. In other embodiments, modules of system 1 may be at least partially integrated into a subsystem (e.g., subsystem 20 (e.g., a server)). For example, a module of system 1 may utilize a portion of memory 13 of a subsystem. Any or each module of system 1 may include its own processing circuitry and/or memory. Alternatively, any or each module of system 1 may share processing circuitry and/or memory with any other module of system 1 and/or processor assembly 12 and/or memory assembly 13 of a subsystem (e.g., subsystem 20).

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device (e.g., via one or more wired connections, one or more wireless connections, or any combination thereof).

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including, but not limited to, routines, subroutines, programs, data structures, objects, modules, applications, applets, functions, and/or the like. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations may be performed by one or more integrated circuits, such as ASICs or FPGAs. In one or more implementations, such integrated circuits may execute instructions that may be stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software may depend upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As may be used in this specification and any claims of this application, the terms “base station,” “receiver,” “computer,” “server,” “processor,” and “memory” may all refer to electronic or other technological devices. These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As may be used herein, the terms “computer,” “personal computer,” “device,” “computing device,” “router device,” and “controller device” may refer to any programmable computer system that is known or that will be developed in the future. In certain embodiments, a computer will be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As may be used herein, the terms “component,” “module,” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some embodiments, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure.

While there have been described systems, methods, and computer-readable media for managing efficient vehicle use using modular cartridges, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” “roll” and “pitch” and “yaw,” “clockwise” and “counter-clockwise,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

Therefore, those skilled in the art will appreciate that the concepts of the disclosure can be practiced by other than the described embodiments, which are presented for purposes of illustration rather than of limitation.

1. A modular aircraft cartridge for side-loading passenger ingress and egress, comprising:
a structural frame defining a passenger cabin interior;
at least one lateral access assembly moveably coupled to the structural frame, the lateral access assembly configured to transition between a sealed flight configuration and an open loading configuration; and
a deployable safety barrier positioned between a passenger seating area of the passenger cabin interior and the lateral access assembly, wherein the deployable safety barrier is configured to move between a retracted position and a protective position, the protective position defining a clearance gap that prevents passenger limb interference with a movement path of the lateral access assembly.

2. The modular aircraft cartridge of claim 1, wherein the lateral access assembly comprises a flexible rolling member configured to retract into a housing via a vertical or longitudinal rolling motion.

3. The modular aircraft cartridge of claim 1, wherein the lateral access assembly comprises a plurality of articulated hinged panels configured to travel along a curved track.

4. The modular aircraft cartridge of claim 1, wherein the lateral access assembly comprises a solid panel configured to fold upward, downward, or slide longitudinally relative to the structural frame to reveal a loading aperture.

5. The modular aircraft cartridge of claim 1, wherein the lateral access assembly comprises a removable panel secured to the structural frame via a plurality of magnetic arrays and mechanical interlocks, the removable panel configured for total detachment from the cartridge by an external robotic or human operator.

6. The modular aircraft cartridge of claim 1, wherein the deployable safety barrier comprises an extended-width armrest or a safety bar configured to pivot or slide into the protective position prior to the movement of the lateral access assembly.

7. The modular aircraft cartridge of claim 1, further comprising a logic controller in communication with the lateral access assembly and the deployable safety barrier, the logic controller configured to:
detect a position of the deployable safety barrier; and
inhibit movement of the lateral access assembly unless the deployable safety barrier is confirmed in the protective position.

8. The modular aircraft cartridge of claim 1, wherein the structural frame of the modular cartridge is configured to provide an open-plan cabin architecture when in the open flight configuration, characterized by a lack of solid lateral walls between adjacent cartridges to allow for unimpeded passenger movement and visibility across multiple docked cartridges.

9. A modular utility distribution system for aircraft, comprising:
a vehicle docking interface coupled to a primary utility system of an aircraft;
a first modular cartridge comprising a first mated interface and a second mated interface; and
a second modular cartridge comprising a third mated interface, wherein the first modular cartridge is configured to receive utilities from the primary utility system of the aircraft via the first mated interface and bridge said utilities to the second modular cartridge via a connection between the second and third mated interfaces.

10. The system of claim 9, wherein the utilities distributed via the mated interfaces comprise at least two of: high-voltage electrical power, conditioned air, potable water, or high-speed data.

11. The system of claim 9, further comprising a vehicle management processing service configured to:
calculate a precise insertion coordinate for the first and second modular cartridges; and
verify a secure utility seal and data handshake between the aircraft and the cartridges prior to flight.

12-14. (canceled)

15. A method for reducing aircraft maintenance downtime, comprising:
identifying a failure in a fixed-function system of an aircraft;
de-docking a modular cartridge containing the failed system from a vehicle docking interface of the aircraft; and
instantly replacing the failed modular cartridge with a functional modular cartridge of the same type, such that the aircraft is cleared for flight without requiring in-situ repair of the failed system.

16-66. (canceled)
